(19) United States
(12) Patent Application Publication
(10) Pub. No.: US 2011/0034120 A1
(43) Pub. Date: Feb. 10, 2011

(54) Intelligent Autonomous Climate Control and Appealing Environment Creation System and Device

(76) Inventor: Olawale Solomon Jaiyeola, Laurel, MD (US)

Correspondence Address: Olawale Jaiyeola, 7622 Erica Lane, Laurel, MD, 20707, US

(21) Appl. No.: 12/535,601

(22) Filed: Aug. 4, 2009

(51) Int. Cl. F24F 13/14; F24F 7/007; F24F 7/00; G05D 7/00

(52) U.S. Cl. 454/335; 454/338; 454/337; 700/282

(57) ABSTRACT

An autonomous device for providing a comfortable climate and appealing environment, for occupants of a particular space, by regulating air flowing into the space is described. It can function independently or as part of a climate control system to: achieve great energy efficiency, reduce time for a room to reach desired temperature, and maintain comfort climate for occupants in various areas. It possesses a means to create an aromatic environment in a particular area. Also described is a system of creating appealing environment and comfortable climate, which includes utilizing the autonomous devices and some other devices. It involves acquiring information from sensors, analyzing the acquired information, and then making intelligent decisions based on results. One embodiment comprises a chassis, intelligent control unit, a petal valve, motors, register grill, atomizers, tubes, power source, wireless module, sensor and energy harvesting module.
Reference Cited
(U.S. Pat. No. 7,156,316)
(U.S. Pat. No. 7,163,156)
(U.S. Pat. No. 7,168,627)
(U.S. Pat. No. 7,347,774)
(U.S. Pat. No. 7,455,236)
(2006/0105697)
Figures
(FIG. 1A-1Z)
(FIG. 2A-2J)
(FIG. 3A-3G)
(FIG. 4A-4M)
(FIG. 5A-5C)
(FIG. 6A-6D)
(FIG. X1-X10)
(FIG. A1-A3)
(FIG. B1-B2)

### FEDERALLY SPONSORED RESEARCH

Not Applicable

### SEQUENCE LISTING OR PROGRAM

Not Applicable

### BACKGROUND

1. Field

This application relates to HVAC (heating, ventilation, and air conditioning) systems, more specifically to air vents, which are commonly found in most buildings in the northern hemisphere where central environmental control units are common. Further, it extends to aromatic-environment creation as it creates a pleasing and attractive environment for occupants. This application further recognizes the utilization of a concept in automobiles ventilation system.

2. Prior Art

As mentioned in the summary, many houses in the northern hemisphere have one central environmental unit that supply every room in a building with the desired air temperature, often by blowing heated or chilled air into them. They are used in conjunction with a central environmental control unit controller (e.g thermostat, humidity controller, etc) and air vents. I will call this combination a central environmental method/system from now on. Traditional air vents commonly found in residential and commercial settings are used to route air flow from a central environmental unit such as a furnace, central air conditioner, or dehumidifier. They are also used for aesthetic purposes. They are usually made from metal or metal alloy and often have a generic shape that simply diverge air flow to opposing directions. These vents are often equipped with levers that are used to manually control the airflow from the environmental unit; the lever opens and closes a gating mechanism that reduces or increases the flux of air into a room from a central environmental unit. This process involves bending down to adjust the airflow into a room by pulling and pushing on the lever and can be quite tedious; especially for some people with back or knee problems and seniors (the elderly). And when air vents are attached to the ceiling a ladder is required to open and close them. The inclusion of a lever in these vent covers is not only unaesthetic but can also be quite dangerous. This is due to the fact that the lever protrudes upwards and can hurt passersby's that are unaware of it; that is if the air vent is located on the floor.

Since these traditional vents are all part of a system with a central environmental unit, the state of one vent (opened or closed or in-between) affects air flow through other vents. That is, changing the state of one or more air vents could increase or decrease pressure or speed of air flowing through other vents. Sometimes, it is necessary to readjust the untouched air vents in the system to avoid damaging the environmental control unit.

Typically a central AC unit, an example of a central environmental unit, is controlled by a single thermostat that activates or deactivates it depending on the set temperature; it measures the temperature of its immediate environment, compares this reading to that of the set temperature, and makes a decision (switch on or switch off the central environment unit) based on this comparison. The air flows from the central environment unit into the rooms of a building through air vents that simply route the airflow. By redirecting the airflow sideways, vents better circulate the air, rather than the air blowing straight up to the ceiling or down to the ground. This central environmental system is so common because it holds some advantages over the alternative; which could be one or more AC unit(s) in each room. In terms of energy consumption, a central air conditioning unit is a more energy efficient method of regulating a building's climate than a multiple unit climate control system (as commonly done in some countries). However buildings that have central unit systems suffer less climate flexibility than those with a plurality of AC units. For example, occupants of a residential building wanting to conserve energy during the night would have a difficult time accentuating air flow to the sleeping quarters only. Occupants would also have a difficult time creating different climate conditions within the same building. Consider a scenario in which there are four occupants (A, B, C and D) in a building that utilizes the central AC unit method (i.e thermostat, central AC unit, and air vents); each occupying different rooms in the building. Each occupant has his/her own climate preference or level of comfort. Let's assume: a room temperature of 24° C. is desired by occupant A, 26° C. by occupant B, 27° C. by both occupants C and D. The best insulated room is occupied by occupant B, the next best insulated room by occupant A, finally the rooms occupied by occupants C and D are the least insulative and are of equal insulative capacity. The room size is also a factor to consider in this given scenario. Occupant A's room is much bigger occupant B's room, it is the same size as occupant C's but smaller than occupant D's (this means that C is also smaller than D). Also each of said rooms has 2 vents, all of same the size. Assume further that the rooms are of equal proximity to the central environmental unit approximately. As often as seen in most buildings, the thermostat is located in a room considered to be central or used often. The thermostat here is set to a temperature of 28° C. on a cold night of 15° C. The central AC is switched on by the thermostat and the ambient temperature of the building starts to differ from room to room. As expected, occupant B's room will be the first to reach the desired temperature due to its insulative capability and size. At this time, if the location of the thermostat has a temperature lower than that of occupant B's room; so the thermostat leaves the central AC on, and the AC continues to pump heated air into all the rooms. A's room is the next to reach the desired temperature due to the occupant's lower temperature demand, room's insulative capabilities, and its size. Meanwhile, the temperature of B's room is beyond that which is desired by its occupant, because the central AC unit kept pumping heated air into the room. If the temperature of thermostat's immediate environment still remains below the set temperature of 28° C., it leaves the central AC unit on. Occupant C's room will be next to reach the desired temperature, though it has an equal insulative capacity as D's, it is smaller than D's room. At this time, occupant B's room's temperature is far beyond the occupant's desired comfortable temperature and it could be as high as 30° C.; thus creating an uncomfortable environment for occupant B. Occupant A's room's temperature would have also surpassed the temperature desired by its occupant. The thermostat's surrounding temperature might have reached 27° C. by this time, therefore; it shuts down the central AC unit without D's room reaching the temperature desired by occupant D. In the end, only occupant C gets what he wanted and the other occupants are left in discomfort. This is a realistic scenario, as it illustrates some of the disadvantages of using a combination of thermostat, traditional/static air vent, and central AC unit as a means of climate control. Factors that are not considered in this central environment design that result in major disadvantages are mentioned below.

Firstly, rooms differ in size and as a result they need different amount of air input from the central AC unit to reach and maintain a particular temperature. This system does not account this; so there is always a temperature imbalance in a building that uses this central environmental system, even when an ambient temperature is desired by occupant(s).

Secondly, rooms differ in heat insulative capacities and this central environmental system also does not account for this. That is one room might have more glass windows than others, or have walls made materials different from those used in other rooms. So again, each room requires different amount of heated/chilled air input to reach a desired temperature.

Thirdly, central AC unit method fails to monitor for human behavior, such as the use of heat generating devices like a computer or a stove that can affect the temperature of a room. These devices can enhance or hinder the efforts of a central environmental system. For example, the heat generating computer hinders efforts to chill a certain room but enhances efforts to warm it up.

Fourthly, different occupants may desire different temperature/climate. As humans, we all have different level of comfort. This central temperature control system does not account for this fact about human nature. Consider a scenario where two people, residing in the same house and are on the same floor but different rooms, probably desire different temperature zones/climate for comfort. It is sometimes impossible for this static and obtuse system to satisfy both users at the same time.

Fifthly, most thermostats are isolated from the rest of the rooms in the building. And as a result, the thermostat shuts down the central AC unit off when the temperature of its immediate environment reaches the desired temperature, and it does so without considering the climate conditions in other rooms. So some rooms are below or above the desired temperature zone (or temperature range) and are not comfortable for the occupants of the room.

Sixthly, the lack of intelligence does affect the efficiency of a central environmental system. For example the central unit unnecessarily pumps more heated/chilled air, due to the lack of stop signal from a thermostat, into a room that has already reached the desired temperature; thereby, needlessly wasting energy and also causing discomfort to the occupants of the room. This central environmental system will even pump air into rooms that are not occupied, wasting energy and increasing time it takes to warm or chill other rooms that are being used.

During my research, which I performed after developing a solution to the problems left unsolved by traditional vent-central AC unit combination, I stumbled upon a couple of automatic air vents (some intelligent air vents too) that solved some of the problems of traditional vent, but were still inadequate concepts/products. One of them is an automatic vent that lessens and increases airflow from a central AC unit into a room. The user simply sets the desired temperature on a human machine interface mounted of the register grill of an automatic air vent (which could involves the hassle of bending down), afterwards the vent closes or opens when temperature is outside or within desired zone. This product is not as easy to use as it could be; users have to bend down to set the temperature which can be tasking for some people, especially those with health issues. Another major problem with this automatic vent is it does not interact with other peripherals for a more wholesome, more energy efficient and effective climate and energy control system. Since it cannot communicate with a thermostat it is limited in its ability to control climate. The thermostat could shut down the AC unit before the temperature of the room, where the automatic vents are utilized, reaches the desired temperature; and there would be absolutely nothing the automatic vent can do about it. Another example, if the automatic vents is in a room that cannot be isolated from the next room (no door between the rooms), then the vent cannot function as effectively as it could since it cannot communicate with other vents. Another obvious disadvantage is the fact that young children, especially babies and toddlers, can easily tamper with the automatic vent since it is usually placed on a level that is accessible to them. There is a good chance of this happening since lights and sounds emitted by this automatic vent could attract them.

Another design is mentioned in published US prior art US 2006/0105697. It involves remote controlled vent louvers. Typically, these vents are wired to an electric energy source or use batteries for operation. Though, the remote controlled devices eliminate the need for manual labor needed for traditional vents, it still leaves many problems unsolved. The user simply points the remote control to the air vent and signals it to open and close. It is not fully practical to control all the air vents in a building by going from room to room. Also it requires wiring to the mains or periodic battery replacement, and constant supervision.

While the main design published prior art US 2006/0105697, which involves the design of a system that include the design of an intelligent flow devices are placed in or at the end of a ductwork, solves some of these problems it still does not provide the most appealing environment possible. It also involves a reverse airflow operation that pumps air from one room, where desired environmental condition is above or below the current environmental condition, to another room(s); so that the environmental control unit controller is propelled to switching the environmental control unit to an “On” state. Consider the situation where the reverse flow function is activated on a hot day when cool climate is desired. The major disadvantage is that the function does not consider the whether the windows in the room are open; therefore, a constant source of the extra heat is the external environment. So eventually, the central environmental control unit is usually in the on state and wastes energy as the reverse flow function encourages this active state. The patented device does not utilize other possible sources of energy to recharge said intelligent flow devices.

An aspect of creating a comfortable environment is aroma that entices our olfactory sense. Up to now aroma creation has not being linked to environmental units; they have been approached separately. Creating aroma in immediate environment often involve the use of scented candle, electronic sprays, canned sprays (many aerosol cans that contain not only toxic but also agents that contribute to the destruction of the environment), scented sticks, incense, and scented cloths. These visible products make rooms look untidy and canned sprays, which are so common, may contribute to global warming if aerosol cans are used. The synergy of a safe aromatic device and intelligent environmental devices is needed for the creation of an environment of great appeal and comfort.

The problems of creating an aromatic environment in an area to be occupied extend to the interior of an automobile or vehicles too. In most automobiles, scented sticks and materials are hung on the rear view mirror and this could be an obstruction, and could the interior look less tidy.

A highly interactive, user friendly, intuitive, safe and intelligent climate control system is needed to provide efficiency, great comfort, greater appeal, practicability, and smart energy consumption; these are some of the traits of and advantages provided by the climate and energy system and device designed by me (author, Olawale Jaiyeola).

### SUMMARY

In accordance to one embodiment, a standalone low power consuming control unit that regulates airflow to an area by, controlling a gating mechanism embedded in a frame or chassis, and/or controlling motor dynamo, while being powered by an energy source. This embodiment has the ability to communicate with external sensors, devices of same nature, and other relevant processors needed for the creation of a wholesome and effective climate monitoring and energy saving system. So in essence, it comprises a means to restrict or boost airflow, a means to communicate with other devices, a means to supply power, a means for aroma creation, and a means of controlling mechanics of the device intelligently. From here on, I categorize embodiments as adaptive vents/adaptive flow device/adaptive flow machines. They can be fitted to the end of ductwork or in the ductwork. Communication can be direct communication with other devices or indirect via a master processor that collects and transmits information from and to other relevant devices. Such communication between the device and other devices allows cooperation in order to achieve a greater goal.

A master processing unit, which equipped with a human-machine interface, communicates current parameters (e.g temperature, humidity, air quality) to the adaptive vents. An independent human-machine interface, which could be fixed to a temperature sensor, is another channel for communicating user's desired parameters to the adaptive vents. Also, current parameters could be made available to the adaptive vents by sensors without consulting the master processing unit.

A plurality of the adaptive vent can be used for climate control within a commercial or residential building. All adaptive vents could function as slaves to a master processing unit or as semi-independent units that network and cooperate with other devices of same nature, or as absolutely independent units that are concerned about their individual local environment only.

It is possible for one embodiment of adaptive flow device to operate in a reverse flow mode where air from a room can be pumped to another rooms through ductwork. However this operation is only allowed when used in conjunction with window/door state sensors (that check if window(s) or door(s) are open or close). This functionality makes the system more efficient by creating a more comfortable environment even while the environment control unit is off. On the other hand, it can also boost airflow from the environmental control unit into a particular area; thereby, reducing the time it takes for the room to reach desired environmental condition. This gives the system a function of priority setting in which certain areas are given precedence over others. Overall, adaptive vents and this system is an intuitive, safe, energy efficient way of creating an appealing and comfortable environment for users.

### DRAWINGS—FIGURES

The preceding alphanumeric in a figure code is an indicator of the embodiment illustrated, e.g FIG. 2A is an illustration of the second embodiment while FIG. 3D is an illustration of the third embodiment. Figure codes with X as the preceding alphanumeric are illustrations relating to schematics and operation of the machines; for example FIG. X3 is a flow chart of independent mode operations of a microcontroller. And finally, figures with A or B as the preceding alphanumeric are figures of accessories (more on this later); for example FIG. A1 is an illustration of accessory A (see below).

FIG. 1A is a full isomeric top left drawing of one embodiment (first embodiment 101) that has a motor 7 operating at the end side of the frame 1.

FIG. 1B is an isomeric top right view of the embodiment.

FIG. 1C shows two drawings of the embodiment (isomeric bottom view and side view) with the slats 9-11 open.

FIG. 1DA is an isomeric view of the embodiment with hidden lines revealed.

FIG. 1DB is an isomeric front view of the embodiment with hidden lines revealed.

FIG. 1EA is an explosion view drawing of the first embodiment 101 of the concept without track lines.

FIG. 1F is overview of some parts needed to build the embodiment and also included is a full picture of embodiment 101.

FIG. 1G is overview of the remaining components needed to build embodiment 101 and also included is a full picture of embodiment 101.

FIG. 1H is a drawing of how some components fit together with the exclusion of the frame 1 and some other members.

FIGS. 1I-1T are drawing of how various members of the embodiment connect.

FIG. 1V is a depiction of the chassis 1 of the machine. It clearly shows that the chassis 1 is divided into two areas: airflow area and chamber area (see description section for more information about this).

FIG. 1W is a depiction of the arrangement of the primary gear 8, pulleys 17 and belt 14 onto the chassis 1 of the machine. Note that the right chassis has been invisible so that we can view the inside of chamber A

FIG. 1X is a close up frontal view of the chamber showing the motor gear flush with the primary gear 8.

FIG. 1Y is an isometric top right view of the final build of the embodiments.

FIG. 1Z is the embodiment views from various angles.

FIG. 2A is an isometric top left view drawing of a second embodiment 102 of the machine. Note that the chassis of this embodiment is a bit different from that of the first embodiment 101, in that there is a more space under the pulley and belt for gears.

FIG. 2B is another isometric view of the second embodiment 102 of the machine with hidden lines revealed. This embodiment uses gears (see description section) in place of the belt and pulley system of the first embodiment. The bottom face of chamber A extended to make room for the gears.

FIG. 2C is closer view of the second embodiment 102 of the machine with focus on the gating mechanism.

FIG. 2D is a drawing of the second embodiment 102 seen from another angle with hidden lines revealed.

FIG. 2EA is a drawing of the type of gating mechanism used in the second embodiment 102.

FIG. 2EB is another view of the type of gating mechanism pictured in FIG. 2EA

FIG. 2EC is the top view of the type of gating mechanism pictured in FIG. 2EB.

FIG. 2FA is a view of the second embodiment 102 showing the bearings 6, washers 5, frame/chassis 1, geared motor 7, primary gear 8, secondary gears, slats 9-11, rods 14, energy harvester 13, wireless module 3, and the processing unit 4.

FIG. 2FB is another view of the second embodiment pictured in FIG. 2FA which includes the vent grill 16. The view focuses on the end of the chassis where the processing unit 4 is located.

FIG. 2FC is an isometric bottom view of the second embodiment 102.

FIG. 2FD is another isometric bottom view of the second embodiment 102 viewed from another angle.

FIG. 2FE is an isometric top view of the second embodiment 102.

FIG. 2G is a depiction of several components of the second embodiment 102.

FIG. 2H is a depiction of the rest of components of the second embodiment 102.

FIG. 2I is a view of chamber A that clearly shows the mechanical aspect of the embodiment.

FIG. 2J is a depiction of the second embodiment 102 that reveals hidden lines.

FIG. 3A is a view of the third embodiment 103. It shares some similarities with the first embodiment 101 (FIG. 1A). Noticeable difference in the drawing is the position of the chamber A (that contains the motor 7, processing unit 4, energy harvester 13, and wireless module 3) is located in the middle of the chassis as opposed to the first embodiment 101.

FIG. 3B is a view of the third embodiment 103 with hidden lines revealed.

FIG. 3C is a view of the gating mechanism of the third embodiment 103.

FIGS. 3DA-3DD are depictions of the third embodiment 103 without the vent lid 16 viewed from different angles.

FIG. 3E is a depiction of the third embodiment 103 with the vent lid 16 on the chassis.

FIG. 3F shows some of the components of the third embodiment 103.

FIG. 3G shows the rest of the components of the third embodiment 103.

FIG. 4A is an isometric view of the fourth embodiment 104.

FIGS. 4BA-4BE are isometric transparent views of the fourth embodiment 104.

FIGS. 4CA-4CB are drawing of the engine house and its component. They show how the components fit together.

FIG. 4D is a depiction of the gating mechanism of the fourth embodiment 104.

FIG. 4E show the gating mechanism in the chassis of the fourth embodiment 104.

FIG. 4F shows some of the components of the fourth embodiment 104.

FIG. 4G shows the rest of the components of the fourth embodiment 104.

FIG. 4H is a top left side view of the fourth embodiment 104.

FIGS. 4IA-4ID show how the gating mechanism fits into the chassis of the embodiment.

FIG. 4J is a frontal view of the fourth embodiment 104 that shows how the geared motor, wireless module, and processing module fit into chamber B.

FIG. 4K is a frontal view of the fourth embodiment 104 that shows how the geared motor 7, wireless module 3, processing module 4, and the energy harvester 13 fit into chamber B.

FIG. 4L is a depiction of the fourth embodiment 104.

FIG. 4M is a depiction of the fourth embodiment 104 with the atomizing components visible

FIG. 5A is a depiction of the fifth embodiment 105 that can be installed in ductwork 503.

FIG. 5B is a depiction of the fifth embodiment 105 with hidden lines revealed for insight into internal structure.

FIG. 5C is a depiction of the fifth embodiment 105 with the chassis 1 made invisible for a clear view of internal components.

FIG. 6A is a depiction of the sixth embodiment 106 that can be installed at the end of a ductwork branch 503.

FIG. 6B is a depiction of the sixth embodiment 106 broken down into 3 main parts: the restricting part, the boosting and hindering part, and the aroma creation part.

FIG. 6C is a depiction of the sixth embodiment 106 that shows how the parts are connected.

FIG. 6D is a depiction of the sixth embodiment 106 that shows how the parts are connected.

FIG. A1 is a depiction of accessory A 201 that can be coupled to embodiments 104 and can be installed in ductwork 503.

FIG. A2 is a depiction of accessory A 201 with hidden lines revealed for greater clarity.

FIG. A3 is a depiction of accessory A 201 with hidden lines revealed and chassis 1 hidden.

FIG. B1 is a depiction of accessory B 202 that can be coupled to embodiments 101-103 and can be installed in ductwork 503.

FIG. B2 is a depiction of accessory B 202 with hidden line revealed. Note that wire 52 connects to an attached embodiment's processing unit.

FIG. X1 is a schematic view of intelligent controller 4 of fifth embodiment 105 and 106.

FIG. X2 is a schematic view of intelligent controllers 4 of embodiment 101-104.

FIG. X3 is a flow chart illustrating the operation of adaptive flow device in independent mode.

FIG. X4 is a flow chart illustrating the operation of adaptive flow device in dependent mode.

FIG. X5 is a flow chart illustrating the operation of adaptive flow device in semi dependent mode.

FIG. X6 is a 3-D perspective view illustrating the positioning of embodiments 101-104 and accessories 20X in a ductwork 502.

FIG. X7 is a 3-D perspective view illustrating the positioning of embodiments 105 in a ductwork 502.

FIG. X8 is a 3-D perspective view illustration the positioning of embodiments 106 at the end of a ductwork branch 503.

FIG. X9 is a schematic and 2-D drawing illustration the application of the concept to the interior of an automobile. Airflow from the AC unit carries the scents released by the atomizer 28 into the interior of an automobile.

FIG. X10 is an illustration of wireless mesh Zigbee network.

### DRAWINGS—REFERENCES

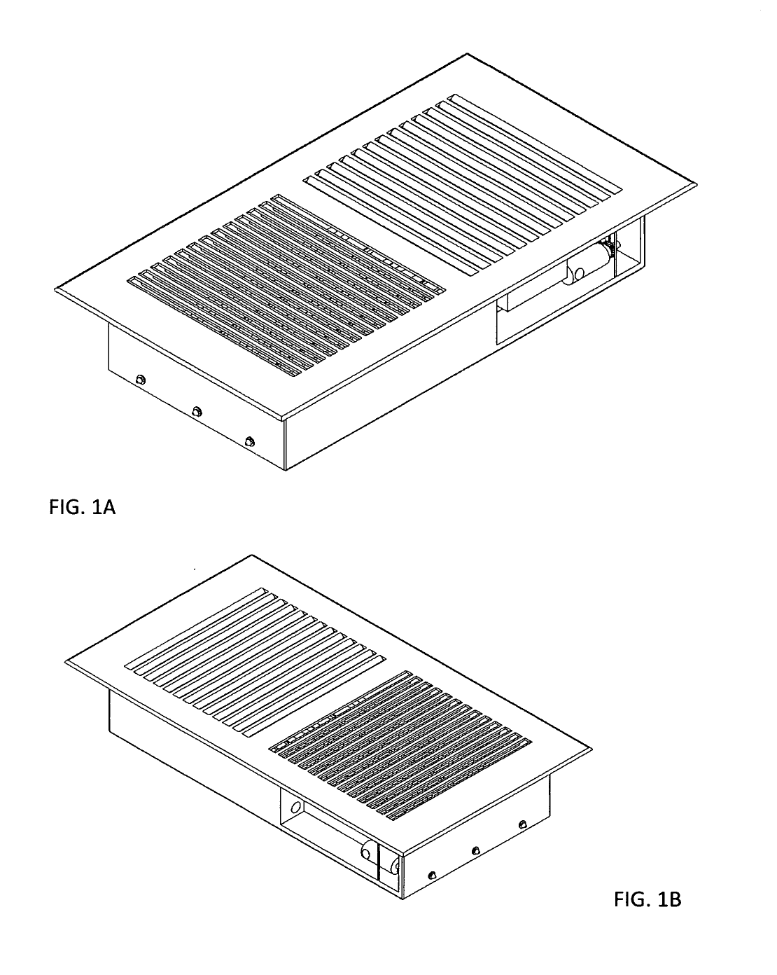

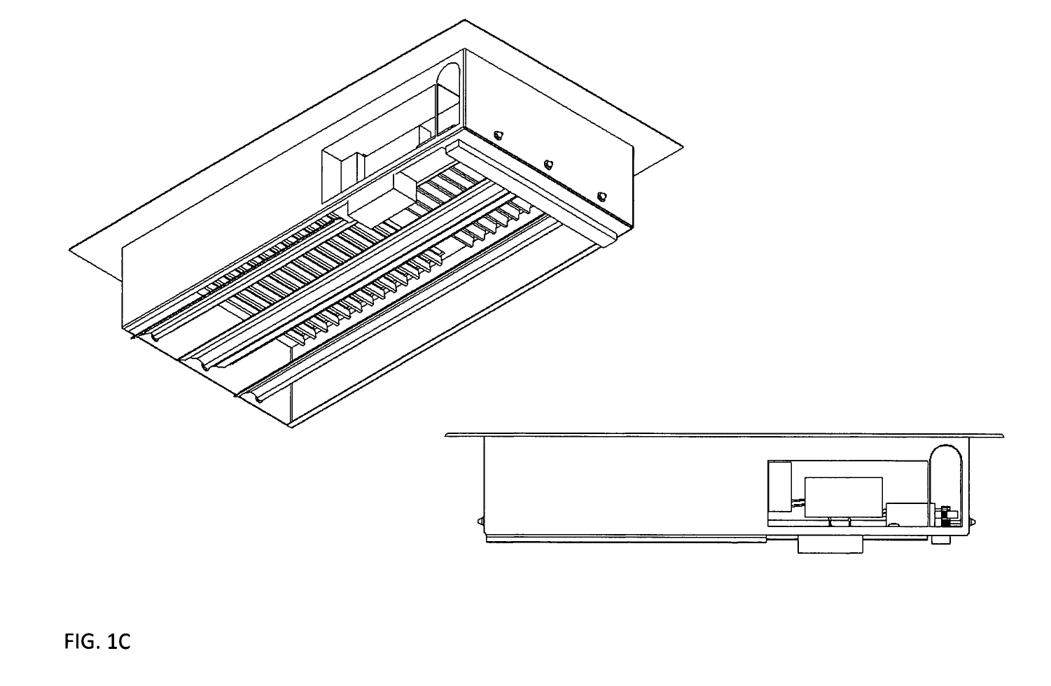

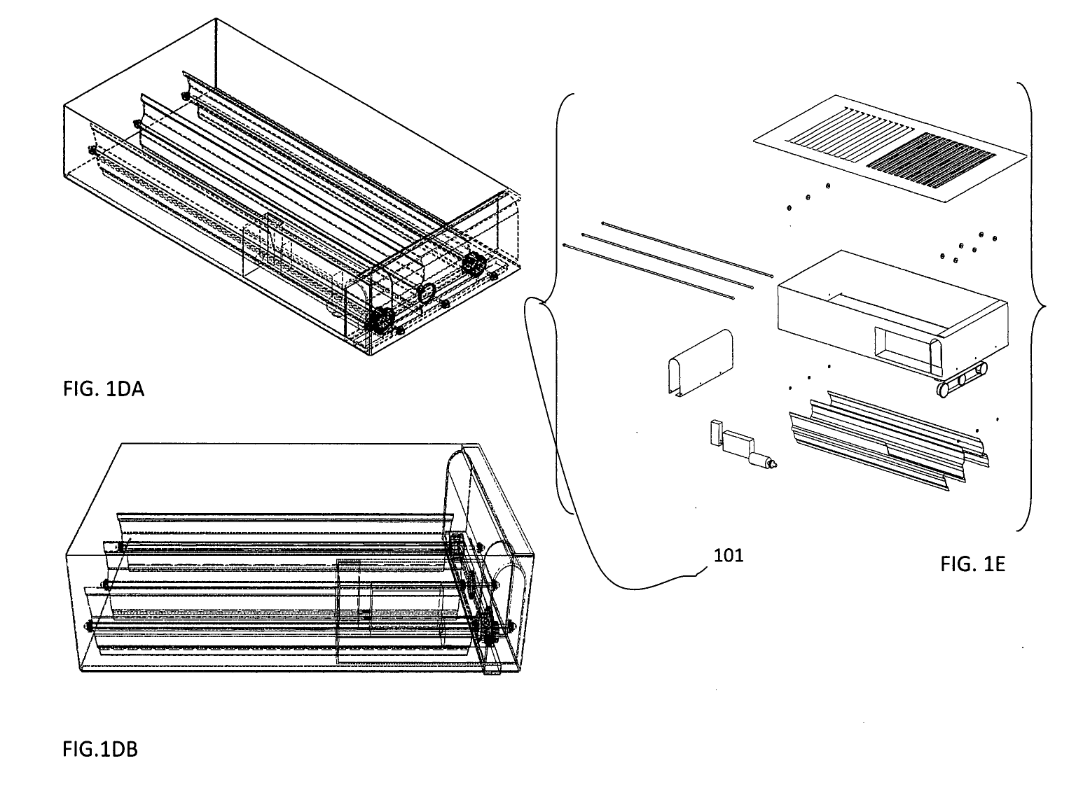

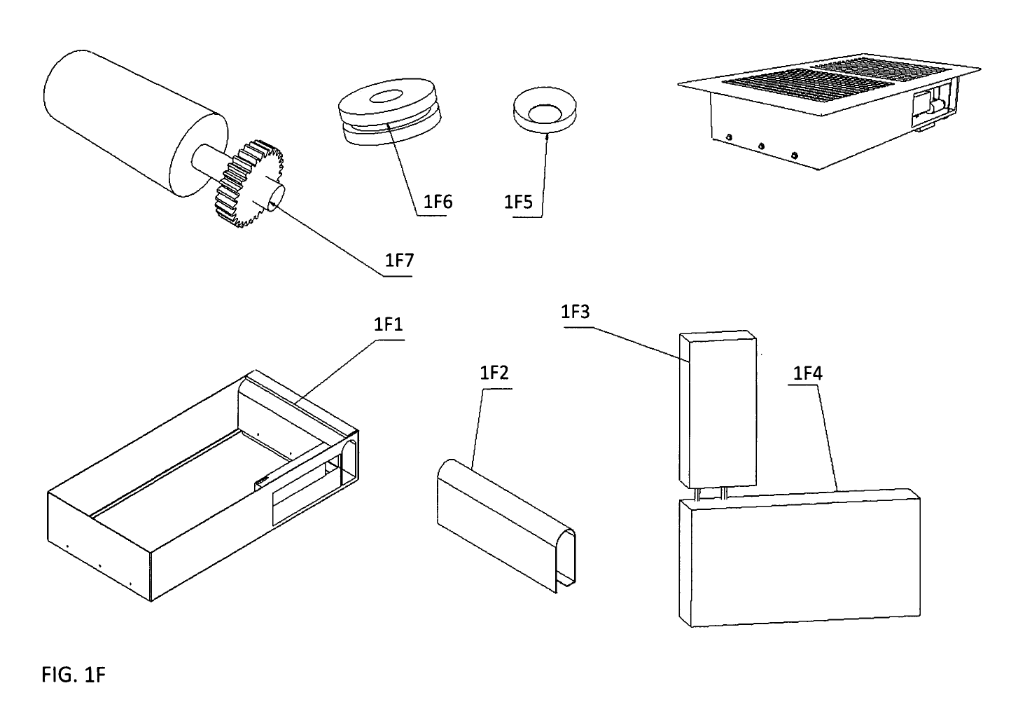

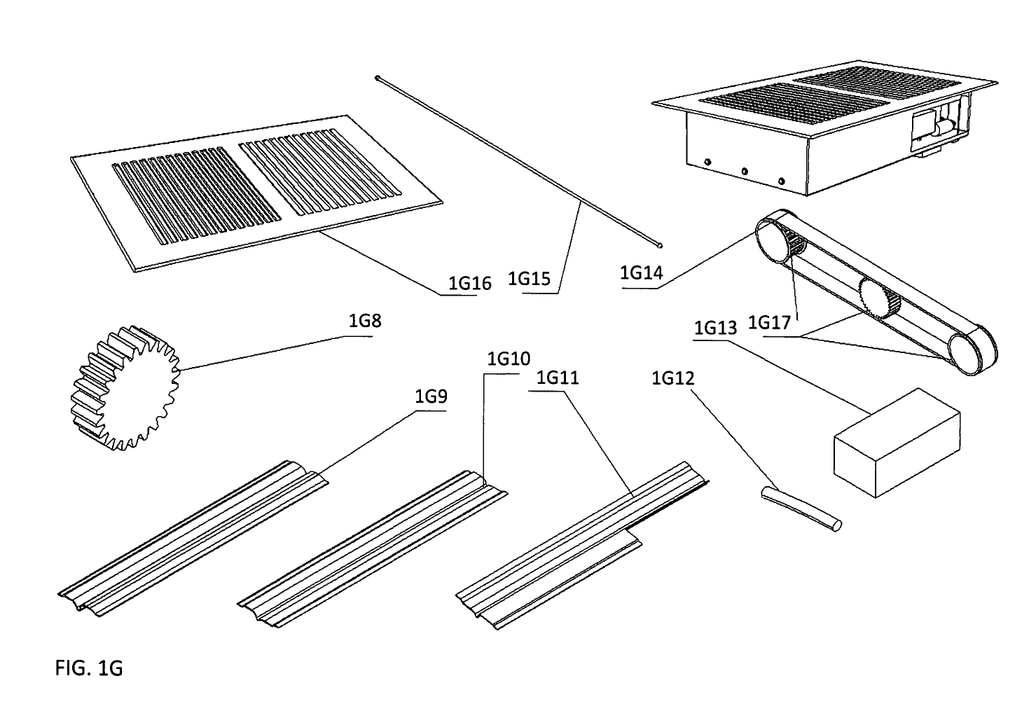

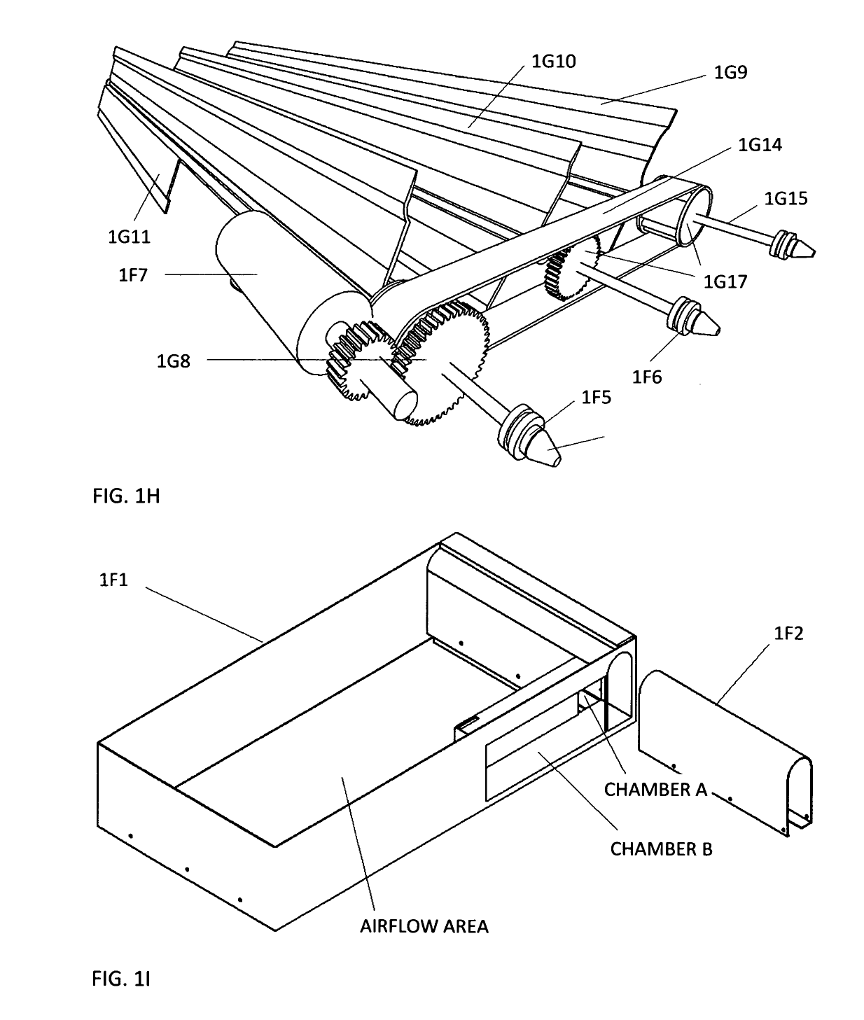

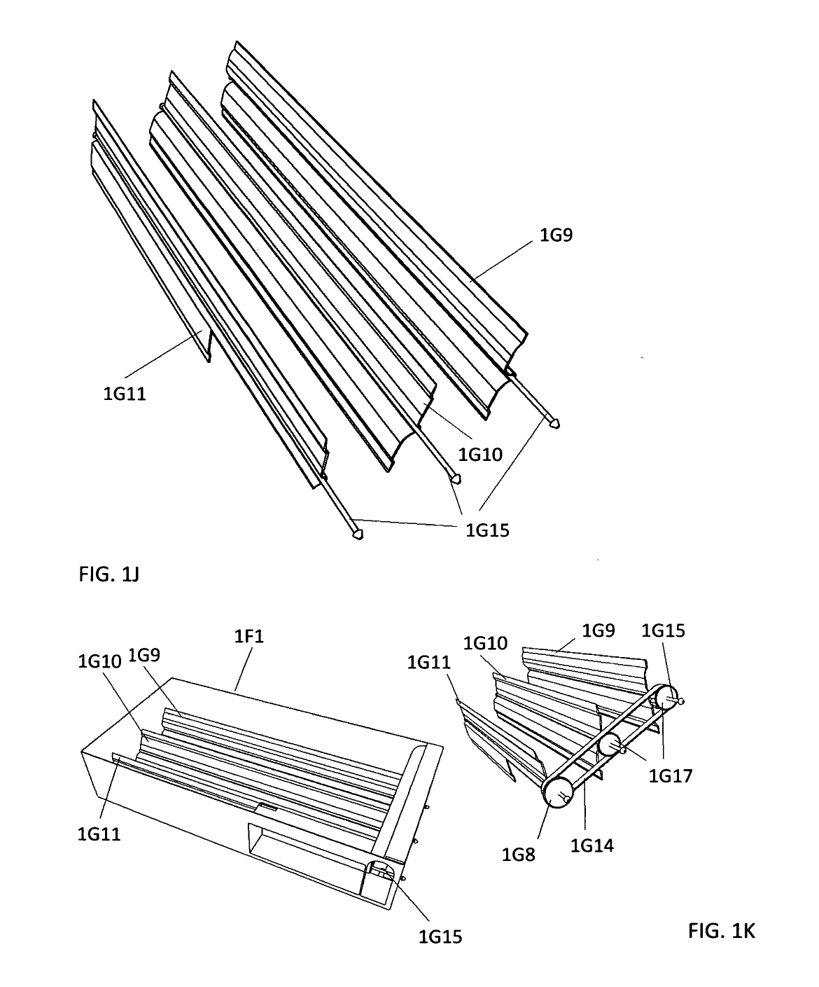

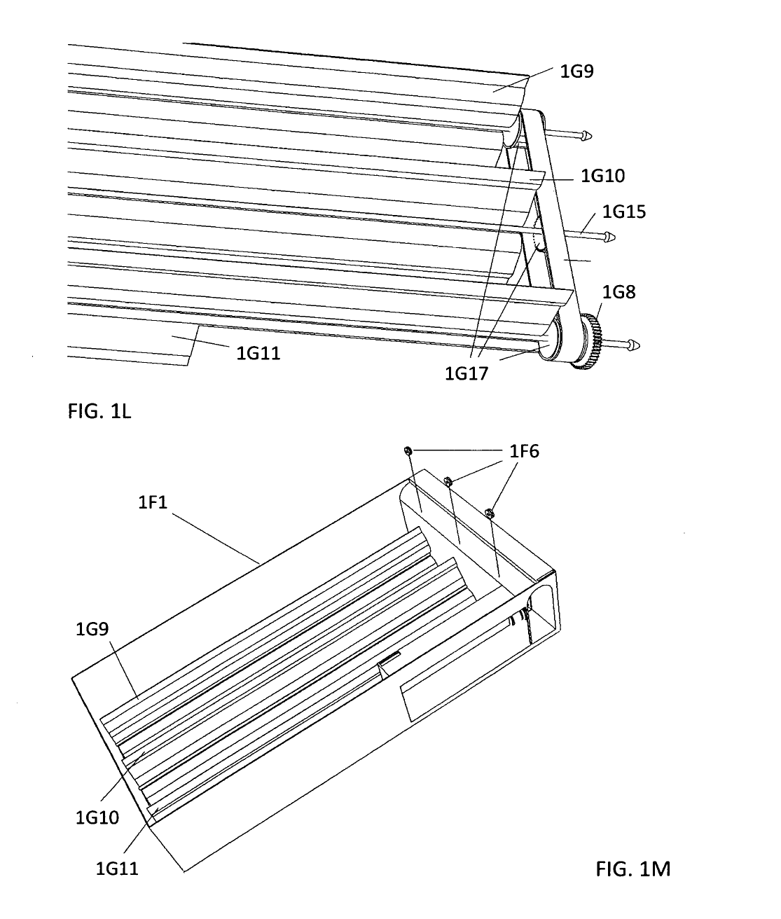

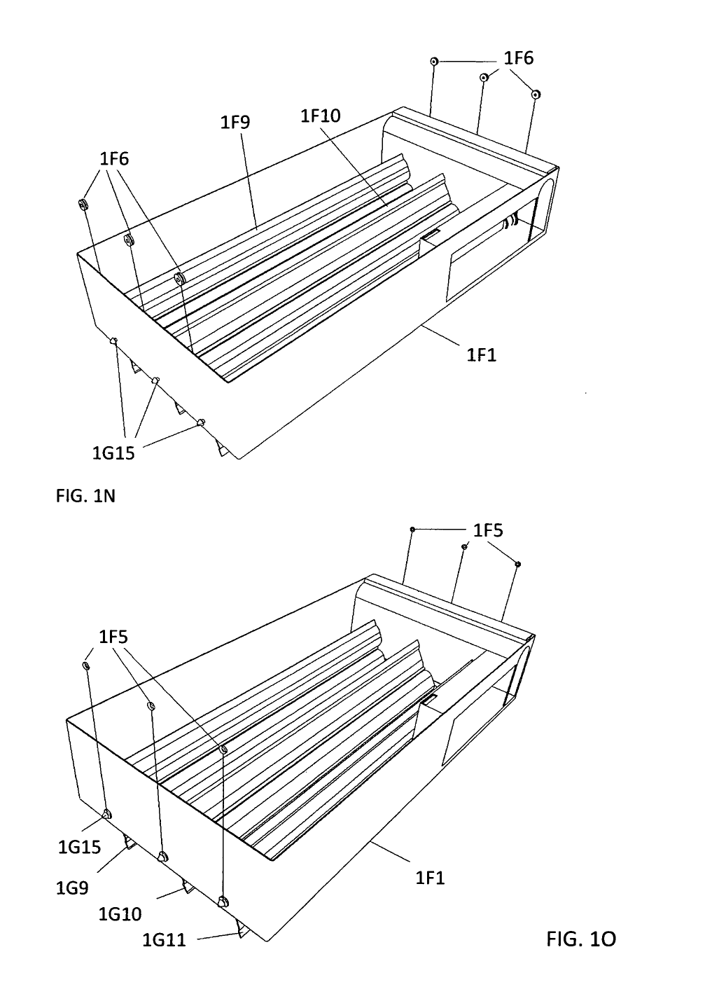

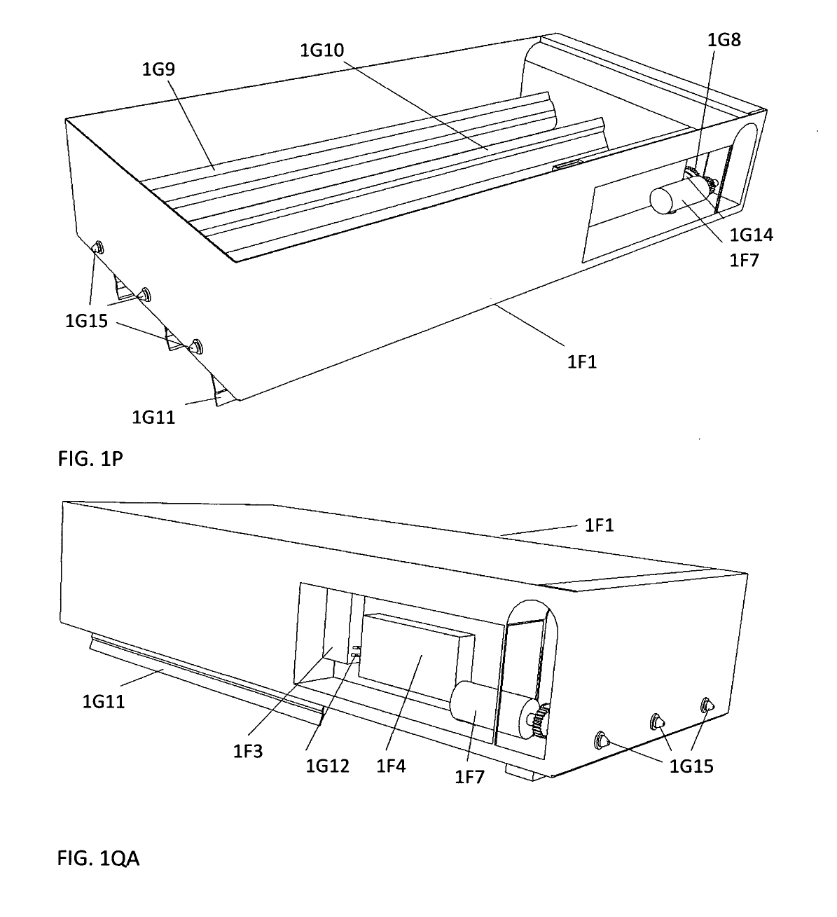

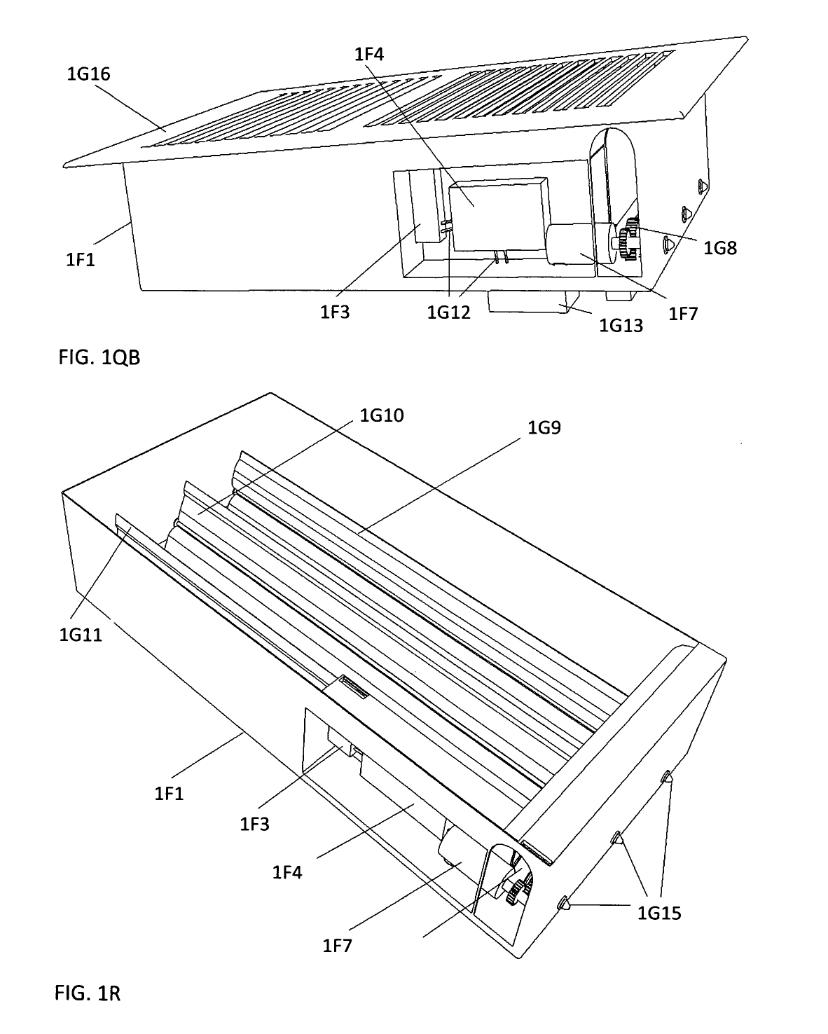

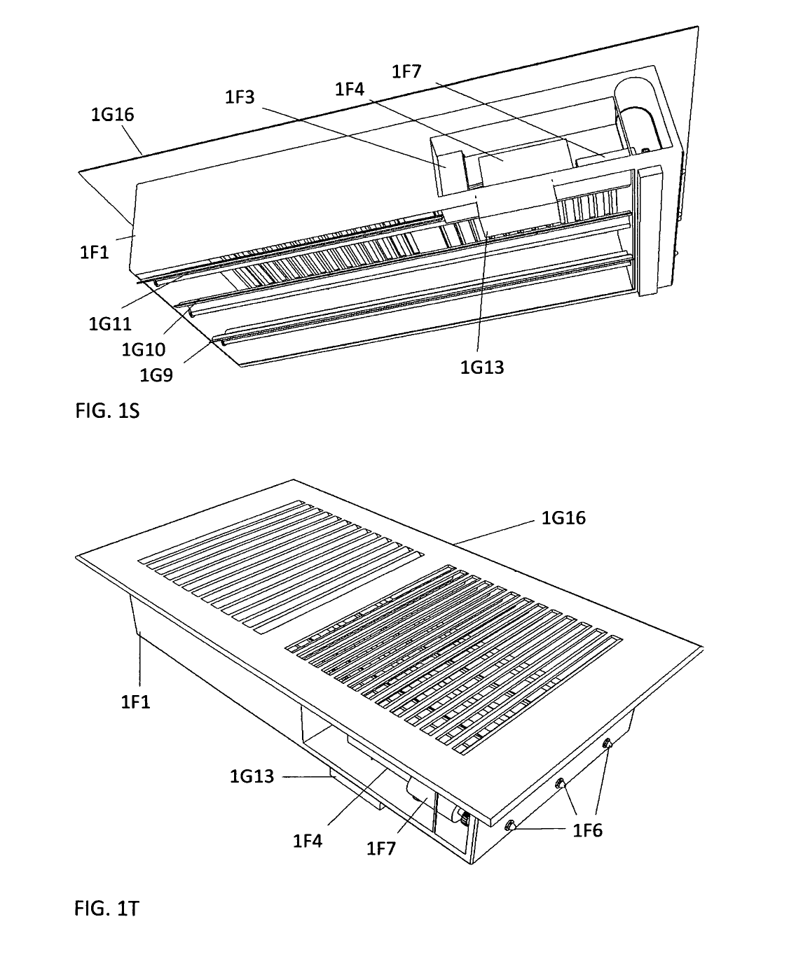

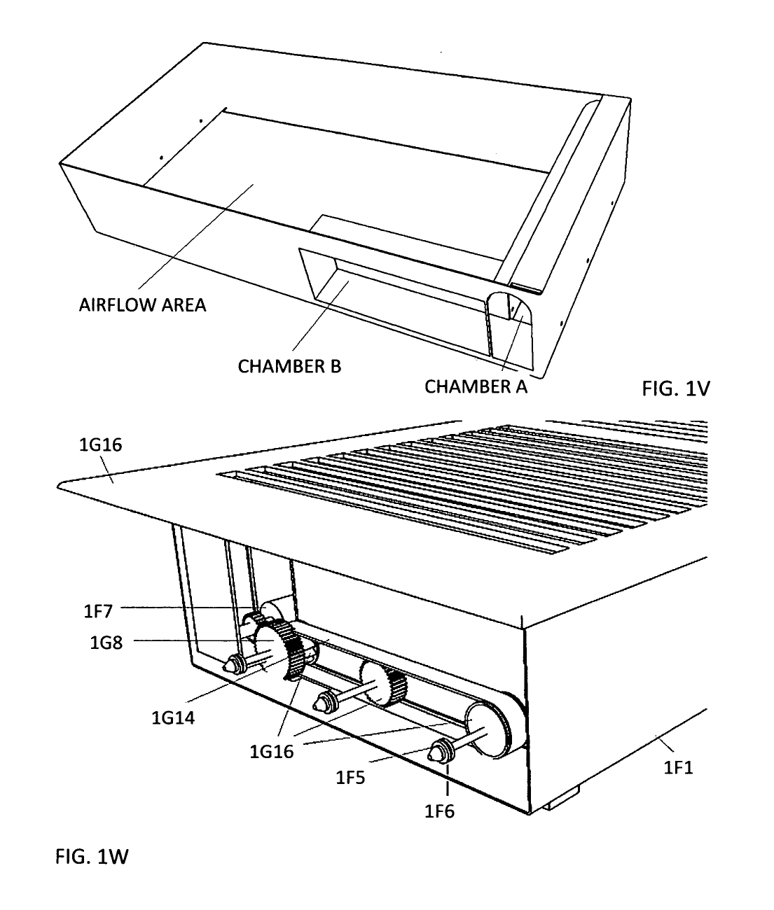

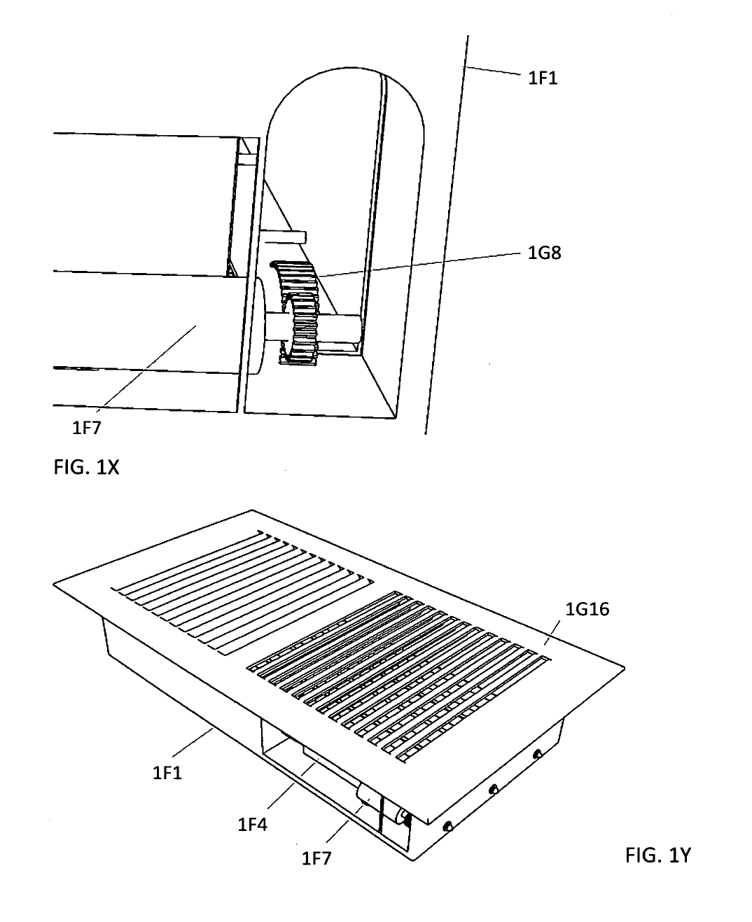

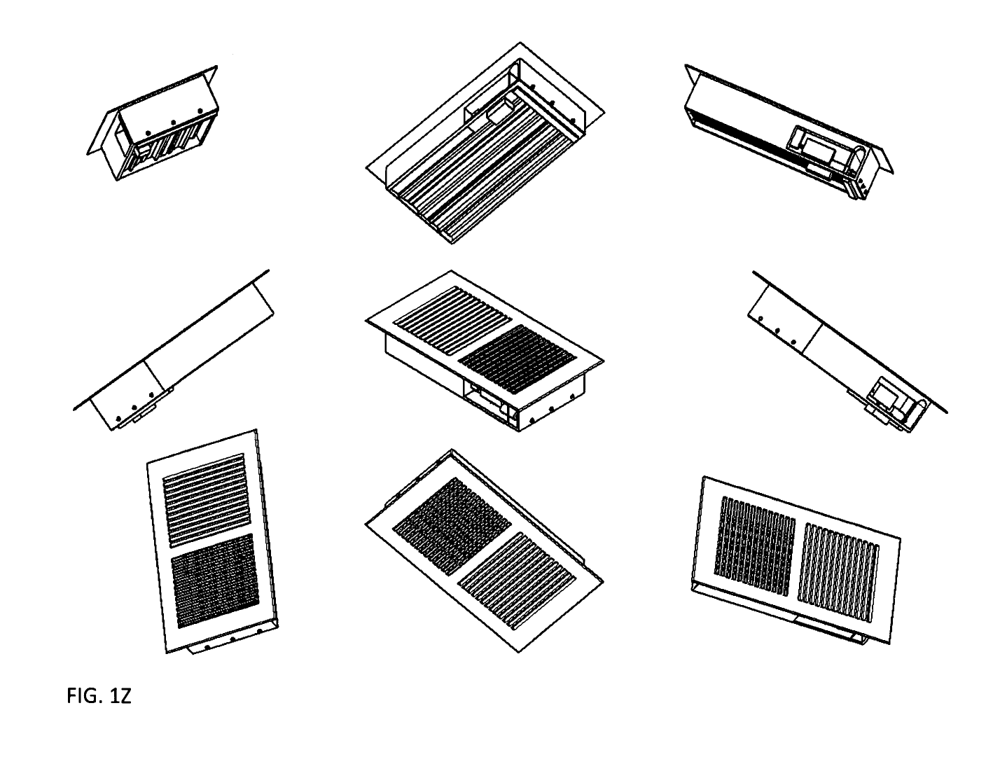

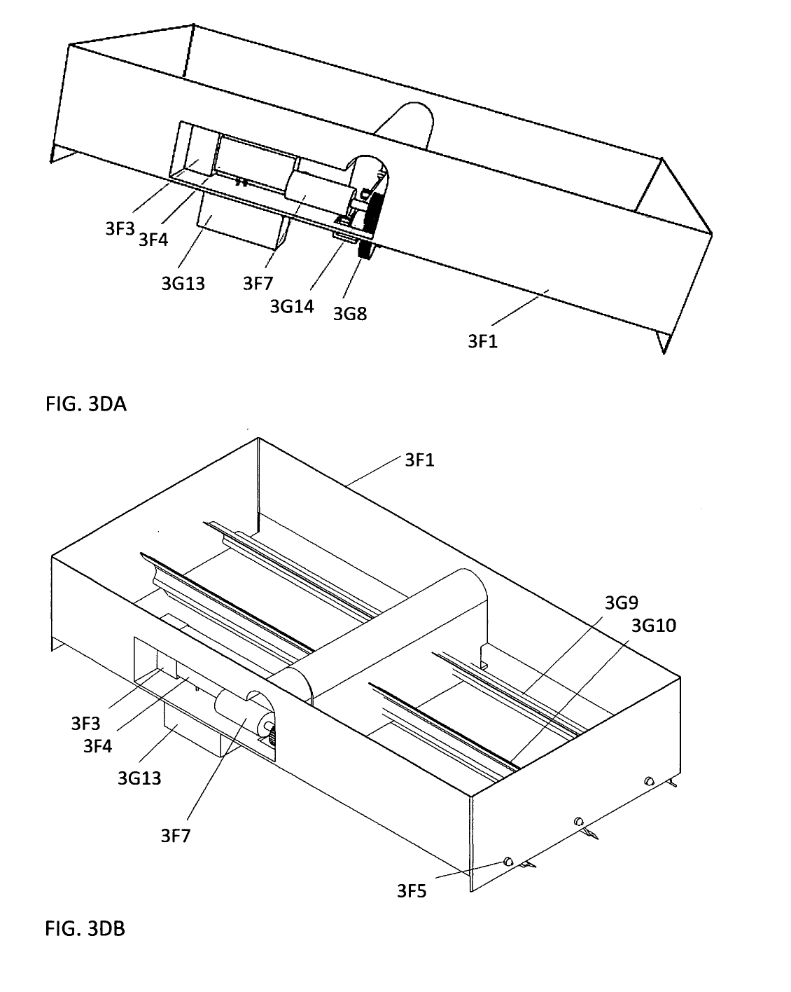

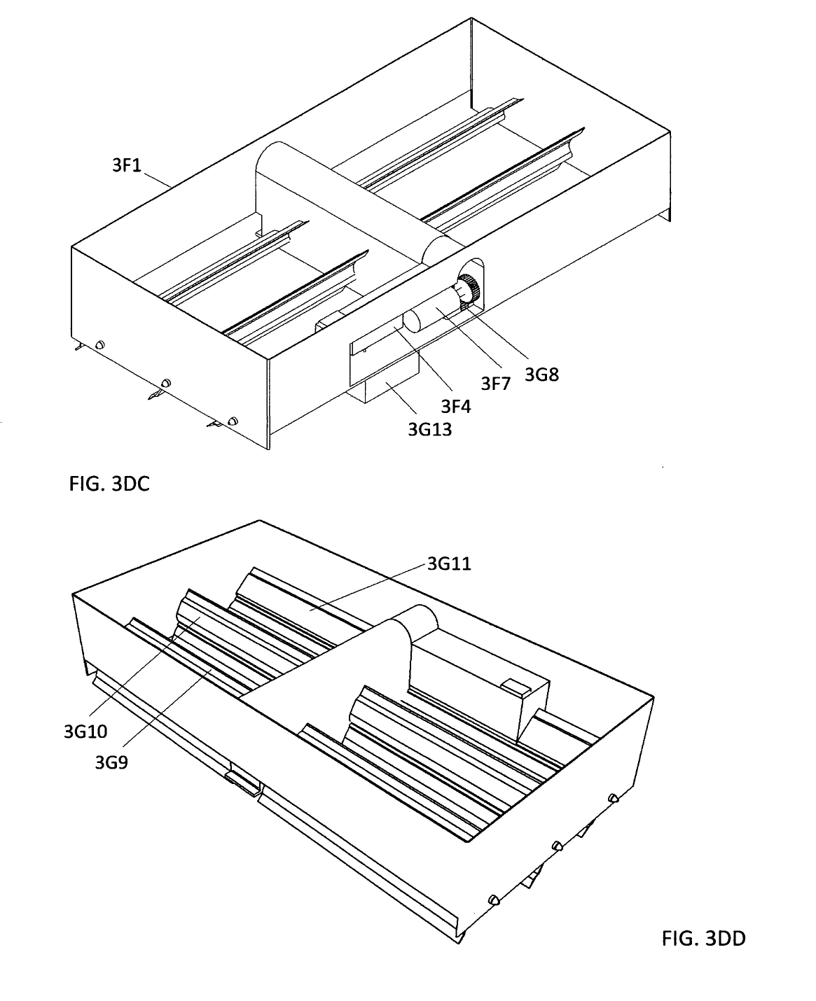

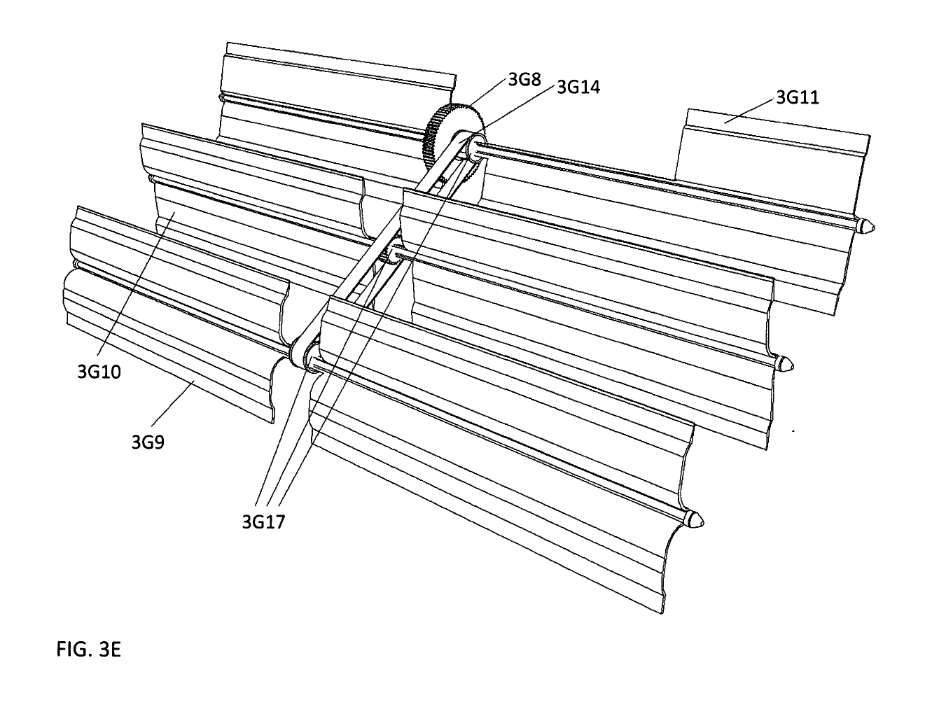

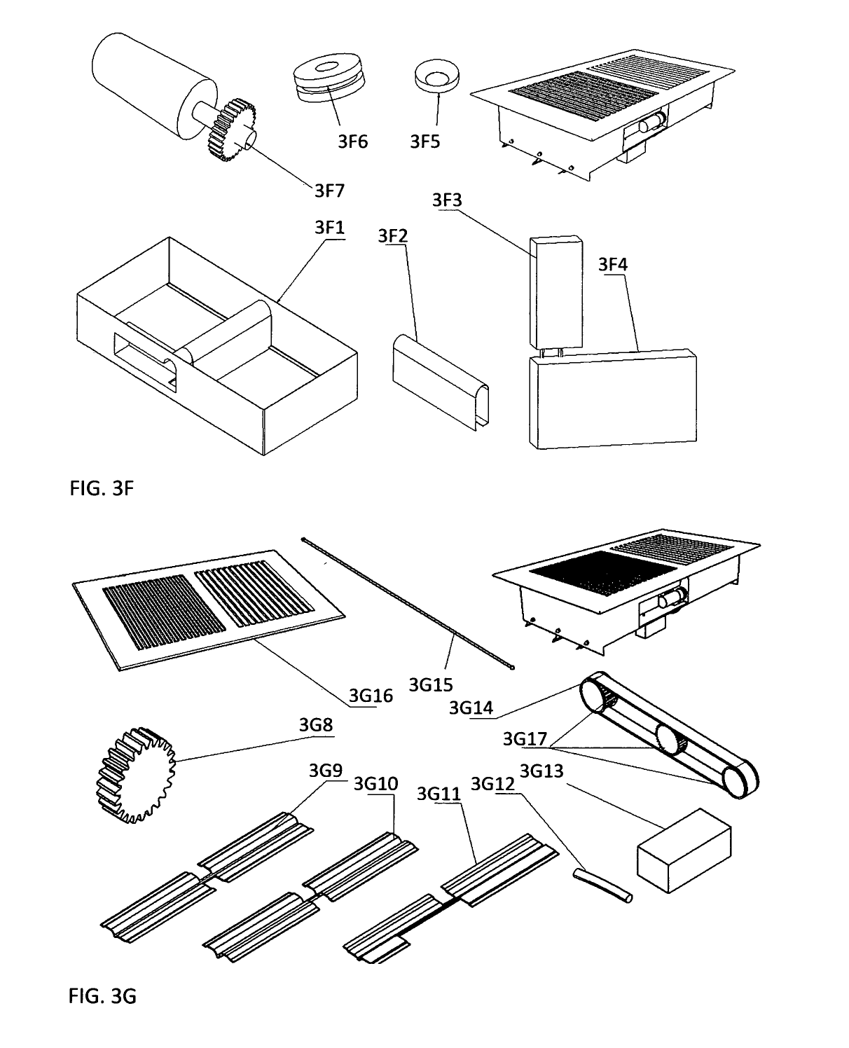

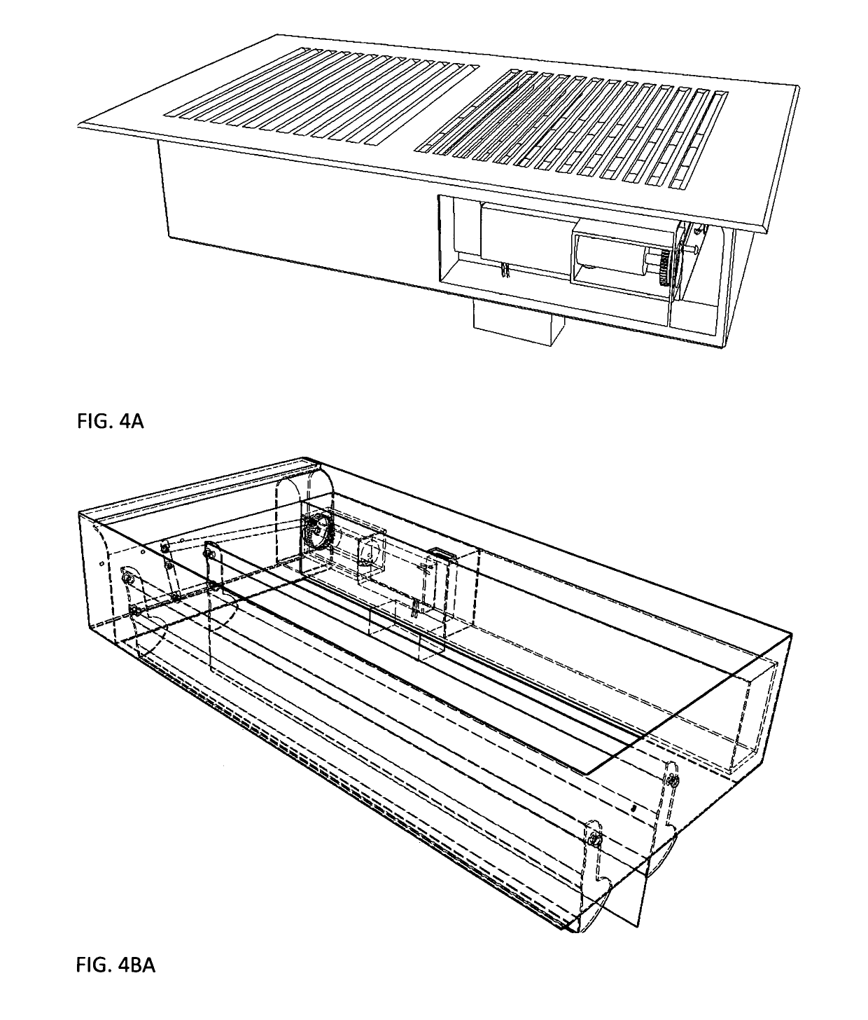

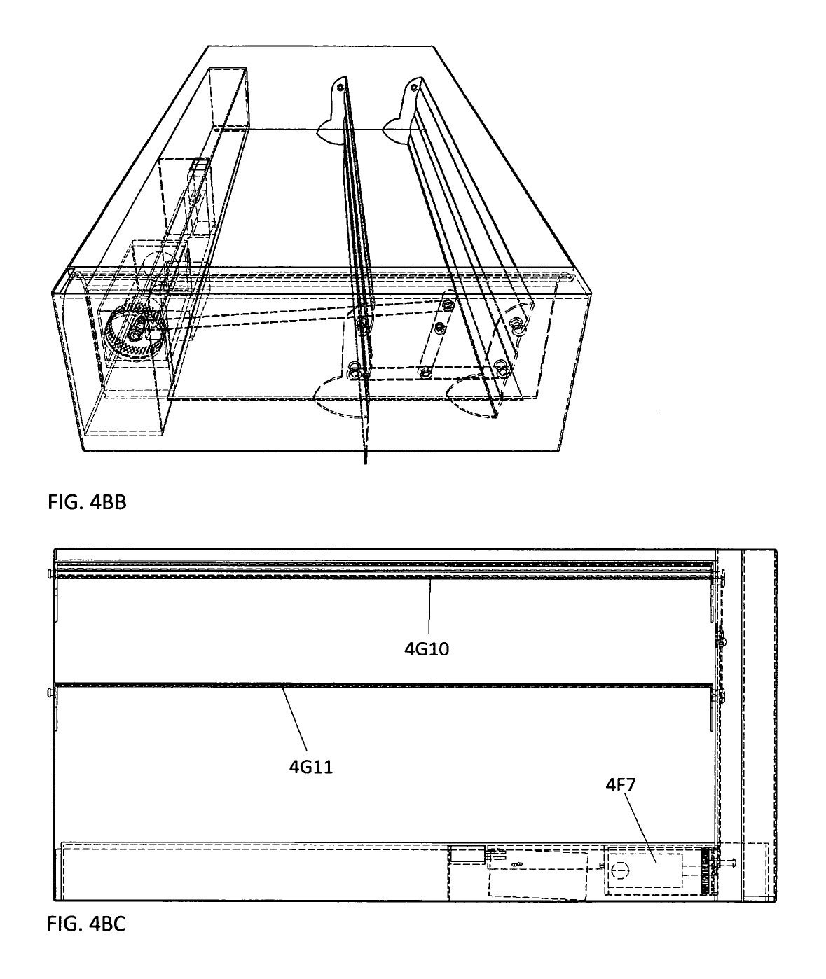

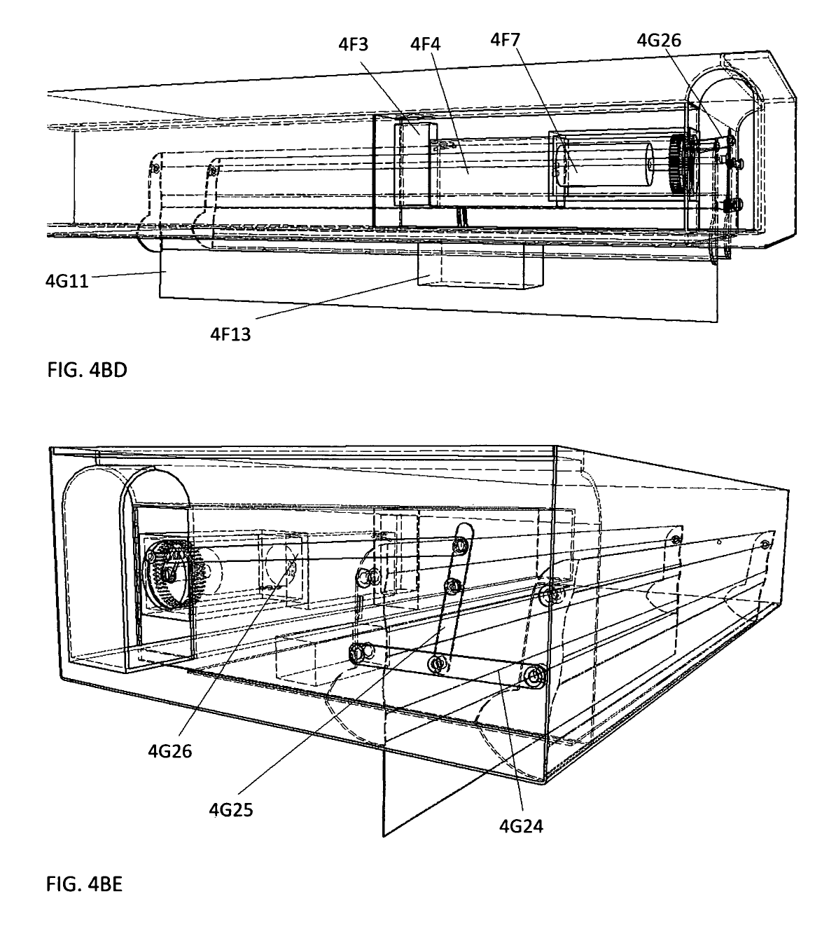

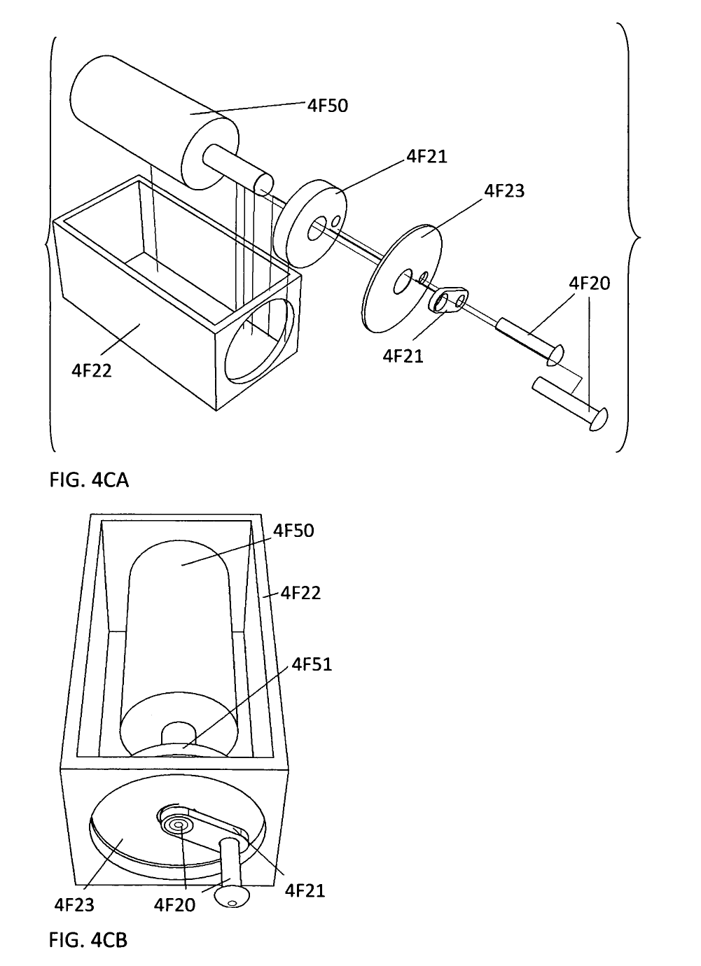

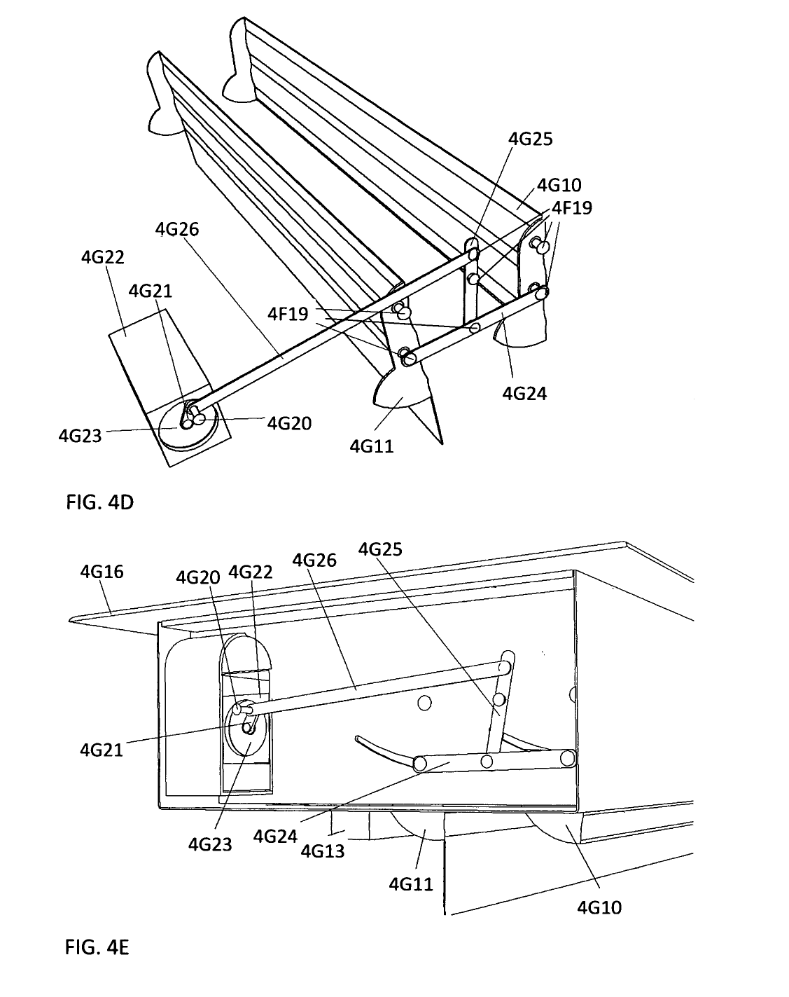

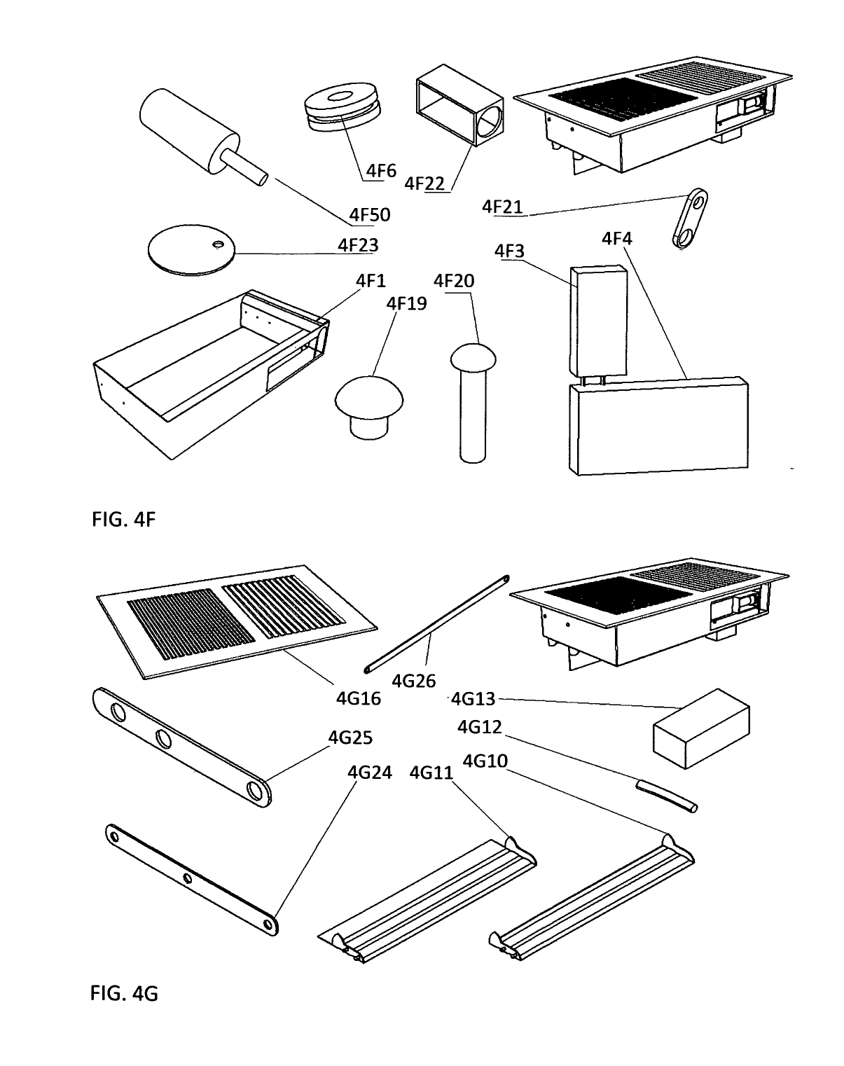

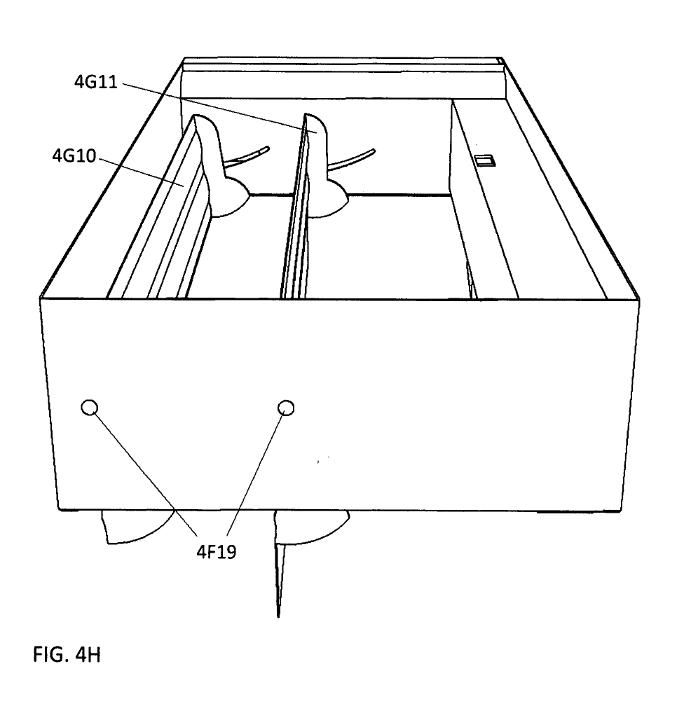

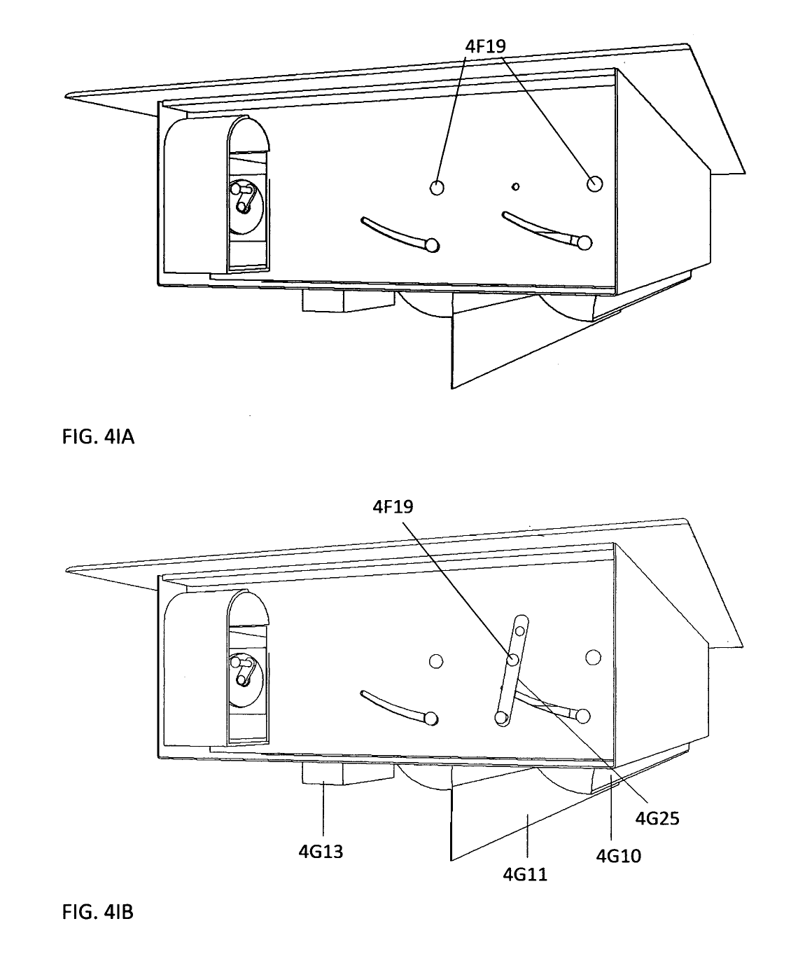

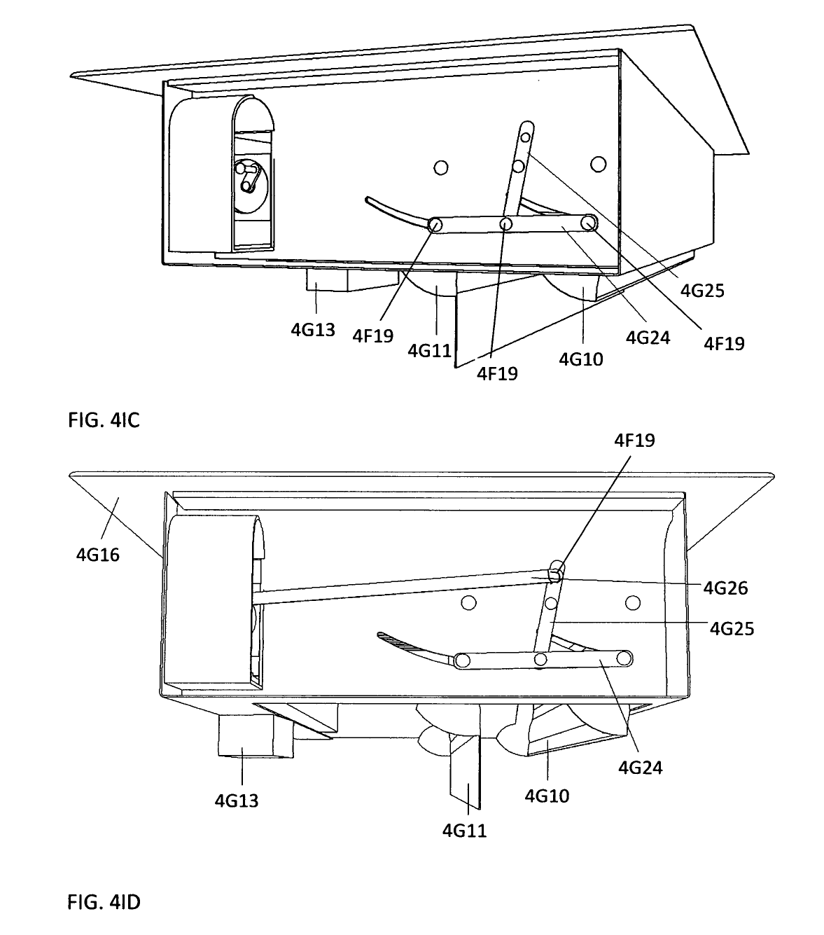

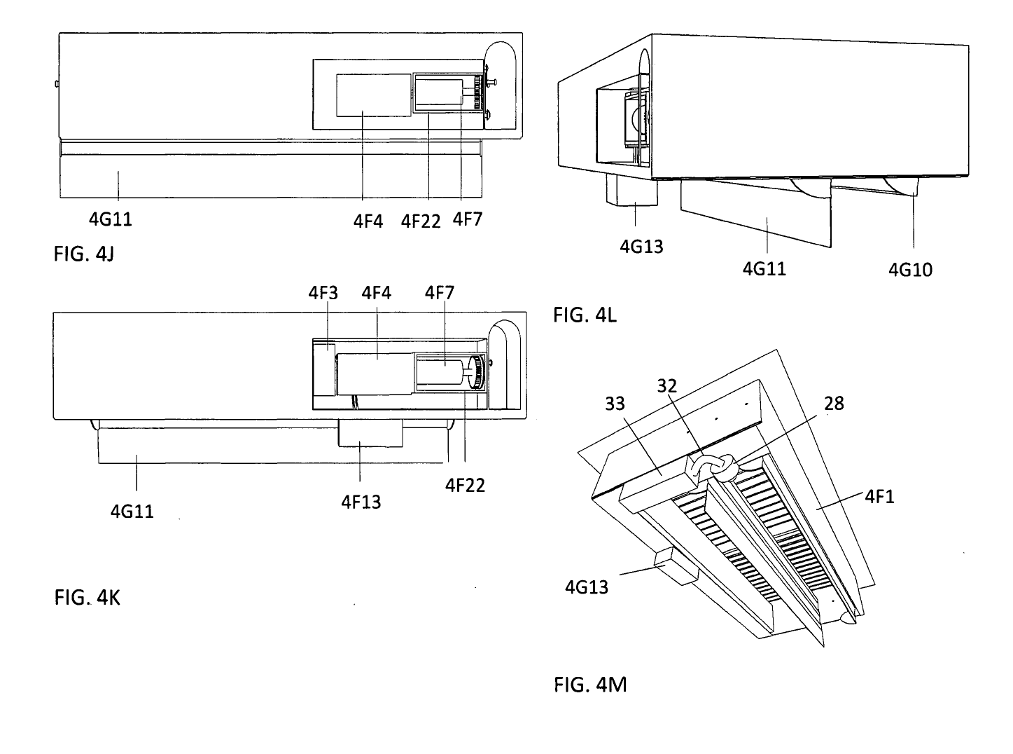

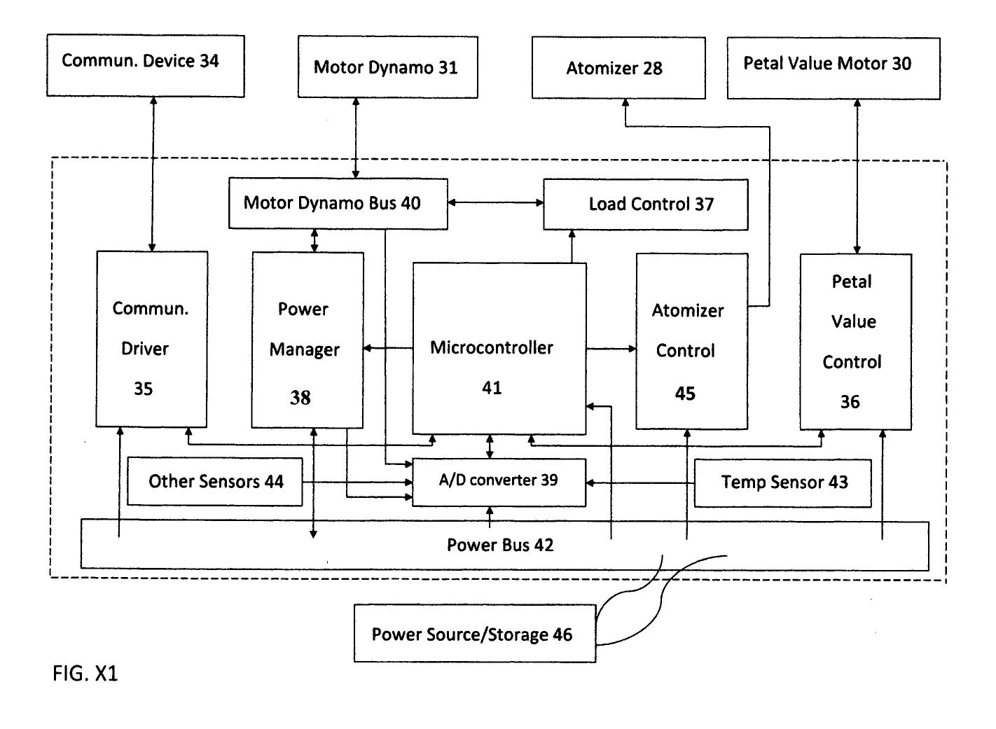

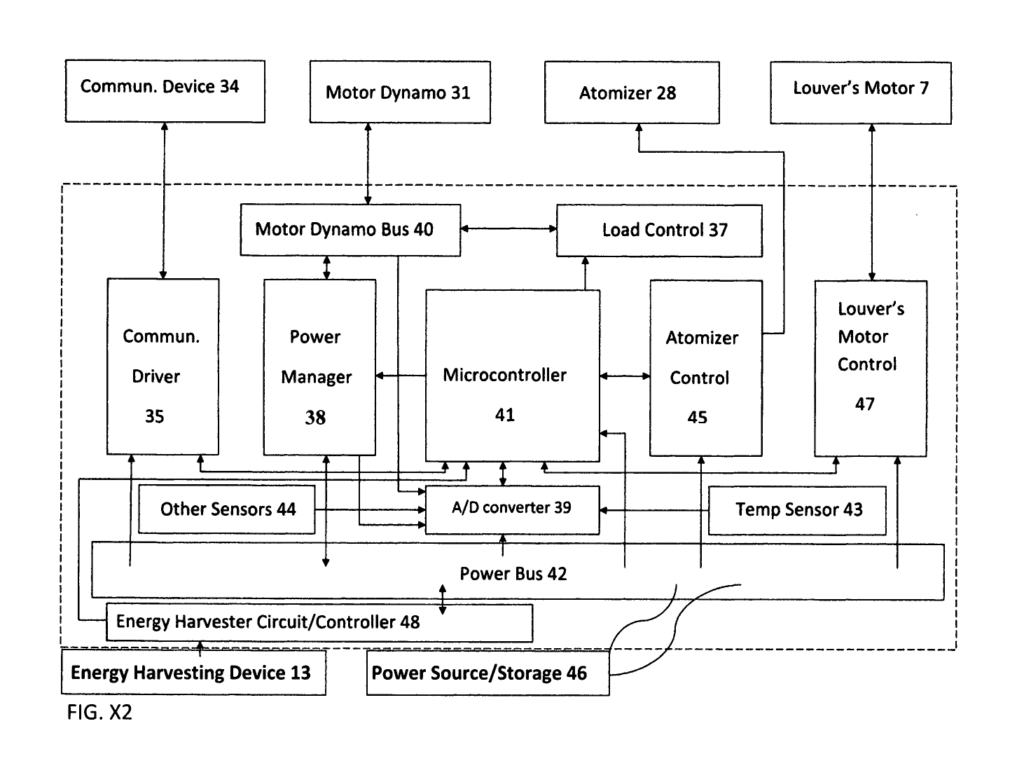

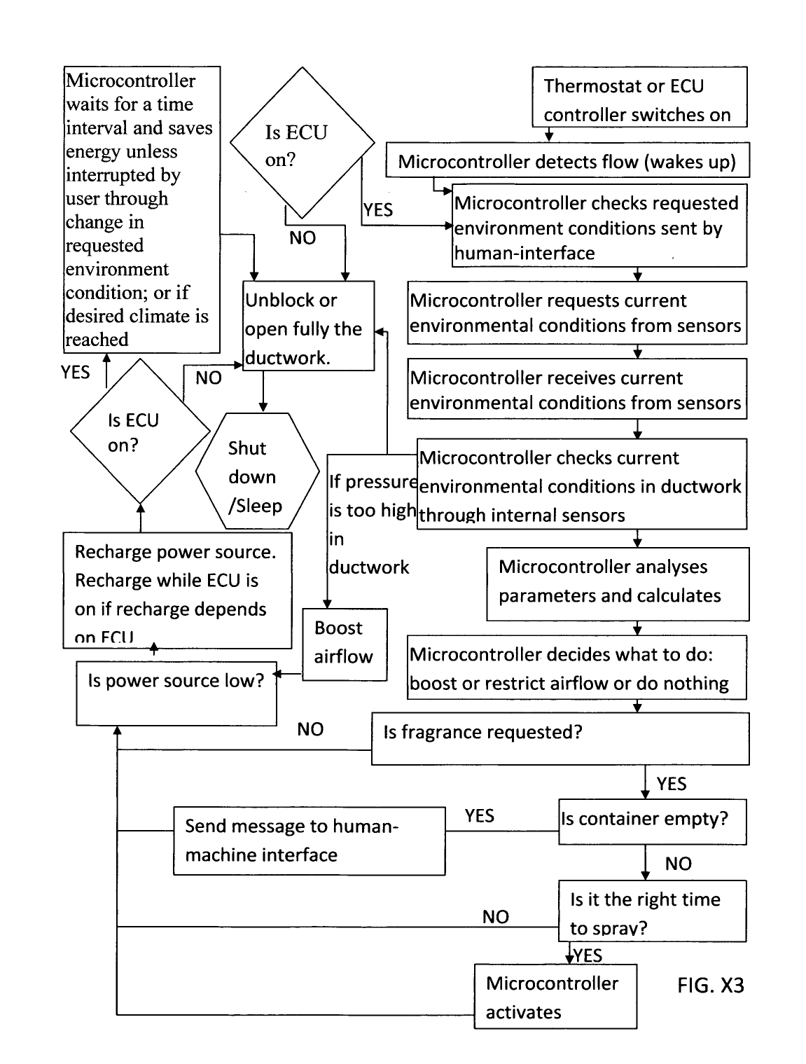

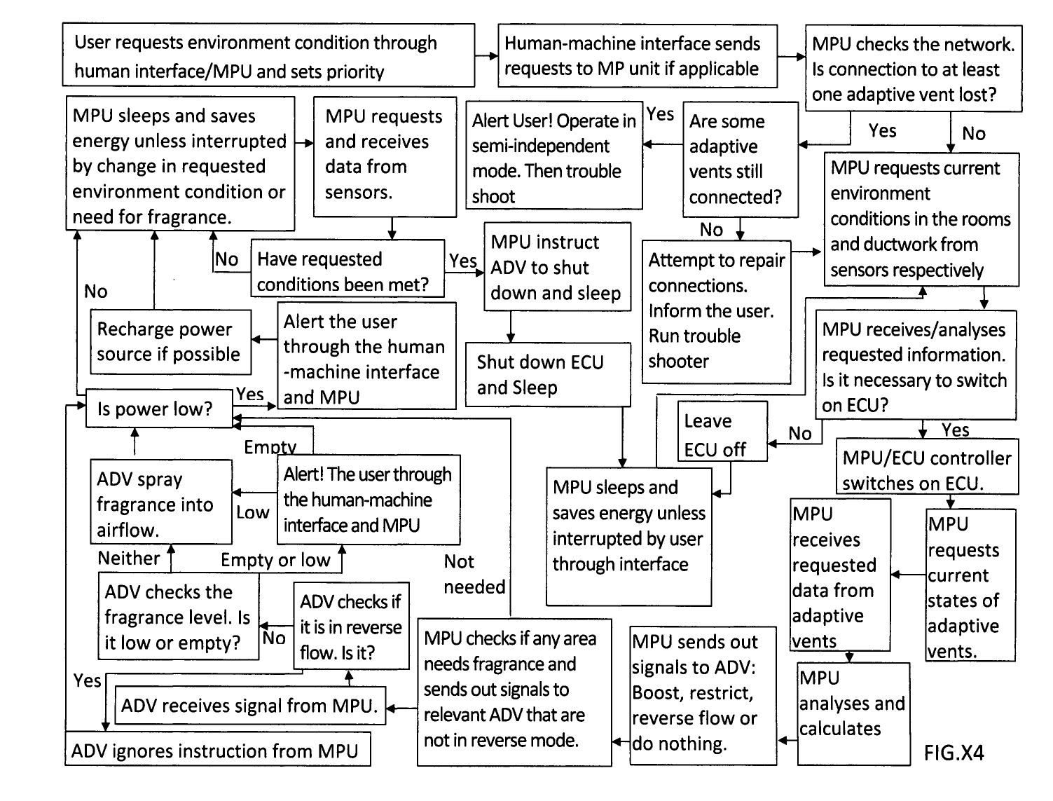

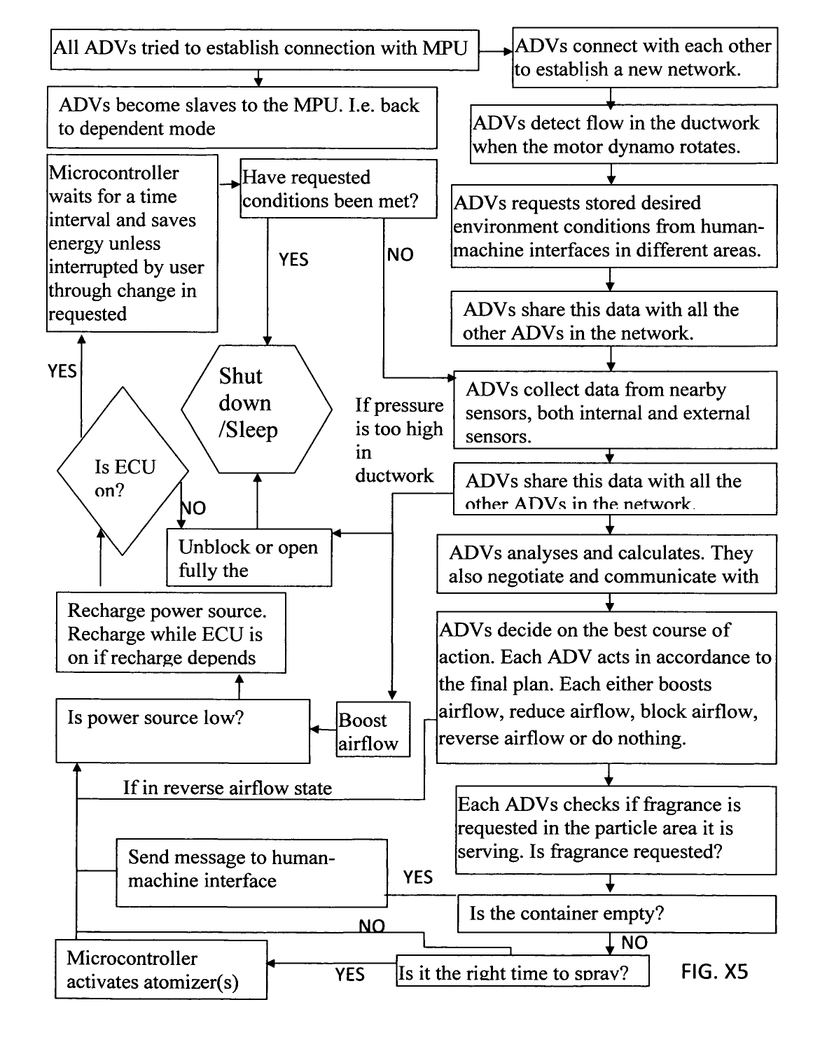

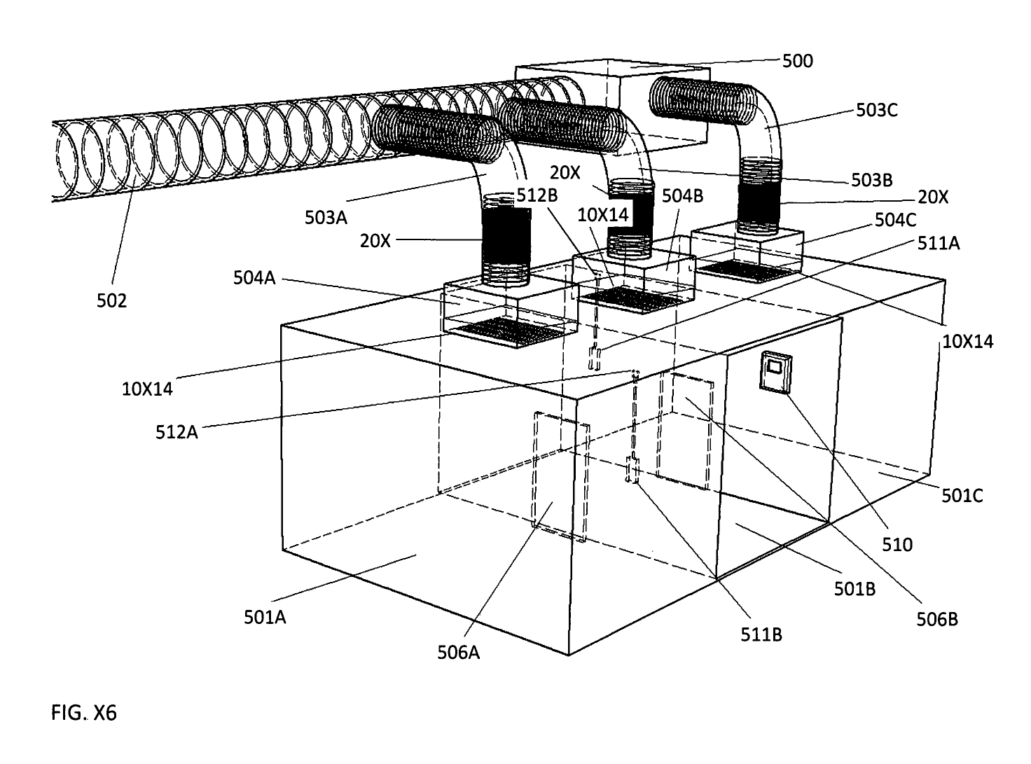

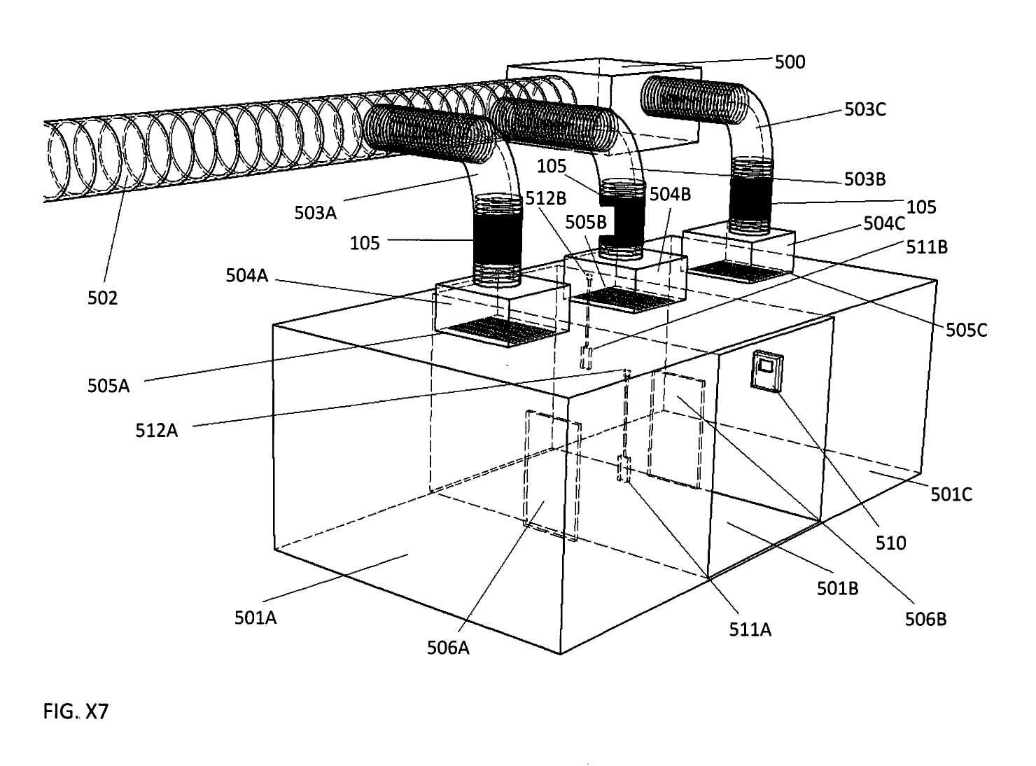

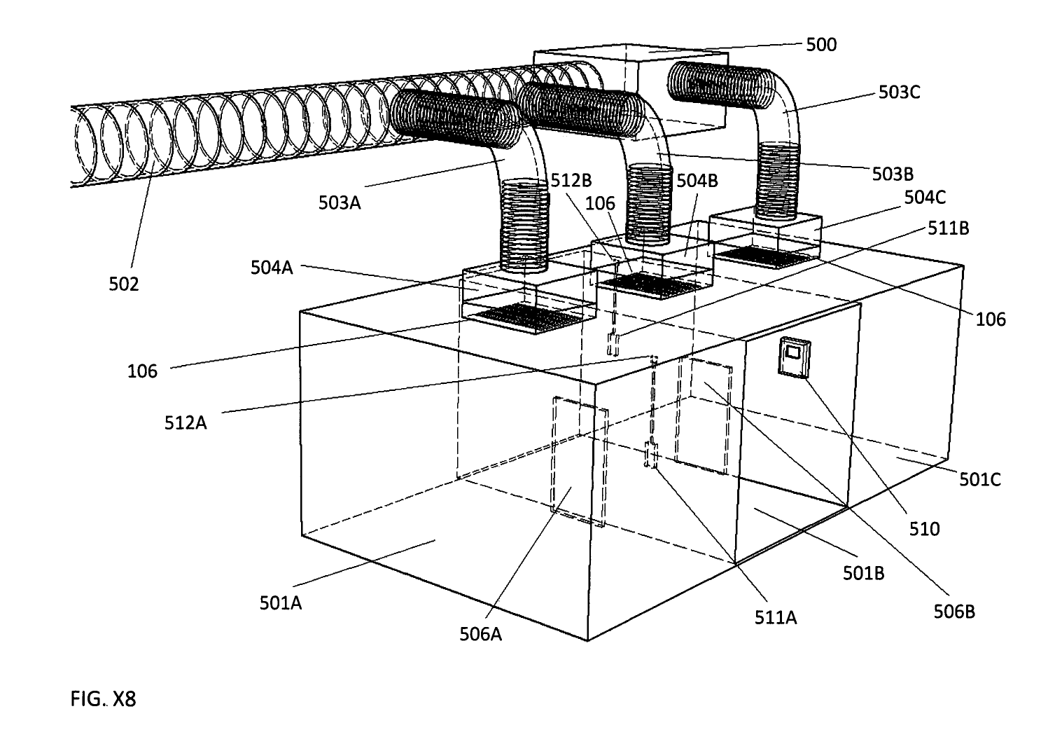

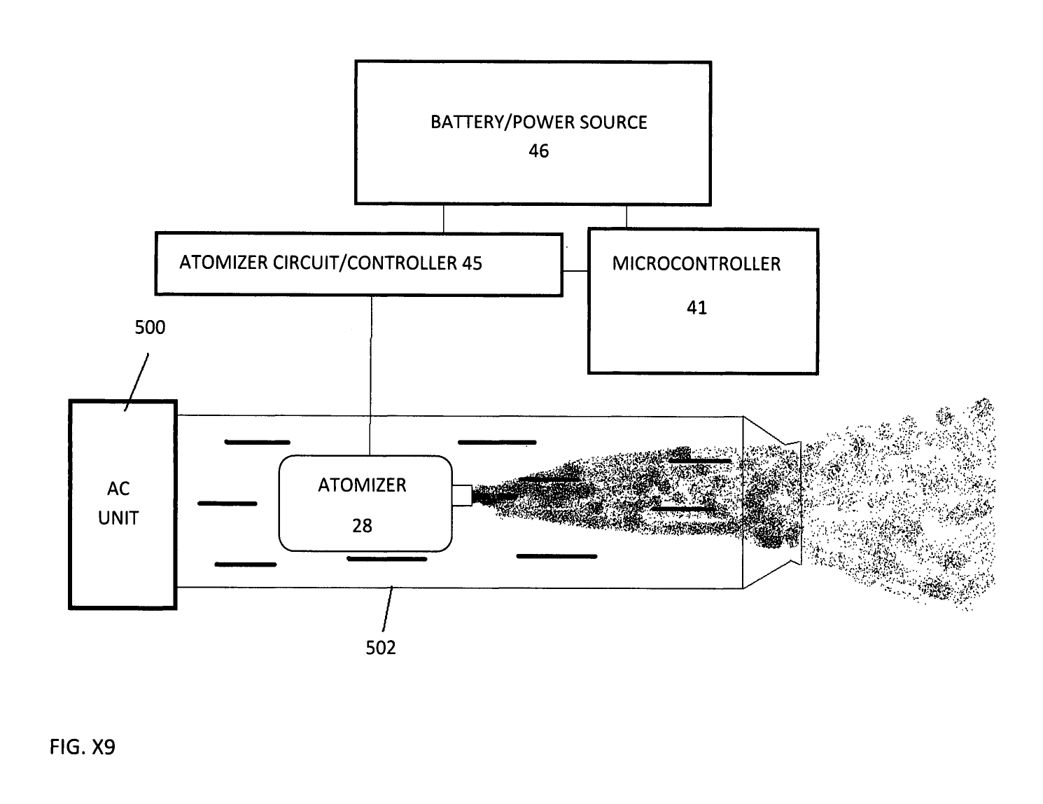

Note: #X?. →#X represents the figure e.g 1F is interpreted as FIG. 1F. The ? represents the code for a member of the embodiment. So 1F1 is a chassis drawing 1 found in FIG. 1F of the first embodiment, 3F1 is also a chassis drawing 1 but found in FIG. 3F. Likewise 4G11 is slat 11 found in FIG. 4G of the fourth embodiment, and 3G11 is also slat 11 found in FIG. 3G. The last digit is simply used to point out the part. Since all the embodiments have some parts in common, the # and X signs are used to specify the embodiment being referred to.

Label #X1 is a body or chassis of the embodiment, a framework that holds components in place.

Label #X2 is an insulating structure is used to insulate the chamber B (see Description of Drawing section) in order to keep some components functioning at their maximum.

Label #X3 is a wireless module/communication device that can be used to communicate with other processing units, devices and sensors.

Label #X4 is a processing/electrical module/intelligent controller, which could include a microcontroller or digital signal processor, used to control the motor 7.

Label #X5 is a washer that serves to reduce wearing of the parts (mostly the rotating rods) and also to reduce the airflow into the chamber (explained below).

Label #X6 is a bearing that allows easy rotation of the rod by reducing friction that could have existed between the rod and the chassis.

Label #X7 is a geared motor that can be used to rotate the gating construction from an open position to close position (and verse visa). It is also called the louvers motor since it is used to close the slats.

Label #X8 is a gear that transfers rotational kinetic energy from the motor. It is called the primary gear because it keys with the gear of the motor while attached to the rod

Label #X9 is a slat that is used as a gate to regulate airflow into a room.

Label #X10 is a slat that is used as a gate to regulate airflow into a room.

Label #X11 is a depiction of a slat that is used as a gate to regulate air-
flow into a room. Notice the difference in form when compared with the
other slats. It is also called the primary slat.
Label #X12 is a cable/wire.
Label #X13 is an energy harvesting module, with a charging
regulator included,
Label #X14 is belt used to rotate pulleys.
Label #X15 (15a, 15b, and 15c) is a depiction of the rod on which
the slats rest. The rotating of these rods will therefore
rotate the slats to open and close position.
Label #X16 is a depiction of the grill of the vent,
which I call vent lid too, which guides airflow
into a room.
Label #X17 (17a, 17b, 17c) depicts pulleys that can be attached to
the rods, so they serve as to transfer mechanical energy supplied
by the motor 7 to the rods. Note that these pulleys could be
geared pulleys
Label #X18 (18a, 18b, and 18c) is a gear of the second embodiment
Label #X19 is a fastener
Label #X20 is a fastener
Label #X21 is a short flat rod
Label #X22 is a chassis for the motor of
fourth embodiment.
Label #X23 is flat circular metal
Label #X24 is a lower flat rod
Label #X25 is a lever
Label #X26 is a long flat rod
Label #X27 is a fan
Label #X28 is an atomizer
Label #X29 is a petal valve
Label #X30 is a petal valve's motor
Label #X31 is a motor dynamo
Label #X32 is a tube
Label #X33 is a container
Label #X34 is a communication device
Label #X35 is a communication driver
Label #X36 is petal valve motor control
Label #X37 is load control
Label #X38 is a power manager
Label #X39 is an A/D converter
Label #X40 is a motor dynamo bus
Label #X41 is a microcontroller
Label #X42 is a power bus
Label #X43 is a temp sensor
Label #X44 is a sensor
Label #X45 is an atomizer control
Label #X46 is a power source/storage
Label #X47 is a louver motor control
Label #X48 is an energy harvesting
circuit/controller
Label #X50 is a motor
Label #X51 is another flat circular plate
Label #X52 is a wire
Label #X53 is fragrance container's space
Label #X10X is an adaptive flow device
Label #X101 is first embodiment
Label #X102 is second embodiment
Label #X103 is third embodiment
Label #X104 is fourth embodiment
Label #X104 is fifth embodiment
Label #X106 is sixth embodiment
Label #X201 is Accessory A
Label #X202 is Accessory B
Label #X20X is Accessory A or B
Label #X500 is an environmental control
unit
Label #X501 (501a, 501b, 501c) is a room
Label #X502 is the ductwork
Label #X503 (503a, 503b, 503c) is a
ductwork branch
Label #X504 (504a, 504b, 504c) is a register
box
Label#X505 (505a, 505b, 505c) is an air
vent
Label #X506 (506a, 506b) is a door
Label #X510 is a master processing unit
wall panel
Label #X511 (511a, 511b) is a human
interface device
Label #X512 (512a, 512b) is an external
sensor
Label #X10X14 represents either one of the
embodiments 101 to 104

### DESCRIPTION OF DRAWING—FIRST EMBODIMENT

FIG. 1 (note that this applies to all figures with the number 1 preceding the alphabet e.g FIG. 1A, FIG. 1B, etc) illustrates one embodiment of the concept which I will refer to as the first embodiment 101 from now on. The drawings show various constructive stages and components of the first embodiment 101 viewed from various angles. Essentially, they capture how each member of the embodiment connects with each other and also reveal other aspects of it.

FIG. 1A is a top right isometric view of the final build of the first embodiment 101. The frame 1 or chassis 1 or body 1 of the device is divided into two areas: the airflow area and the chamber. FIGS. 1B and 1C are other views of the embodiment, while FIGS. 1DA and 1DB are views with hidden lines revealed for insight to the inner workings of the embodiment. Some of the various sub-mechanisms of the embodiment are obvious in the depiction of FIG. 1D. This includes the chassis of the machine, the gating mechanism (obvious after closer inspection), a gear motor, and some electronic modules. To avoid ambiguity, the face with chamber B bordering it is regarded as the front of the embodiment, while the vent lid (1G16) is the top face.

The depictions in FIGS. 1F and 1G are drawings of members of the first embodiment 101 that are needed for building such a machine. FIG. 1F shows: a chassis 1F1, an insulating structure 1F2, a wireless module 1F3, a processing module 1F4, a washer 1F5, a bearing 1F and a geared motor 1F7 (note the electrical connection, two wires, between the wireless module and the processing unit). FIG. 1G shows: a primary gear 1G8 (called primary because the gear is in contact with the geared motor), 3 slats 1G9-1G11 (notice that the third slat has a section cut to accommodate the chamber B as I will explain later), cable 1G12, a energy harvesting module 1G13, a toothed belt 1G14, a rod 1G15 (3 rods are needed. They could be solid or hollow), a vent grill 1G16, and 3 toothed pulleys 1G17. A plurality of washers and bearings are used in this embodiment. At this point, it is worth mentioning that a major difference between this embodiment and some other embodiments is the gating mechanism. FIG. 1H is an insight to the inner working of the gating mechanism for the first embodiment (more on this later).

As mentioned earlier the chassis 1 is divided into two areas: the airflow area and the chamber area as can be seen in FIG. 1V. The flow area is the area where the air/fluid flows through the frame while the chamber area houses the necessary components of the machine such as the motor, processing unit/electrical module, pulleys and belt, etc. The chamber is further divided into two sections: the mechanical area (which I like to name chamber A) and the electronic area (which I like to name chamber B). In the first embodiment, chamber A is located to the right side of the chassis while chamber B borders the frontal face. Chamber A is designed to house the primary gear 8, pulleys 17, and belt 14 while chamber B area is designed to house the geared motor 7 and the printed circuit board (PBC)/electrical modules (note that components will sometime overlap the areas). Through the chassis 1 are holes where the rods 15 will be passed through. Bearings 6 are also inserted into these holes to reduce friction between the rods 15 and chassis 1. The chassis 1 can be made out of any material suitable for the function and the environment. For example, materials such as a metal alloy or plastics can be used.

Note that the following description of embodiment 101 is not a recipe or manual of how to manufacture or build the machine; it is only a means of explaining how all the members of the embodiment are connected. It is an explanation and an insight into the concept and operation of the machine so that an individual in the arts can easily build it whichever way he/she sees fit. FIGS. 1I to 1U are drawings of how components of the first embodiment 101 of the concept connect. First, an insulating structure 2 is fitted into chamber A of the chassis 1 as we see in FIG. 1I. Next, rods 15 of equal dimensions are inserted through the slats 9-11 as can be seen in FIG. 1J (note that ample space is left for chamber and washers 5). Before continuing, I would like to point out the idea of the gating mechanism as depicted in FIGS. 1K and 1L. It is obvious that the pulleys 17 are attached concentric to the rods as shown, so that rotational motion of the pulley 17 will induce a balanced rotational motion on the rods 15 hence the slats 9-11. The pulley 17 between the bearing 6, in the inner face of chamber A, and the primary gear 8 is called the primary pulley. The belt 14 is used to transfer the rotational motion from the primary pulley to the other pulleys of the system. The primary pulley rotates with the primary gear 8, which is attached to the same rod 15, when the primary gear is rotated by the geared motor 7. See FIGS. 1DA and 1DB for more insight to the design. Now back to previous thought train, with the bearings 6 inserted in the 9 holes of the chassis 1 of the embodiment; the rods 15 are passed through the holes in the chassis 1. This is shown in FIGS. 1M and 1N. Next the primary gear 8, pulleys 17 and belt 14 are inserted into the rod as seen in FIG. 1W; whereby, the primary gear 8 is placed concentric the left most rod 15a right next to chamber B. Note that in FIG. 1W, the right face chassis 1 has been invisible so that we can view the inside of chamber A. The belt links the primary pulley 17a, the middle pulley 17b and the rightmost pulley 17c. Next the washers 5 are inserted between the capped end of the rod 15 and the chassis 1 of the machine as shown in FIG. 1O. With the gear on the motor 7 flush with the primary gear 8 on the rod (See FIGS. 1X and 1P), the geared motor 7 is fitted into chamber B of the chassis. Afterwards, the processing/electrical module is connected to the geared motor 7 and fitted to the inner wall of chamber B (See FIG. 1Q, fitted with adhesive, screws, bolts and nuts, etc). Next the wireless module 3 and energy harvester module 13 (which also includes the energy source in this embodiment) are then connected to the processing module 4. See FIG. 1QA and FIG. 1QB. (The processing module 4 in this embodiment also includes the circuitry for supplying the motor with electrical energy). The wireless module 3 is fitted in the inner wall of chamber B, while the energy harvester 13 is fitted beneath chamber B for greater access to free energy (See FIG. 1QB). Note the rectangular hole in the upper wall of chamber B allows the wireless module 3 to communicate with other devices effectively (FIG. 1R). Finally, the vent lid 16 is fitted onto the chassis 1 of the machine as seen in FIG. 1Z. FIG. 1Z also shows the final build of the machine from different angles.

The insulating structure 2 in chamber A serves to insulate the chamber from extreme temperatures, which could affect the functionality of components such as the processing unit module 4 and the wireless module 3 in chamber B. The rods 15 serve as spines of the slats and the center of mass of the rod-slat combinations are located along the rods 15. There are bearings 6 between the rods 15 and the chassis 1 in order to reduce friction between the two. The washers 5 between the chassis and the capped ends of the rods are also (present) to reduce wear and vibration. The geared motor 7 rotates the slats shut and open, by rotating the primary gear 8 which transfers the motion to the pulley 17 through the rod 15; as a result cause the other pulleys 17 in the belt/pulley system to rotate; the other rods 15 and attached slats 9-11 rotates as well. The processing module 4, which could be a microcontroller or a digital signal processor mounted on the PCB, is used to activate and deactivate the geared motor 7. This depends on its interpretation of the signals it receives from the sensors or other adaptive vents or master processing unit. Basically, this processing module 4 houses the intelligence of the machine that controls aspects of the machine. It could be programmed to learn and adapt to user behavior as it collects more information about the insulative capacity of the individual rooms in a building. The wireless module 3 in chamber B serves as a means of communication between other relevant processing units and the adaptive flow machine's processing unit; in other words, it helps other devices communicate with the processing module 4. The sensors read the various parameters of the environment, parameters such as the temperature, air quality, humidity, etc. The energy harvester 13 fitted beneath chamber B recharges the energy source as it depletes; this makes the machine more autonomous. For a fully functional embodiment that can perform most efficiently, this first embodiment 101 must be coupled with accessory B 202 (see below section titled “Description of Drawing—Accessory B”). This embodiment 101 is fitted at the end of ductwork branch 503 while accessory B 202 is fitted within the ductwork branch 503 (see FIG. X6).

Note that the following description of the intelligent controller is for first embodiment—Accessory B coupled device. An intelligent controller 4, which could include a microcontroller or a digital signal processor, provides a means of controlling actuators, communications and motor dynamo in an intelligent fashion to satisfy the user. It 4 is an amalgamation of several electrical subsystems each serving a particular aspect of the adaptive flow device; all electrical subsystems printed on a circuit board or made into an integrated electronic chip (see FIG. X2). Typically, a microcontroller is utilized as the processing unit of the intelligent controller as opposed to a digital signal processor. The louver control 36 subsystem is electrically connected to the geared motor 7 that operates the gating mechanism and also connected to a power bus 42. It also makes a third connection is made to the microcontroller as a way for control and feedback. As a result, the geared motor 7 is supplied with needed energy through the power bus 42, and controlled intelligently by the microcontroller 41; so basically, one function of the airflow control subsystem is to control the flow of electrical energy to the geared motor 7 that actuates the slats 9-11. A power storage 46 is connected to the power bus 42, it 46 could be a rechargeable battery or a capacitor or supercapacitor. A communications driver 35 serves as a link between the communications device 34, the microcontroller 41, and the power bus 42. It manages the data sent to or received by communications device 34. Its connection to the power bus 42 is a path of supplying the communications aspect of the intelligent control 4 with needed energy. The communications device 34 and driver 35 combination is a means by which the microcontroller 41 communicates with other processing units and sensors. The motor dynamo 31 is electrically connected to a motor dynamo bus 40 which is connected to a power manager 38 that is connected to the power bus 42. The power bus 42 serves as an energy pathway which connects to the power storage/source 46. The motor dynamo bus 40 provides a means for other subsystems within the intelligent controller 4 to transfer energy to and from the motor dynamo 40. The power manager 38 serves as the regulator between the motor dynamo bus 40 and the power bus 42. It is connected to and controlled by the microcontroller 41. The analog to digital converter 39 acts as an interpreter between: the internal sensor(s) 43 44 and microcontroller 41, power manager 38 and microcontroller 41, power bus 42 and microcontroller 41, and motor dynamo 31 and microcontroller 41; for current parameters in ductwork, control, charge level information, and flow indicator respectively. Note that some of these subsystems might not need an A/D converter e.g a digital temperature sensor can communicate directly with the microcontroller 41. There is also an atomizer control subsystem 45 that links the atomizer 28 to the microcontroller 41 and atomizer 28 to the power bus 42. The subsystem acts as a means of controlling the flow of electrical energy to the atomizer 28. The atomizer 28 can still perform its duty regardless of the state of the environmental control unit controller and the environmental control unit. And finally, there is an energy harvesting circuit/control subsystem 48 that is connected to microcontroller 41, energy harvesting module 13, and the power bus 42; it controls in flow of energy from the energy harvesting module 13 to the power bus 42.

### DESCRIPTION OF DRAWING—SECOND EMBODIMENT

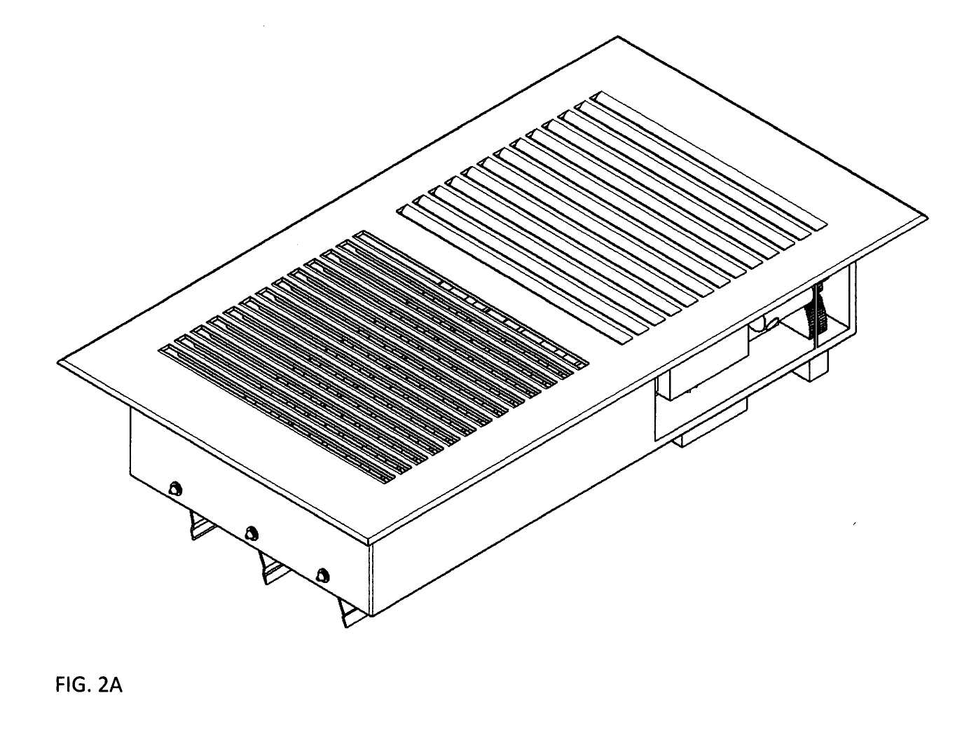

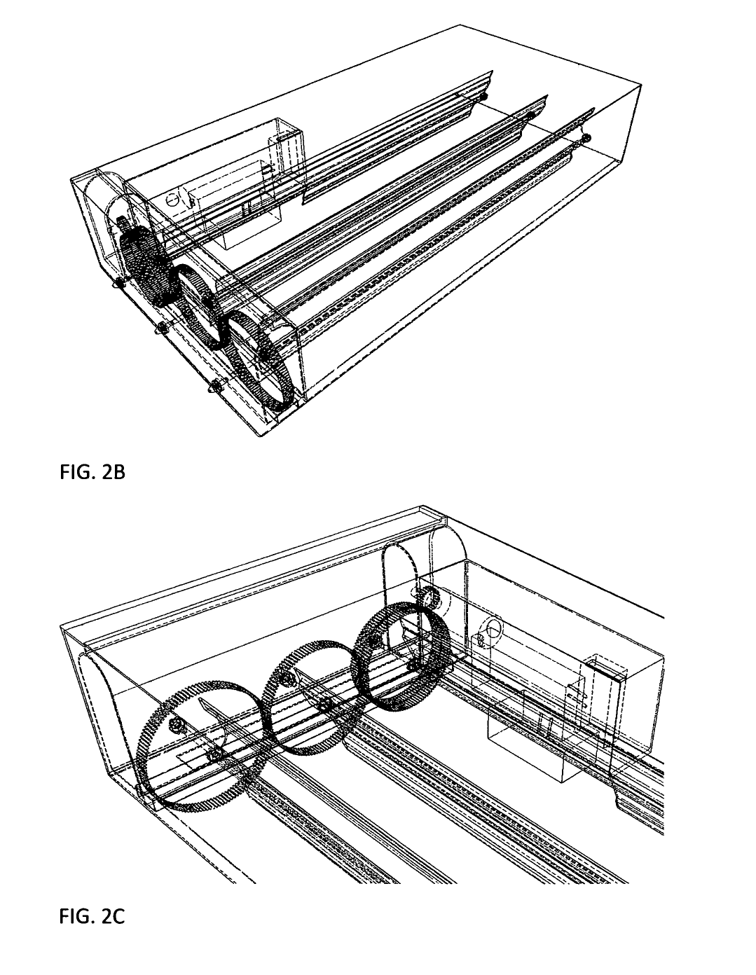

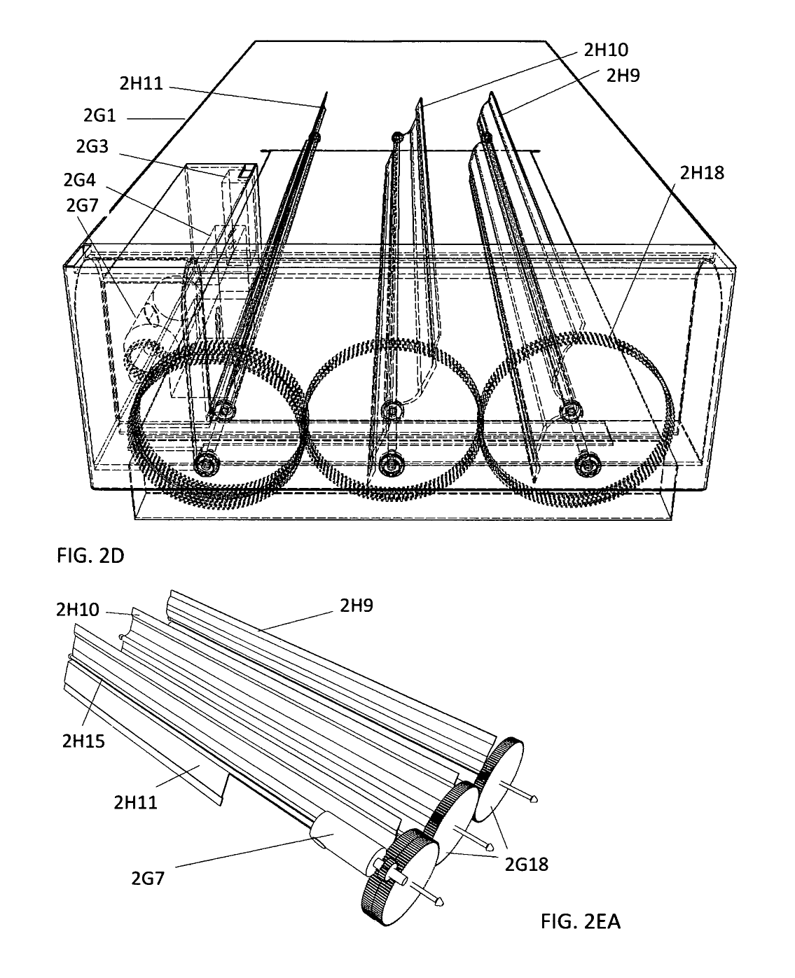

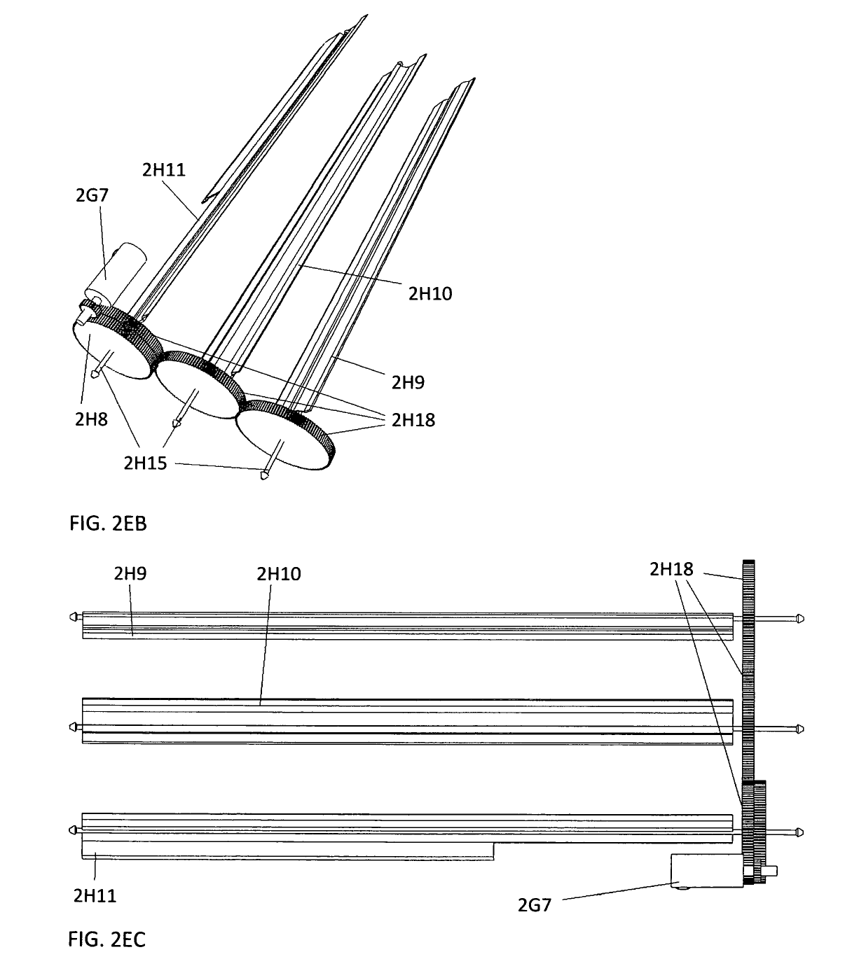

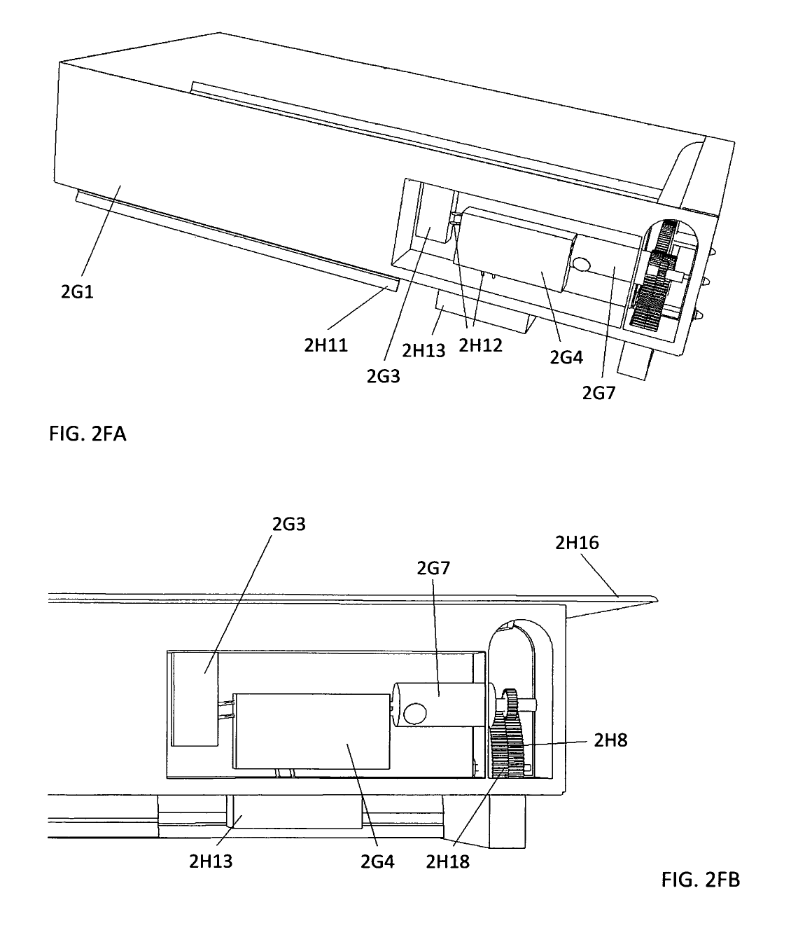

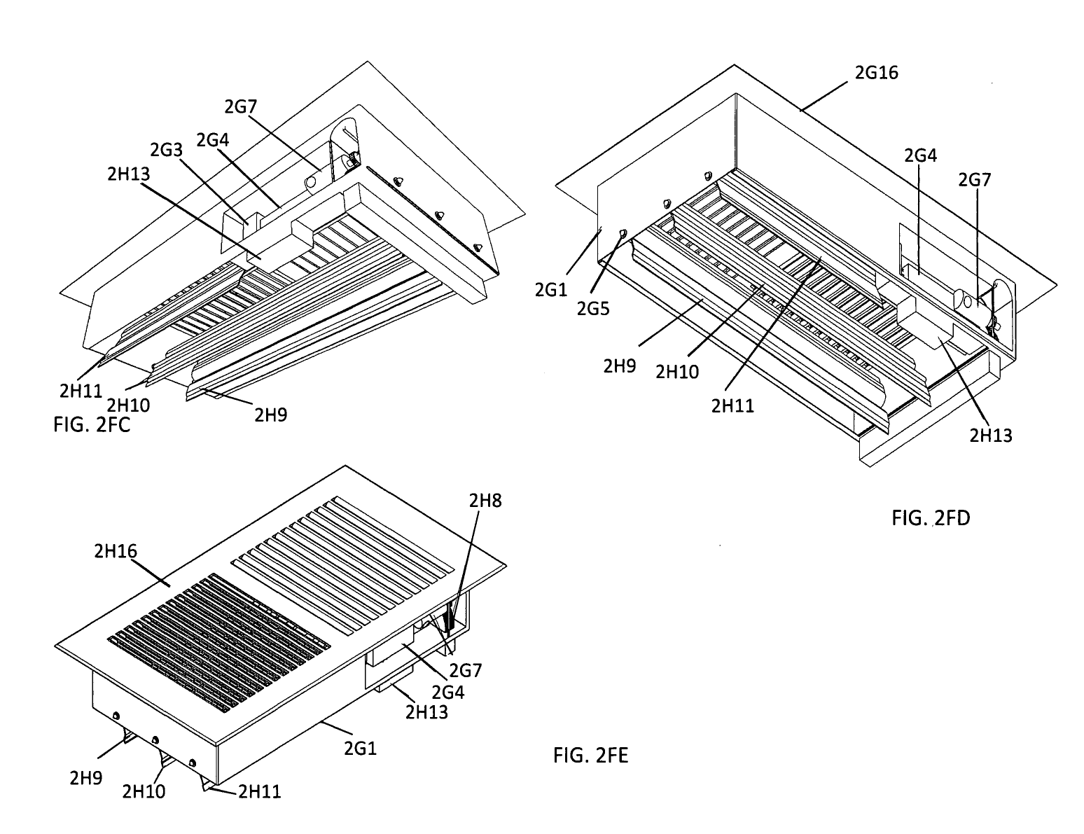

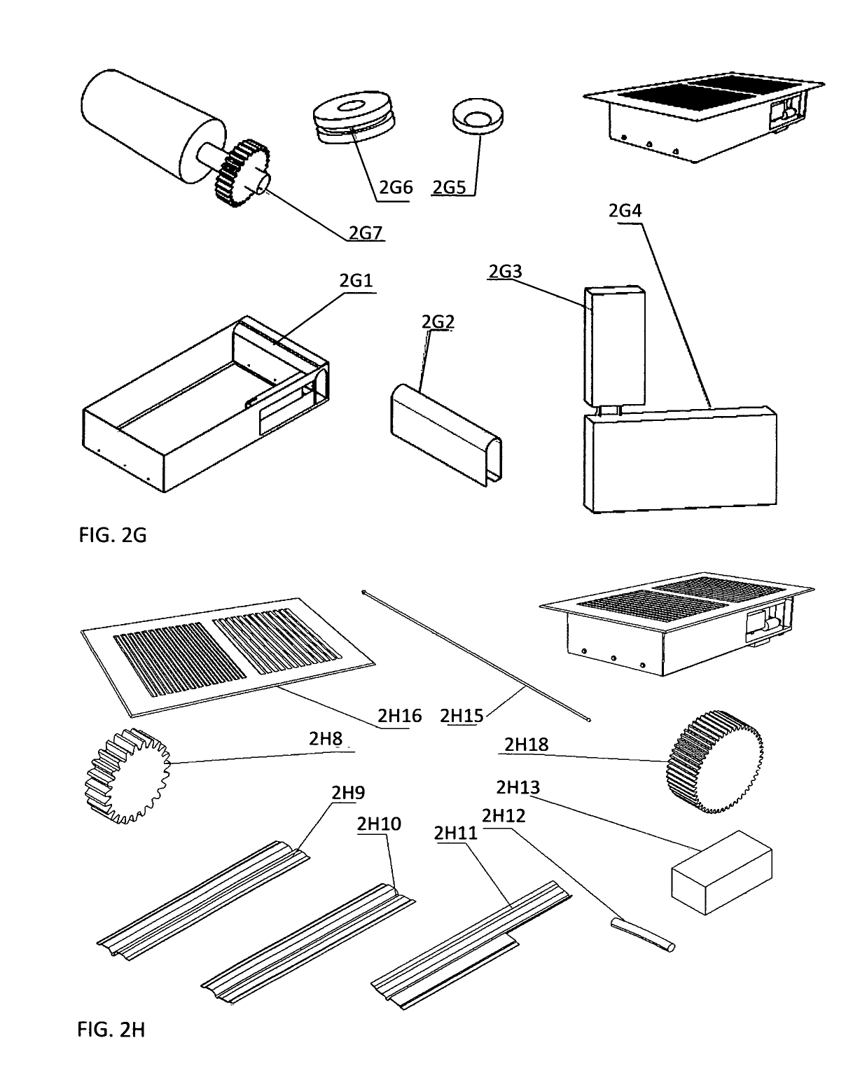

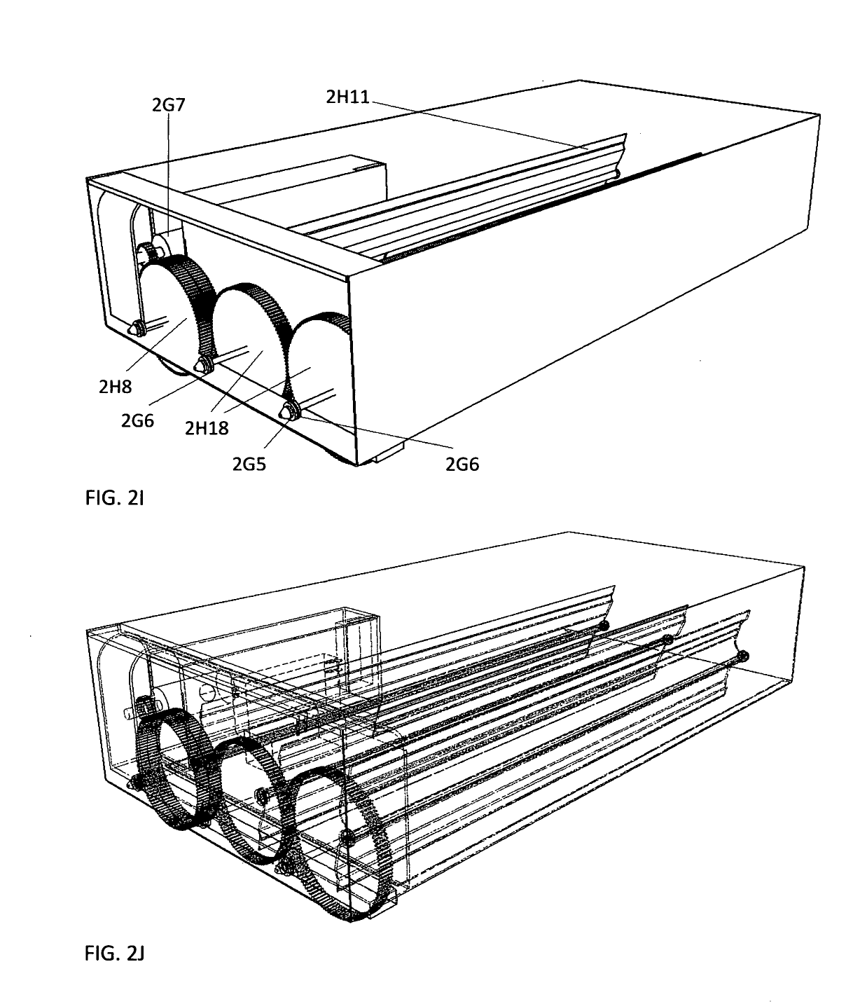

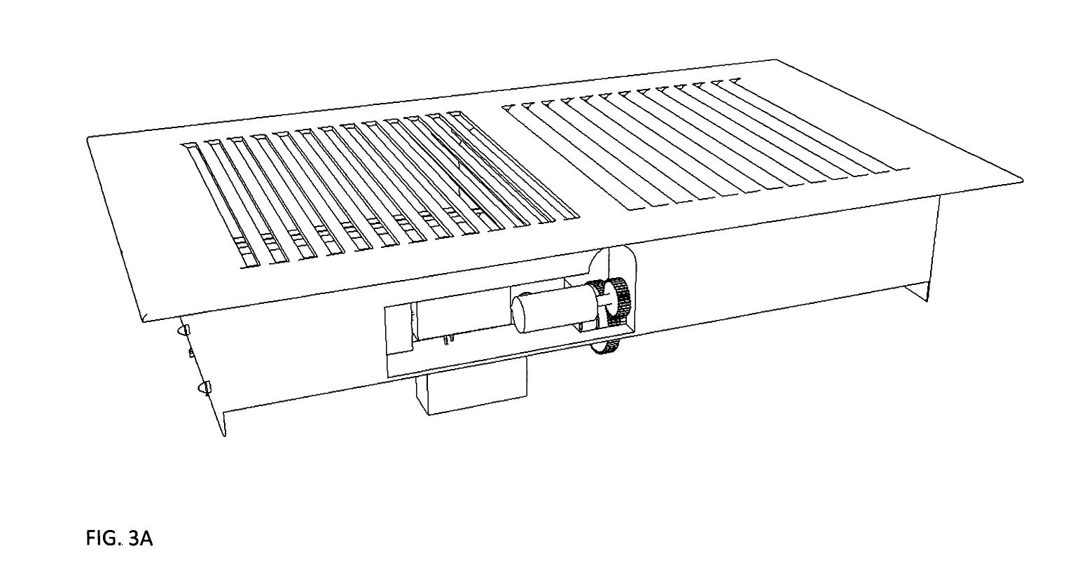

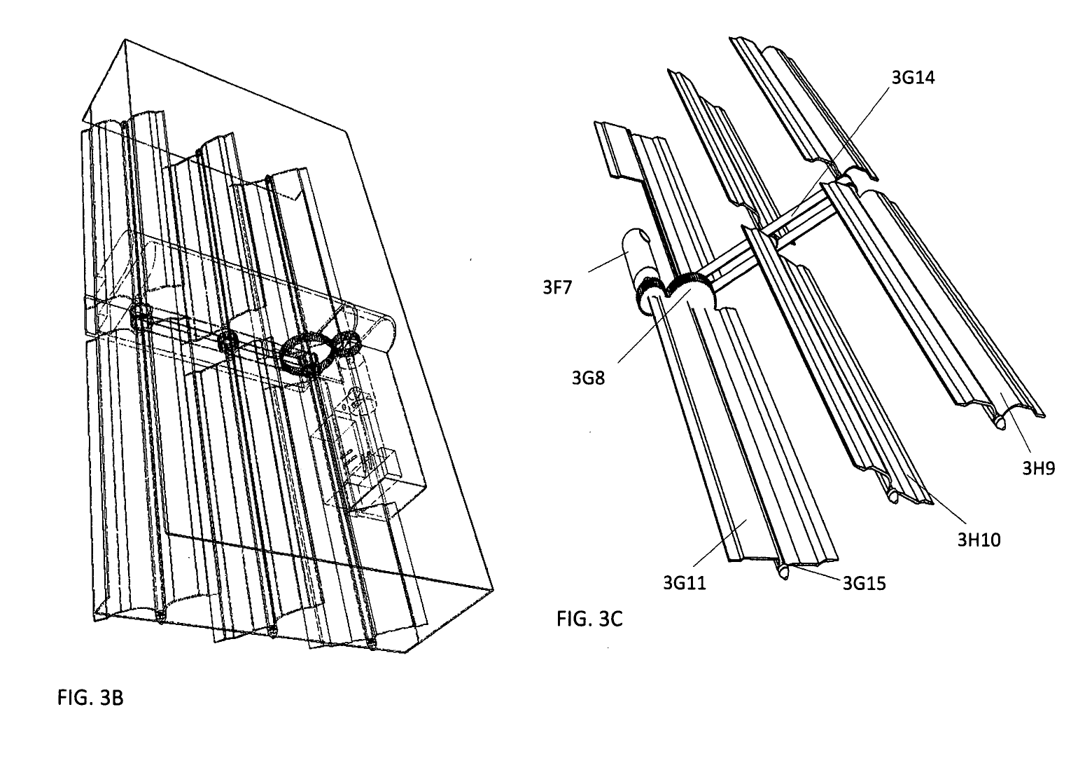

The final build of the second embodiment 102 is shown in FIG. 2A. From quick inspection, it can be seen that the second embodiment 102 has a lot of similarities with the first embodiment 101. The main difference between this embodiment 102 and the first one 101 is the gating mechanism. The chassis 1 and arrangement of some of the members, such as: wireless module 3, energy harvester 13, processing module 4, bearings 6, washers 5, and vent grill 16, are the same in these embodiments (101 and 102). As can be seen, the chassis 1 of the second embodiment, which is essentially of copy of the first, can be divided into two sections: the flow area and the chamber that is further divided into chamber A and chamber B. The wireless module 3, energy harvester 13, processing module 4, and part of the geared motor 7, reside in chamber B. The bearings 6 are also fitted into the 9 holes in the lower part of the chassis 1. The washers 5 are placed between the capped ends of the rods 15 and chassis 1, and the vent grills 16 caps the chassis of the machine. Basically almost all of the components in FIGS. 1F and 1G are used in the creation of the second embodiment 102; these exclude the pulleys 17 and belt 14 and include 3 gears 18 of suitable sizes. See FIGS. 2G and 2H for the components needed for the second embodiment 102.

FIGS. 2B, 2C, 2D and 2J are hidden lines drawings of the second embodiment 102, and they show how various members are arranged and connected. It is clear that the second embodiment 102 uses medium sized gears 18 to transfer kinetic rotational energy from the primary gear 8 to the rods 15 rather than the pulley and belt system employed in the first embodiment 101. I speculate that this new transfer mechanism is more durable than that of the first embodiment 101. The connections of the second embodiment 102 are pretty much the same as that of the first except for the pulleys 17 and belt 14; gears 18 are used instead. FIGS. 2EA-2EC are supplements to help understand the construct's inner workings (Note that in this picture, the chassis of the embodiment as well as some other members are made invisible). The teeth of the primary gear 8 are locked in place with the teeth of the geared motor 7, and the primary gear 8 is attached firmly to the primary rod 15a. The gear 18 behind the primary gear 8, on the primary rod 15a, is called the secondary gear. This secondary gear 18a serves to transfer motion from the primary rod 15a to the middle gear 18b. The middle gear 18b which is attached firmly to the middle rod 15b then rotates middle rod 15b and transfers motion to the third gear 18c; likewise, the third gear 18c rotates the third rod 15c.

As mentioned earlier, the connections between components of the second embodiment 102 is pretty much the same as the first embodiment 101. Keep in mind that the following description of the embodiment is not a recipe or manual of how to manufacture or build the machine; it is only a means of explaining how all the members of the embodiment are connected. So basically it is an explanation and an insight into the concept and operation of the machine so that an individual in the arts can easily build it as he/she sees fit. An insulating structure 2 is first fitted into chamber A of the chassis 1 as we see in FIG. 1I (I use this first embodiment drawing because the action described is same for this embodiment). Then rods 15 of equal dimensions are fitted on the slats 9-11 as can be seen in FIG. 1J (note that ample space is left for the chamber and washers 5). With bearings fitted into the 9 holes of the chassis 1 of the embodiment; the rods are then inserted in the holes and into the chassis 1. This is shown in FIGS. 1M and 1N. Next, the primary gear 8 as well as the other gears 18; all of suitable sizes are inserted into the rods 15. They are placed concentric to the rods 15 as seen in FIG. 2I; the primary gear 8 is inserted to the left most rod 15a right next to chamber B (Note that in FIG. 2I, the right face of the chassis 1 has been made invisible so that we can view the inside of chamber A). Afterwards the washers 5 are inserted between the capped end of the rods 15 and chassis 1 of the machine as shown in FIG. 1O. The geared motor is then fitted into chamber B of the chassis 1, with the gear on the motor 7 flush with the primary gear 8 of the rod 15a. Afterwards, the processing module 4 is connected to the geared motor 7 and fitted to the inner wall of chamber B (See FIG. 2FA). Following this, the wireless module 3 and energy harvester module 13 (which also includes the energy source in this embodiment) are then connected to the processing module 4 (See FIG. 2FA and FIG. 2FB. The processing module 4 in this embodiment 102 also includes the circuitry for supplying the motor with electrical energy). The wireless module 3 is fitted in the inner wall of chamber B, while the energy harvester 13 is fitted beneath chamber B for greater access to free energy (See FIGS. 2FC and 2FD). Note there is rectangular hole in the upper wall of chamber B which allows the wireless module 3 to communicate with other devices effectively (FIGS. 2D and 2I). Finally, the vent grill 16 is fitted onto the chassis 1 of the machine as can be seen in FIGS. 2FB-2FE.

The insulating structure 2 in chamber A serves to insulate the chamber from extreme temperatures, which could affect the functionality of the components such as the processing unit module 4 and the wireless module 3 in chamber B. The rods 15 serve as spines of the slats 9-11 and the center of mass of the rod-slat combination is located along the rods 15. There are bearings 6 between the rods 15 and the chassis 1 in order to reduce friction between the two. Also the washers 5 between the chassis 1 and the capped ends of the rods 15 serve to reduce wear and vibration. The geared motor 7 serves to rotate the slats 9-11 shut and open, by rotating the primary gear which transfers the motion to the secondary gear through the rod 15, which in turn induces rotational motion in other gears 18 in the system; thereby, causing the other rods 15 and attached slats 9-11 to rotate (Note that the secondary gear is not necessary as the primary gear can be made to transfer the motion to the middle gear directly; though this idea is not adopted in this embodiment). The processing module 4 is used to control different operations of the machine. Basically, this processing module 4 houses the intelligence of the machine that regulates airflow into a particular room. It could be program to learn and adapt user behavior as it collects more information about the insulative capacity of the individual rooms in a building. The wireless module 3 in chamber B serves as a means of communication between other devices and the adaptive flow machine's processing unit in the processing module 4; it helps the sensor communicate various parameters of the environment such as temperature, air quality, humidity, etc to the processing unit of the adaptive flow device. The energy harvester 13 fitted beneath chamber B recharges the energy source as it depletes, this makes the machine more autonomous. For a fully functional embodiment that can perform most efficiently, the second embodiment 102 must be coupled with accessory B 202 (see below section titled “Description of Drawing—Accessory B”). This embodiment 102 is fitted at the end of ductwork branch 503 while accessory B 202 is fitted within the ductwork branch 503 (see FIG. X6).

The intelligent controller of this embodiment is basically the same as that of the first embodiment (see first embodiment section's last paragraph).

### DESCRIPTION OF DRAWINGS—THIRD EMBODIMENT

The final build of a third embodiment 103 is shown in FIG. 3A. The chassis 1 of the third embodiment 103 is quite similar to the other two in the sense that it can be divided into two areas namely: the airflow area and the chamber which is further divided into chamber A and chamber B; however, the main difference in the chassis 1 is the positions of the chambers. The chambers are not located at the right section of the frontal face instead they are located about midway of the length of the frontal face.

FIG. 3B is a drawing of the final build of the third embodiment 103 (excluding the vent grill for clarity) with hidden perspective lines revealed. It gives an overall idea of how the components of this embodiment fit together to create the machine as seen in FIG. 3A. At this point, it is necessary to expound on the drawing of FIG. 3C which gives more insight to the inner workings of the machine (the chassis and some other components are hidden for clarity). It is apparent that this gating mechanism type is fundamentally the same as that of the first embodiment 101, in that it is a means that employs the rods 15, pulleys 17 and belt 14 to transfer kinetic rotational energy from a geared motor 7 to the slats 9-11, the only difference here is the geometry of the device. As mentioned earlier, the pulley and belt system are located in the middle of the rod 15 approximately. The geared motor transfers kinetic rotational energy to the primary rod 15a through the primary gear 8, and thus leads to the concurrent rotation of the primary pulley 17a through the rod. Simultaneously, the rotation motion of the pulley 17a induces rotation of the belt 14, and as a result rotation of other pulleys 17b and 17c that are attached to the other rods 15b and 15c. The slats 9-11 rotate along with the rods 15.

The components that are needed to build the third construction are the same as that of the first embodiment 101, with 3 additional bearings 6, which now make 12 holes (See FIGS. 1F and 1G). See FIGS. 3F and 3G for components needed for the third embodiment 103. Keep in mind that the shapes of the slats 9-11 are modified to fit this new embodiment (See FIG. 3E). Note that in FIG. 3E, the primary slat 11 is incised to make space for chamber B.

As mentioned earlier, the assembly of the components of the third embodiment 103 is almost the same as the first embodiment 101. Keep in mind that the following description of the embodiment is not a recipe or manual of how to manufacture or build the machine; it is only a means of explaining how the members of the embodiment are connected. It is an explanation and insight into the concept of the machine so that an individual in the arts can easily build it, as he/she sees fit. First, an insulating structure 2 is fitted into chamber A, which is now located at the middle of the chassis 1, as we see in FIG. 1I (I use this first embodiment drawing because the action described is same for this embodiment). Next, rods 15 of equal dimensions are fitted on the slats 9-11 as is done in FIG. 1J (note that ample space is left for washers). With bearings 6 inserted in the 12 holes of the chassis 1 of the embodiment; the rods 15 are then inserted in the holes of chassis 1. This is shown in FIGS. 1M and 1N. Next the primary gear 8, pulleys 17 and belt 14 are inserted into the rods as seen in FIG. 1W; whereby, the primary gear 8 is inserted into the leftmost rod 15a next to chamber B. The primary pulley 17a is located between bearing 6 in the chassis 1 and the primary gear 8. The belt 14 is also used to link the primary 17a, middle 17b and the rightmost pulleys 17c. Next the 6 washers 5 are inserted between the capped end of the rod 15 and chassis 1 of the machine as shown in FIG. 1O. The geared motor 7 is then fitted into chamber B, of the chassis 1, with the gear on the motor 7 flush with the primary gear 8 of the rod 15. Afterwards, the processing module 4 is connected to the geared motor 7 and fitted into the inner wall of chamber B (See FIG. 3DA). Then the wireless 3 and energy harvester modules 13 (which also include the energy source for this embodiment) are then connected to the processing module 4 (See FIG. 3DA and FIG. 3DB. The processing module 4 in this embodiment 103 also includes the circuitry for supplying the motor with electrical energy). The wireless module 3 is fitted in the inner wall of chamber B, while the energy harvester module 13 is fitted beneath chamber B for greater access to free energy (See FIGS. 3DB and 3DC). Note there is rectangular hole in the upper wall of chamber B that allows the wireless module 3 to communicate with other devices effectively (FIG. 3DD). Finally, the vent grill 16 is fitted onto the chassis 1 of the machine as can be seen in FIG. 3A.

The insulating structure 2 in chamber A serves to insulate the chamber from extreme temperatures, which could affect the functionality of the components such as the processing module 4 and the wireless module 3 in chamber B. The rods 15 serve as spines of the slats 9-11 and the center of mass of the rod-slat combination is located along the rods 15. The bearings 6 are located between the rods 15 and the chassis 1 in order to reduce friction between the two. The washers 5 between the chassis and the capped ends of the rods also reduce wear and vibrations. The geared motor 7 functions to rotate the slats 9-11 shut and open, by rotating the primary gear 8 which transfers the motion to the pulley 17a through the rod 15a, which in turn causes the other pulleys 17b,17c in the pulley/belt system to rotate; thereby, causing the other rods 15a,15b and attached slats 10,11 to rotate The processing module 4 is used to control different operations of the machine, sometimes based on the information it receives from other processing units and sensors (machine's processing unit could be a microcontroller that is mounted on the PCB). Basically, this processing module 4 houses the intelligence of the machine that regulates airflow into a particular room or area. The wireless module 3 in chamber B serves as a means of communication between other processing units and the machine's processing unit; it also communicates various parameters of the environment such as temperature, air quality, humidity, etc, from sensors to the machine's processing module. The energy harvester 13 fitted beneath chamber B recharges the energy source as it depletes; this makes the machine more autonomous. For a fully functional embodiment that can perform most efficiently, this third embodiment 103 must be coupled with accessory B 202 (see below section titled “Description of Drawing—Accessory B”). This embodiment 103 is fitted at the end of ductwork branch 503 while accessory B 202 is fitted within the ductwork branch 503 (see FIG. X6).

The intelligent controller of this embodiment is basically the same as that of the first embodiment (see first embodiment section's last paragraph).

### DESCRIPTION OF DRAWING—FOURTH EMBODIMENT

The final build of a fourth embodiment 104 is shown in FIG. 4A. It bares several similarities in form to the first and second embodiment 101, 102. One obvious similarity is the location of the chambers to the chassis 1; however, when the hidden lines are revealed, as in FIG. 4B, some key differences surface. It becomes apparent that neither the pulleys, belt, nor gears (excluding the primary gear of course) are used in the gating mechanism. The gating mechanism that is used in this embodiment is shown in FIG. 4D (chassis and some other member made invisible in this depiction). Note that a motor is housed in a small chassis 22 as opposed to the motors in the other embodiments. This motor's house will be referred to as the engine house from now on. The engine house is composed of a motor 31, a cylindrical knob/fastener 20, a circular plate 23 with hole in it, short flat rod 21 and a chassis 22. FIG. 4C shows how the components are assembled to form the engine house. Taking a look at FIG. 4D again, we see that the rotation of the motor causes a partial linear motion of the long flat rod 26, which pulls and pushes the top of the thin lever 25. This kind of action on the lever 25 causes torque on the lever 25 and as a result causes the lower portion of the lever 25 to move in the same direction (clockwise or anticlockwise). The motion of the lower portion of the lever 25 moves the lower flat rod 24 in a particular direction since they are attached to each other (to the left if rotation of lever is clockwise, and the right if rotation is anticlockwise). The motion of the lower flat rod 24 causes the attached slats 10, 11 to rotate. Another noticeable difference, in this embodiment there are only two slats and their forms differ from each other, and also from slats of other embodiments. One of the slats in this embodiment is longer than the other. The end sides of the slats flanged and curved to make them suitable for this gating mechanism rather than the flat shape adopted by the slats in other embodiments. Note that no rods are needed for this embodiment. The chassis 1 of this embodiment is also quite similar to that of the first and second embodiments 101,102 but there are little differences: less number of holes, the location of holes on the chassis 1, chamber B cover greater area, and gaps in the inner face of chamber A to accommodate the fastener 19 that connects the lower portion of the slat to the lower flat rod 24 (See FIG. 4E and FIG. 4H).

The assembly of the components of the fourth embodiment 104 is reasonably different from the other embodiments. Keep in mind that the following description of the embodiment is not a recipe or manual of how to manufacture or build the machine; it is only a means of explaining how all the members of the embodiment are connected. It is an explanation and insight into the concept and operation of the machine, so that an individual in the arts can easily build it as he/she sees fit. The engine house is attached firmly to the chassis 1 with glue, screw, bolt and nut or other adhesives. In the preceding step, the processing module 4 is connected to the motor in the engine house and fitted to the inner wall of the chamber B (See FIG. 4J). The wireless module 3 and energy harvester module 13 (which also includes the power source in this embodiment) are then connected to the processing module. See FIG. 4J and FIG. 4K. The wireless module 3 is fitted into the inner wall of chamber B, while the energy harvester 13 is fitted beneath chamber B for greater access to free energy (See FIGS. 4J and 4K). Note there is rectangular hole in the upper wall of chamber B that allows the wireless module 3 to communicate with other devices effectively (FIGS. 4H and 4BC). The vent grill 16 is fitted onto the chassis 1 of the machine as can be seen in the final build. Then the slats 10,11 are attached to the chassis 1 with the fastener 19 (4 fasteners) as shown in FIGS. 4IA and 4H; they should be attached firmly but loose enough for free rotation of the slat. Next the lever is fastened to the chassis through the middle hole as seen in FIG. 4IB. Then lower flat rod 24 is fastened through the lower hole of the lever to the lever 25, and then fastened to the slats 10,11 (3 fasteners. See FIG. 4IC). The upper end of the lever is bolted through the hole with fastener 19 to the long flat rod 26, which is then attached to the motor's fastener 20 (See FIG. 4ID and FIG. 4D). Finally the atomizer and the fragrance container is affixed to the chassis (See FIG. 4M)

The geared motor 7 serves to rotate the slats shut and open, by pulling and pushing on the lever 25 which transfers the motion to the slat through the lower flat rod 24. The processing module 4, which could include a microcontroller, controls different operations of the machine; sometimes based on its interpretation and analysis of information it receives from other devices and sensors. Basically, this processing module 4 houses the intelligence of the machine that regulates airflow into a particular room or area. The wireless module 3 in chamber B serves as a means of communication between other processing units and the adaptive flow machine's processing unit. It also communicates various parameters of the environment such as temperature, air quality, humidity, etc, from sensors to the machine's processing module. The energy harvester 13 fitted beneath chamber B recharges the energy source as it depletes making it a more autonomous machine. The energy harvester 13 could be a rotating structure and a motor dynamo that can harvest the mechanical energy of the moving air, transform it to electrical energy, which can be stored. It could also be a device that transforms thermal energy or energy in vibrations to electrical energy.

For a fully functional embodiment that can perform most efficiently, this first embodiment must be coupled with accessory A 201 (see below section titled “Description of Drawing—Accessory A”). This embodiment 104 is fitted at the end of ductwork branch 503 while accessory A 201 is fitted within the ductwork branch 503 (see FIG. X6).

The intelligent controller of this embodiment is basically the same as that of the first embodiment (see first embodiment section's last paragraph).

### DESCRIPTION OF DRAWING—FIFTH EMBODIMENT

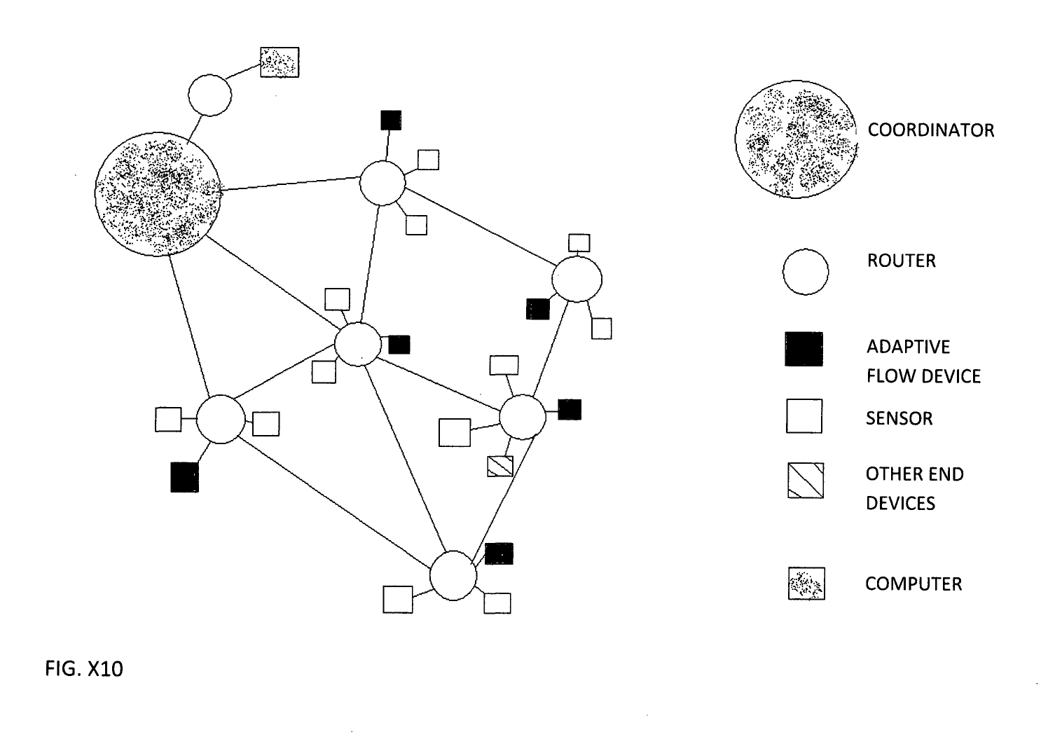

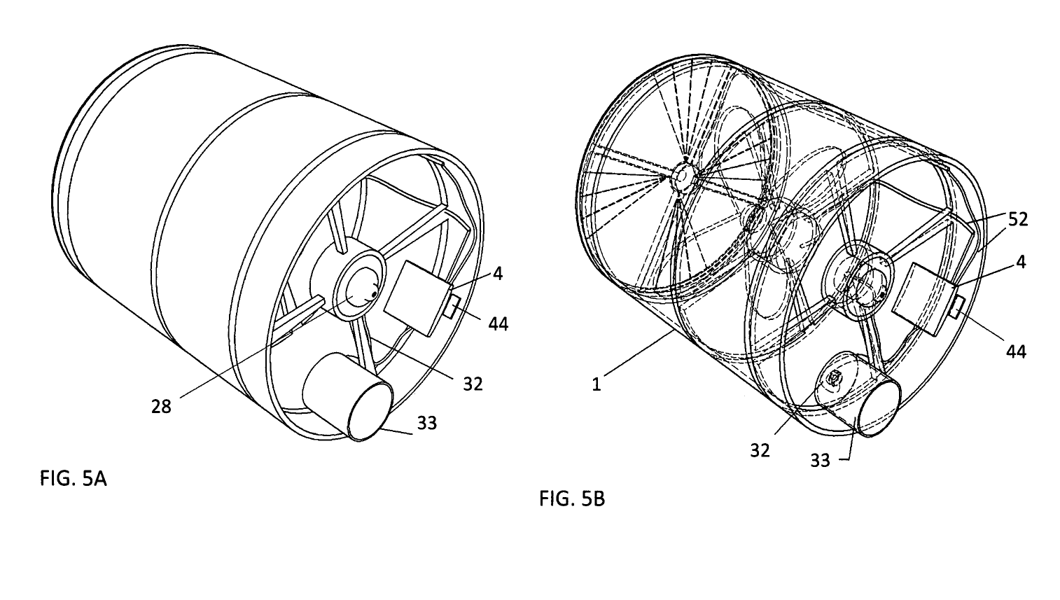

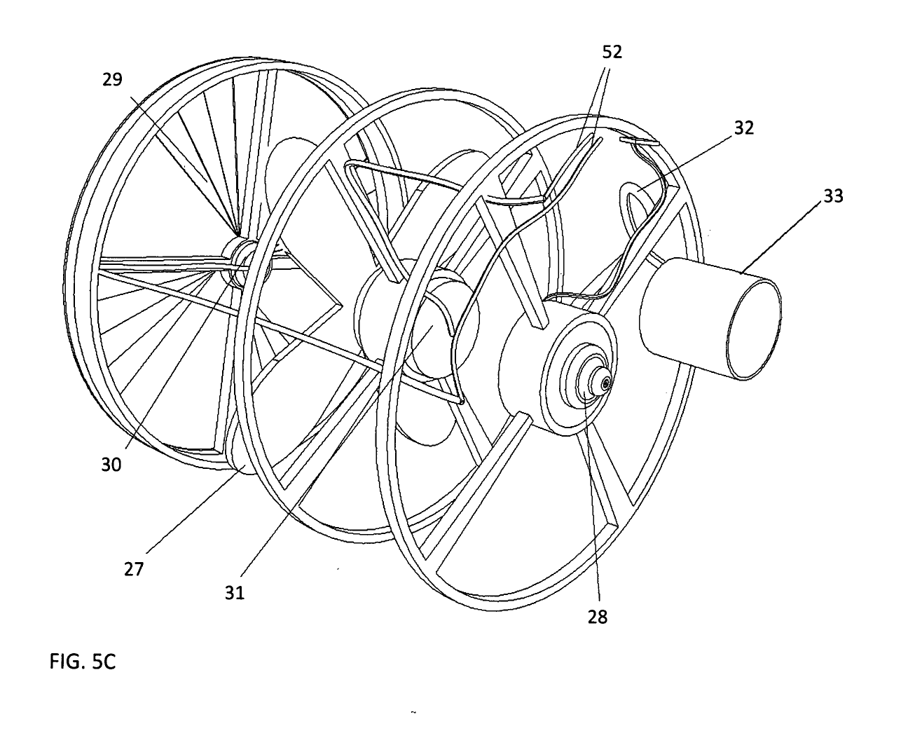

The fifth embodiment 105 is a different approach to the application of the concept. The embodiment can be snugly fitted into ductwork or at the end of a ductwork branch see FIGS. X7 and 5A. The base of the device is a chassis 1 where most of the components are affixed. The chassis could be made of a flexible material, such as a flexible plastic, which would allow easy installation. The device has a fan 27 or propeller that is fixed to a motor dynamo, which could be a brush or brushless motor 31. This combination of fan 27 and motor 31 is a means of generating power, a means of boosting flow and restricting flow. The other section of the embodiment, located upstream the ductwork, involves another means of reducing or blocking airflow into a particular area. It is a combination of a petal value 29 and a stepper motor 30. The stepper motor 30 is used to turn the petal value 29 in varying degrees to accomplish reduction or total blockage of airflow as can be seen in FIG. 5B. The parts in the embodiment 105 that serve to create an aromatic environment are an ultrasonic atomizer 28, tubes 32, and a container 33. The container is filled with natural scented oils or a scented solution of some kind; the tube 32 feeds the liquid to the atomizer 28 that atomizes it and airflow carries the scent molecules into the area. Note that any tube of suitable length and diameter can be used; this allows the adaptive flow device 105 to be placed farther upstream in the ductwork. A communications device 3 is also part of the adaptive flow device 105 and is located further downstream at the end of the ductwork. The adaptive flow device 10X5 also has a sensor(s) 44 attached to its chassis 1 as a means of measuring environment conditions in the ductwork such as pressure, temperature, air pollutants, etc.

An intelligent controller 4, which could include a microcontroller or a digital signal processor, provides a means of controlling actuators, communications, and motor dynamo in an intelligent fashion to satisfy the user (see FIGS. 5B and 5C). It 4 is an amalgamation of several electrical subsystems each serving a particular aspect of the adaptive flow device chip (see FIG. X1); all electrical subsystems printed on a circuit board or made into an integrated electronic. Typically, a microcontroller is utilized as the processing unit of the intelligent controller as opposed to a digital signal processor. The petal value control 36 subsystem is electrically connected to the stepper motor 30 that operates the petal valve 29 and also connected to a power bus 42. It also makes a third connection is made to the microcontroller. As a result, the stepper motor is supplied with needed energy through the power bus, and controlled intelligently by the microcontroller; so basically the airflow control subsystem controls the flow of electrical energy to the stepper motor that actuates the petal valve. A power storage 46 is connected to the power bus 42, it 46 could be a rechargeable battery or a capacitor or a supercapacitor. A communications driver 35 serves as a link between the communications device 34, the microcontroller 41, and the power bus 42. It manages the data sent to or received by communications device 34. Its connection to the power bus 42 is a path of supplying the communications aspect of the intelligent control 4 with needed energy. The communications device 34 and driver 35 combination is a means by which the microcontroller 41 communicates with other processing units. The motor dynamo 31 is electrically connected to a motor dynamo bus 40 which is connected to a power manager 38 that is connected to the power bus 42. The power bus 42 serves as an energy pathway which connects to the power storage 46. The motor dynamo bus 40 provides a means for other subsystems within the intelligent controller 4 to transfer energy to and from the motor dynamo 40. The power manager 38 serves as the regulator between the motor dynamo bus 40 and the power bus 42. It is connected to and controlled by the microcontroller 41. The analog to digital converter 39 acts as an interpreter between: the internal sensor(s) 43 44 and microcontroller 41, power manager 38 and microcontroller 41, power bus 42 and microcontroller 41, and motor dynamo 31 and microcontroller 41; for current parameters in ductwork, control, charge level information, and flow indicator respectively. Note that some of these subsystems might not need an A/D converter e.g a digital temperature sensor can communicate directly with the microcontroller 41. There is also an atomizer control subsystem 45 that links the atomizer 28 to the microcontroller 41 and atomizer 28 to the power bus 42. The subsystem acts as a means of controlling the flow of electrical energy to the atomizer 28. The atomizer 28 can still perform its duty regardless of the state of the environmental control unit controller and the environmental control unit.

### DESCRIPTION OF DRAWING—SIXTH EMBODIMENT

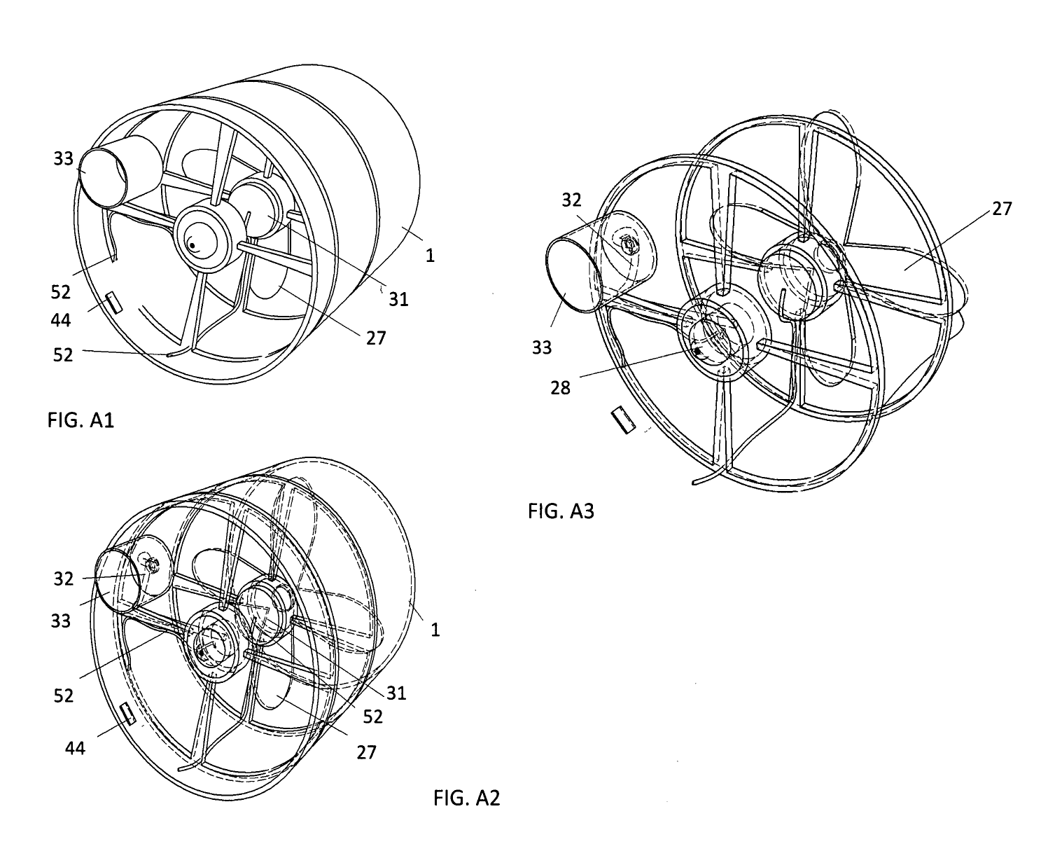

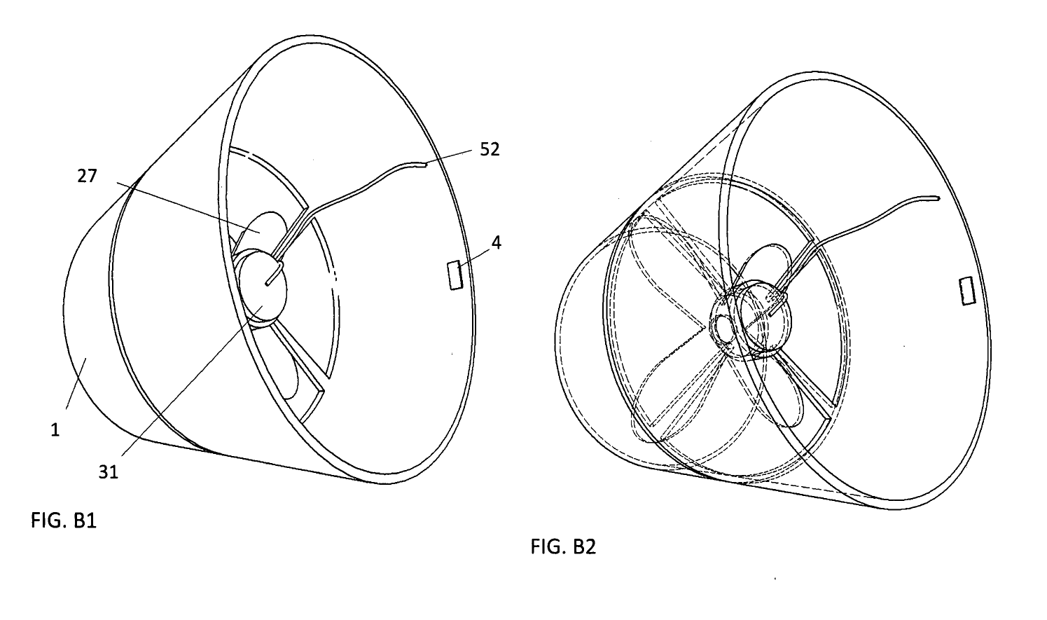

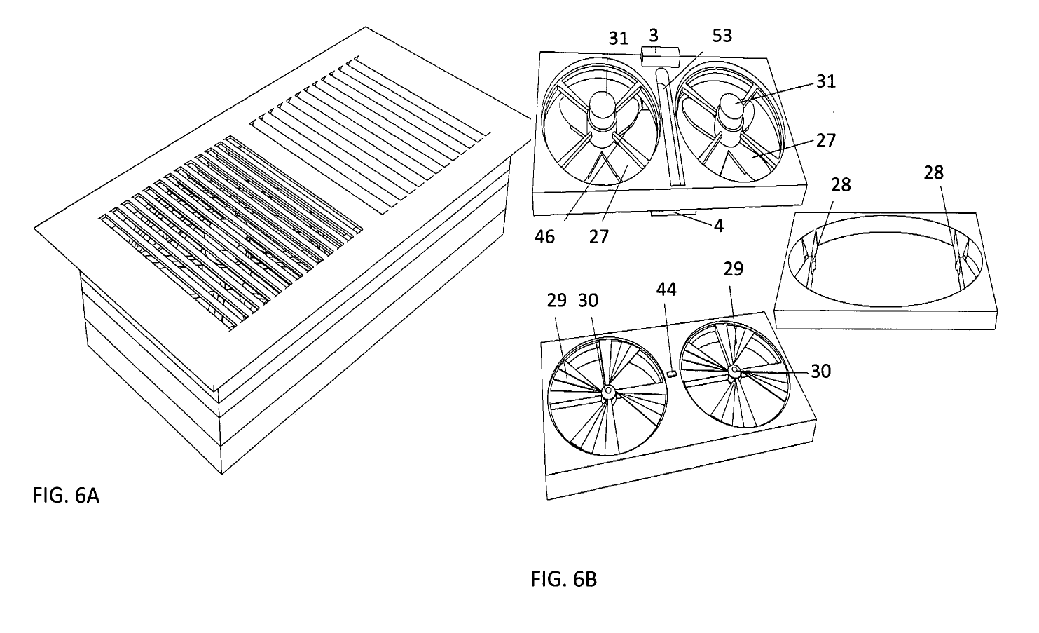

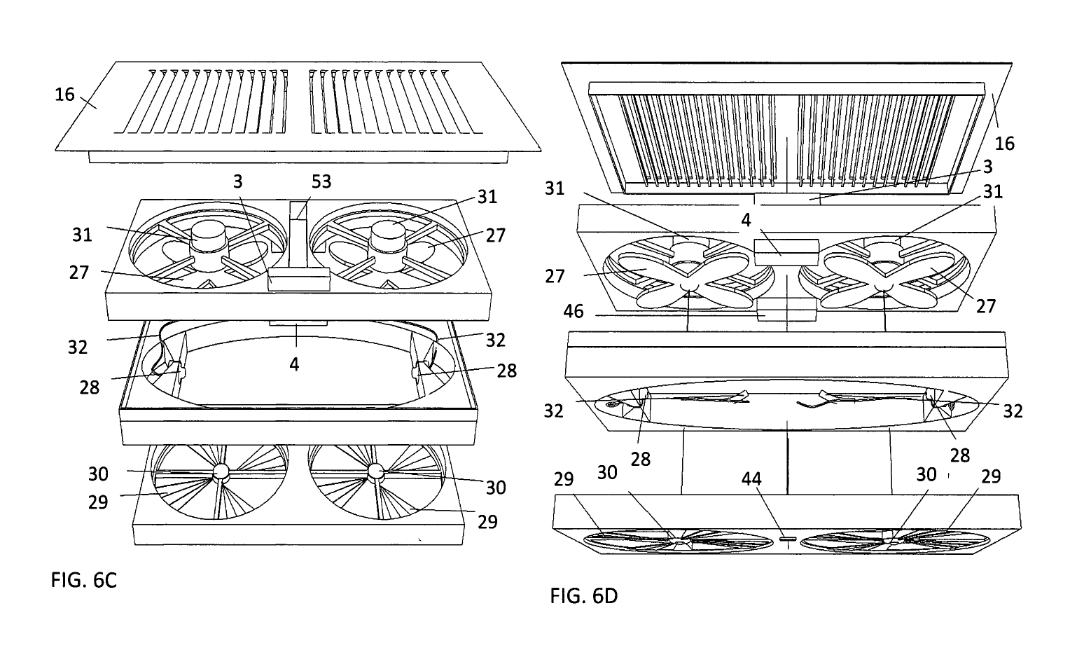

Essentially, this embodiment 106 has the same components as the in-duct type (fifth embodiment 105, see FIG. X8 for illustration of positioning embodiment 106 in ductwork), although some of the components here are double of that used in the fifth embodiment 105. As can be seen in FIGS. 6B-6D, this embodiment can be broken down to 3 layers or brackets. The first layer functionality is the boosting and restricting of airflow, and harvesting kinetic energy of air molecules. The first layer also includes space for the scent container for storing scented oils and other kinds of fragrances. The first layer also serves as a template for an intelligent controller 4 that has similar construction as mention in the fifth embodiment 105; additionally, power source and communications device 3 are affixed to first layer. The second layer houses the atomizers 28 which are fed liquid fragrances from the scent container by tubes 32. The atomizers 28 can only be activated while air flowing downstream, away from the environmental control unit, in the duct.

The third layer has the functionality of reducing and blocking airflow, and sensing the conditions within the duct. This layer carries petal values 29, sensors 43 44, and stepper motors 30. This embodiment is fitted in a register box at the end of a ductwork branch just like you would install a traditional vent.

The intelligent controller 4 of this embodiment is basically the same as that of the fifth embodiment (see FIG. X1).

Note that these layers can be stacked in any order, the one shown here is basically that of a preferred embodiment. Note that this embodiment can be made to also possess reverse flow functionality by utilizing the second propeller-motor combination of this embodiment for reverse flow operation only; however, for such a functionality to be effective and efficient, the system would have to include window(s) and door(s) sensors. These sensors check the state of windows and doors (open or close) to prevent unnecessary wastage of energy. Also a separate/additional electrical subsystem could be needed for this second propeller-motor combination. While operating in reverse flow, the atomizers 28 are deactivated in order to prevent spreading fragrance to other areas where it is not desired.

### DESCRIPTION OF DRAWING—ACCESSORY A

This is called accessory A because it is not a full embodiment of the concept but rather an additional element that should be coupled to the fourth embodiment for a more efficient and effective device. The main functions of this accessory are: to boost airflow, sense conditions within the ductwork such as pressure and temperature, and/or harvest kinetic energy of air molecules moving in the ductwork. The accessory can be fitted into the ductwork just as the fifth embodiment. The device has a fan 27 or propeller that is connected to a motor dynamo, which could be a brush or brushless motor 31 (see FIGS. A1-A2). This combination of fan 27 and motor 31 is a means of: generating power, boosting flow, and restricting flow. This accessory 201 also includes a sensor(s) attached to its chassis as a means of measuring environment conditions in the ductwork. Its dynamo motor and sensor is controlled by the intelligent controller or processing module 4 of the embodiment (104) that is coupled to it.

### DESCRIPTION OF DRAWING—ACCESSORY B

Note that Accessory A and B cannot be used at the same time. Like accessory A, accessory B is called an accessory because is it not a full embodiment of the concept but rather an additional element that can be added to embodiment 101 to 103 for more efficient device. The main functions of this accessory are: to boost airflow, atomize liquid fragrances, check environmental condition in the ductwork, and/or harvest energy from the kinetic energy of the air molecules. The accessory can be fitted into the ductwork just as the fifth embodiment. The device has a fan or propeller 27 that is connected to a motor dynamo, which could be a brush or brushless motor 31 (see FIGS. B1 and B2). This combination of fan 27 and motor 31 is a means of: generating power, boosting airflow, and restricting airflow. This accessory also includes a sensor(s) that are attached to its chassis as a means of measuring environment parameter in the ductwork. Its dynamo motor and sensor is controlled by the intelligent controller 4 of the embodiment (101 or 102 or 103) that is coupled to it. It includes an atomizer that atomizing liquid fragrance which can then be carried to a particular area.

### Operation

### How it Comes Together

All embodiments satisfy the functions of regulating fluid or air flow into a particular space. From now on I will refer to these embodiments and vent machines of this nature as either autovents or adaptive vents (ADVs) or adaptive flow devices. Essentially, an autovent can communicate with external sensors, other adaptive vent machines, environmental control unit controller (such as thermostats), machine/human interface devices, other relevant processing units and any combinations of the previously mentioned devices. It delivers and maintains the climate in a particular room as desired by its occupant(s).

There are various kinds of wireless communication technology that can be adapted to the adaptive flow device system/concept. Zigbee, as an example, could be employed as a relevant wireless communication system. FIG. X10 is an example of how the topology of the adaptive flow device wireless system could look with the utilization of Zigbee devices. So sensors are attached to a router-coupled device which could include human-machine interface. Such a router-coupled device can be placed in each room so that occupants of the room can set desired environmental condition. Note the inclusion of a computer in the diagram of the Zigbee mesh topology; in essence, a personal computer can also act a human-machine interface. Other device such as a cell phone can also be made a human-machine interface for the adaptive vent device; of course this could include the use of other devices too.

There are three modes in which adaptive flow devices can function: the independent mode, semi-independent mode, and the dependent mode. The independent mode is a setting in which the vent is not a slave to a master processing unit that has the ability to control it; even if it is aware of it. While in the dependent mode, the vent is fully aware of and is a slave to a master processing unit that could control a plurality of autovents and other devices. The semi-independent mode is a setting in which each adaptive flow device is not a slave to a master processing unit, but rather it works as part of a system of adaptive flow devices. In this mode, an adaptive flow device considers the settings in other areas, and works in conjunction with other adaptive flow devices to create comfortable environment for all occupants.

Even while in an independent mode the autovent can still communicate with other devices such as a wireless sensors etc; however, it does not receive “close” and “open” commands from any other devices. It makes decisions of its own based on its interpretations, calculations, and analysis of the information it receives from a wired or wireless sensors and other relevant devices. The following scenario is an example of a situation where the independent mode could be useful: if occupant A of a 20° C. small room, in a single family house type, is normally comfortable in a 23° C. to 26° C. environment; and occupant B is more comfortable in a 25° C. to 29° C. environment. Occupant B occupies another room in the building. Assuming the room occupied by occupant A is quite small and well insulated compared to other rooms in the building; then it is reasonable to conclude that the smaller room would tend to be more sensitive to temperature change as heated/chilled air flow from a central air conditioning unit (by central air conditioning unit, I mean that the AC unit is responsible for cooling or heating a plurality of rooms to desired temperatures as explained in background section). Therefore, if the thermostat is set to 29° C. by occupant B, then occupant A's room will reach the desired temperature quicker than the room occupied by occupant B. By the time occupant B's room reaches the desired temperature of 29° C., the temperature of occupant A's room will be well over 29° C., and this is will be a very uncomfortable to the occupant A. Such an uncomfortable environment could irritate the respiratory system and could have undesirable and unhealthy consequences. To prevent this, occupant A's could install an adaptive vent(s), which would stop airflow into the room when the temperature in room reaches a comfortable temperature zone for occupant A. So occupant A would simply set the adaptive vent (using the human-machine interface which could be coupled with the temperature sensor) to the desired temperature (let's say 26° C.), and then the adaptive vent regulates airflow into the room. So a wireless sensor informs the processing unit in the adaptive vent 10X of the current temperature through the wireless system, and the processing unit analyses and decides if the vent should block airflow or allow it. Note that the adaptive vent in an independent mode cannot shut down the air conditioning system like a thermostat, but it can stop airflow into a particular area. Therefore, while in the independent mode, an adaptive vent has limited functionality. The adaptive vent regulates the temperature of occupant A's room without care for the conditions in occupant B's room. Once the occupant A's room reaches the 26° C., the adaptive vent stops airflow from the air conditioning system into the room. The central air conditioning unit keeps running until the thermostat shuts it down, which by then, the temperature in B's room could have reached 29° C. So everybody wins; A gets a comfortable 26° C. room and B gets a 29° C. room that is comfortable to him/her. Recognize that while operating in the independent mode, an adaptive vent can be a part of a communication network. See FIG. X3 for more insight to the operation of the intelligent controller as it controls the adaptive flow device.

This example illustrates some very important points about the use of a central air conditioning system without the use of adaptive vents. Firstly, a thermostat measures the temperature of the immediate area it occupies, which is supposedly a central location of the house, and makes necessary decisions based on measurement of the temperature of the room. The problem with this system is that all rooms are not equal in insulation, and the temperature will vary from one room to the next. So while the central room, where the thermostat is located, might be at a set temperature, other rooms in the house could have much higher and/or lower temperature. Despite this fact, the thermostat still shuts down the central air conditioning system only when the space in which it is located reaches a set temperature; this could leave occupants in other rooms of the building in an uncomfortable state. Secondly, a central air conditioning system without the use of adaptive vents, can create an unhealthy environment in some rooms, for example some room could be too hot or too cold. Thirdly, a user is incapable of setting room climate priority; that is such a system lacks flexibility of being influenced to emphasize and prioritize the climate of a particular area over others.

Semi independent mode could be considered a fall-back mode incase communications with a master processing unit fails. In this mode, the adaptive flow devices quickly form a wireless network; thereby, each adaptive flow device relays information it gets from sensors about its surroundings to other adaptive flow devices. It also relays desired environmental parameter, such as temperature, requested by user to other adaptive flow devices. So users in different rooms of a building can set the desired environmental conditions through human-machine interfaces, and then the adaptive flow devices send all relevant information through the network to each other. Relevant information like current environmental conditions, desired environmental conditions, environmental conditions inside the duct, etc. The adaptive flow devices then make necessary adjustments in order to meet desired conditions. Any changes in the environment or desired environmental conditions will be quickly transmitted to other adaptive flow devices in the network. So basically, the adaptive vents in the network communicate and cooperate with each other. See FIG. X5 for more insight to the operation of the microcontroller of the adaptive vent while in semi-independent mode. Keep in mind that as the intelligent controller receives instructions from the user, it checks the priority of the meeting the need of the user. While air is flowing through the ductwork from the environmental control unit then the atomizer(s) sprays fragrance molecules into flow, which carries them to the area where they are desired. Other relevant sensors like air quality sensors can be incorporated into the adaptive flow devices.

An adaptive vent in dependent mode is more efficient than that of independent mode. By being slaves to a master processing unit each adaptive vent is part of a wholesome system that can be programmed to regulate climate and energy for maximum efficiency. They are connected to more devices in the building through the master processing unit. While in the semi-independent mode, intelligent controllers of the adaptive flow devices are more active thereby consuming more energy; this results in more frequent recharge circles. A typical master processing unit is a wall mountable, user friendly, wireless unit that has human-machine interface. It does all the interpretations, analyses, and calculations with the information it receives from the wireless sensors and other devices located in various rooms in a building; and then it instructs each adaptive flow devices to: stop, allow, reduce, increase, or boost airflow into a particular area. See FIG. X4 for more insight to the operations of the intelligent controller and master processing unit of an adaptive flow device in independent mode.

The sixth embodiment is a preferred embodiment because it seemly holds some advantages over the other embodiments. When compared to the other embodiment it appears to be the most durable, more robust, and practical though this assumption is yet to be examined, researched and proved.

Though Zigbee wireless system has been used in this section as an example other communication devices (wireless or wired) can be used. For example infra red, ultrasonic ×10, 802.11 spread spectrum, instrumentation bus, RS-232, modem, Bluetooth, digital cable, or other wired or wireless methods and protocols, and combination thereof.

Using a cooperative system such as this provides not only suitable and comfortable environment for various occupants, but also saves energy. The following example illustrates this fact. Consider another scenario, in which there is a four bedroom house with 2 occupants residing in it and both in the master bedroom. In winter time, central air conditioning unit is used to heat up the building. The thermostat is set to 27° C. Note that the air conditioning unit will needlessly waste heat by supplying the 3 unused rooms with heated air. With an adaptive vent in an dependent mode, the occupants can control the temperature of various rooms from the comfort of their room (or any other location in the building, most preferably a central location in the building e.g hallway, corridor). The occupant can simply inform the master processing unit, and then the processing unit regulates the airflow into the rooms in order to attain the desired climate by controlling the adaptive vents in the rooms through wireless communication. Therefore, the occupant could set the adaptive vents in the unused room to stop airflow, thereby saving energy, while the master bedroom heats up quicker due to the increase in air speed through the ductwork. Note that an adaptive vent in an independent mode can also be used to achieve success in the second scenario too, but it requires more effort by the user.

Consider a third scenario where there are 3 occupants in the building and the same season mentioned in the second scenario, and all of them occupying separate rooms. With the adaptive vents in either independent or dependent mode, each occupant of a room sets the room's temperature to whatever temperature desired through the human-machine interface. Let's assume that occupant A desires 25° C., occupant B desires 28° C., and occupant C desires 28° C. too. Let's further assume that A's room is much smaller than the other rooms (and roughly as well insulated as B's room), and B's room is the same size as C's room; however C's room is less insulated than B's room. All rooms have the same number of same sized adaptive vents. A central air conditioning unit is then switched on by the thermostat or master processing unit (thermostat if in independent mode, master processing unit if in dependent mode), and ambient temperature starts to vary from room to room. Occupant A's room will be the first to reach the desired temperature because of its size, insulation, and lower temperature desire; and so, the adaptive vents of A stops airflow first. Due the discontinuation of access to A's room the air pressure in the ductwork increases. This helps heat up the other rooms quicker. The next room to attain the desired temperature is B's room due its better insulative capacity, and as a result the adaptive vents in B's room block airflow into the room. Again this action increases air pressure in the ductwork, and thereby reducing the time needed to heat up C's room to desired temperature. So this system reduces the time needed to heat up rooms and stops energy wastage by preventing heat/chilled air from being distributed to areas where it is not needed, e.g empty rooms and rooms at comfortable temperatures. More importantly, it maintains comfort zones that suit each occupant.

An adaptive flow device's atomizer(s), which could be ultrasonic atomizer(s), is only active when there is airflow in the ductwork. Fine particles of fragrance are sprayed into the airflow, which carries them into the room. The use of adaptive flow devices as aromatic devices as the advantage of spreading the aroma evenly; and also, it is an alternative to other less tidy options such as wall mounted air fresheners which could damage the wall due to adhesives and screws used to hold them in place. Atomizers are better alternatives to aerosol spray cans that contain ozone damaging molecules. Note that atomizer is deactivated when the adaptive flow device is operating in a reverse flow (which is possible with the sixth embodiment), so as to prevent fragrance from spreading to area where it is not desired.

The energy harvester of the adaptive flow devices can come in different forms and transform different forms of energy to electrical energy, which can be stored and used later. The storage device can be rechargeable batteries, capacitors, super capacitors etc. In embodiment, 105, 106 and Accessories 201, 202 the motor can be used to recharge power source by capturing the kinetic energy of the moving air molecules in the ductwork. In embodiments 101 to 104, the energy harvester could be a device that can harvest energy in vibrations in its surroundings, or could be a thermal energy harvester that absorbs thermal energy and converts it to electrical energy. Having these energy harvesters makes the adaptive flow devices more autonomous.

As mentioned earlier, this aroma creation system could be adapted to automobiles (see FIG. X9). The atomizers 28 are simply installed behind the air vent of the car in the duct, as shown in the picture. It is controlled by a microcontroller 41 and powered by the car's battery or by a rechargeable power source. While the air conditioning of the car is on an atomizer 28 sprays fine particles of fragrance in the airflow in timed intervals; these particles are carried into the interior of the car. Note that these atomizers 28 can still be used in while the air conditioning is off if the air duct of the car is open (outside ventilation setting is active). This setting allows fresh air from outside the car in through air duct, thus creating airflow into the car through the air vent. Adapting the described aroma creating system to an automobile gets rid of obstruction caused by scented tresses and makes the interior of the car look tidy and less clustered.

The specificities given above should not be construed as limitation on the scope, rather they are provided to give unambiguous illustrations of embodiments. For example, the chassis could have a circular cross section rather than a rectangular one, or some other kind of processor could be used instead of a microprocessor, a liquid filled piston or spring could be used in gating mechanism etc. Many other variations are possible. Changes and modifications, which fall within the true spirit and scope, will be apparent to those skilled in the art. The scope and spirit should not be determined by the embodiments illustrated, but by the appended claims and their legal equivalents.

1. An adaptive machine/adaptive flow device that can be used for climate control and creating an appealing environment for users, by regulating or controlling the airflow into a particular room/area/compartment, which comprises of following:
a. frame of appropriate dimensions and form
b. first means of increasing and decreasing airflow through or near said frame
c. second means of creating aroma in said environment
d. third means of automatically or manually controlling said first means and second means
e. fourth means of supplying said third means and/or other energy dependent members with energy so that each can perform its function
g. fifth means of sensing environmental conditions
f. an optional sixth means of communicating with other relevant devices
whereby by said first means affixed to said frame is controlled by said third means; said second means creates an aromatic environment for said users and is also controlled by third means; said fifth means gathers useful information about the environment such as temperature humidity; said fourth means supplies power to energy dependent members of said adaptive machine; and said sixth means allows said adaptive machine to communicate with other relevant devices; in order to satisfy the users desires.

2. A machine as claimed in claim 1 wherein said fourth means further comprises one or more of the following:
a. means of harvesting energy from surrounding environment and transforming it into useable form for said adaptive flow device
b. means of harvesting energy from the air flowing through or close to said frame and transforming it into useable form for said adaptive flow device
c. means of harvesting thermal energy from the surrounding environment and transforming it into useable form for said adaptive flow device.

3. A machine as claimed in claim 2 that further includes a charging regulator or manager or controller through which the rate of transferring energy into said adaptive flow device, and/or other energy dependent members, and/or an energy storage component is controlled.

4. A machine as claimed in claim 1 wherein said first means includes one or more of the following:
a. gating means for restricting airflow and controlling influx of air to a particular area
b. air propelling means for boosting, and/or reversing, and/or hindering air flow

5. A machine as claimed in claim 4, wherein said gating mechanism includes:
a. a motor that is controlled by said third means
b. slats that acts as a gates that limit airflow
c. rods that are used to attach the slats to said frame
d. pulleys and belt which are used to transfer the mechanical energy of said motor to said rods inserted through said slats, thereby the mechanical energy is also transferred to said slats
e. feedback mechanism that makes said third means aware of the state of the gating mechanism
whereby rotational kinetic energy of said motor is transferred to said slats which can then open and close in various degrees in order to regulate air flowing into a particular area through said frame.

6. A machine as claimed in claim 4 wherein said air propelling means includes:
a. a fan or propeller that can drive air in a particular direction
b. a motor controller, by said third means, which can drive said propeller
c. feedback mechanism that makes said third means aware of the state of air propelling means
whereby the rotation of the propeller by the motor can boost, hinder, or reverse airflow into a particular area.

7. A machine as claimed in claim 1 wherein said third means is an intelligent controller or processing unit such as a microcontroller or a digital signal processor.

8. A machine as claimed in claim 1 wherein said second means includes:
a. an atomizer that atomizes liquid fragrance
b. storage container that is used to store fragrance
c. tubes that feed liquid fragrance from said storage container to said atomizer
d. a feedback mechanism that makes said third means aware of liquid level of the storage container
whereby fragrance fed to said atomizer by said tube, from said storage container, is atomized and sprayed into airflow in a ductwork that carries it to where is it desired.

9. A machine as claimed in claim 1 further includes one or more of the following settings:
a. independent operation setting in which said adaptive flow device works alone
b. cooperation setting in which said adaptive flow device cooperate with other adaptive flow machines
c. dependent setting in which said adaptive flow device is a slave to a master processing unit that can control a plurality of said adaptive flow devices by communicating with them through sixth means
whereby each setting is ideal for a particular situation or circumstance.

10. A machine as claimed in claim 9, wherein said other relevant machines in communication with said adaptive flow devices through sixth means includes one or more of the following:
a. machines of the same nature claimed herein
b. a sensor/human-machine interface coupled processing units
c. sensors that provide useful parameters to said third means
d. a computer or a plurality of it
e. a master processing unit that has the capability of controlling and communicating with a plurality of said adaptive flow machines
f. a cell phone or a plurality of it
g. other useful processing units and devices
whereby collaboration between said other relevant devices and said adaptive flow device help create a comfortable and appealing environment.

11. A machine as claimed in claim 10 that further includes one or more of the following:
a. means of harvesting energy from an environment
b. means of restricting airflow in a ductwork into a particular area by limiting flow in varying degrees
c. means of propelling air in ductwork in order to hinder, boost, or reverse airflow into a particular area
d. means of creating aroma in an environment by atomizing stored fragrance with an atomizer, which is then sprayed into airflow in said ductwork that carry them to a particular area
e. charging regulator or manager or controller through which the rate of transferring energy into said adaptive flow device, and/or other energy dependent members, and/or an energy storage component is controlled
f. feedback mechanism so that said third means is aware of the state of different aspects of said adaptive flow device such as air propelling means' state, air restricting means' state, liquid fragrance level, power level
g. said communicating means is either wireless or wired or combination thereof.

12. A method of creating a comfortable and appealing environment for a user with adaptive machine/device or a plurality of said adaptive machine/device or traditional air vent; this method of using adaptive machines includes second step below, and/or one or more of the remaining steps:
a. regulating fluid/air flow into a particular environment/area/compartment/chamber through adaptive flow device/devices.
b. utilizing a means of creating aroma in the environment that is coupled or affixed to said adaptive vent; or coupled or affixed to traditional vents found in buildings
c. utilizing a communications network that includes one or more of the following: said adaptive device or a plurality of said adaptive device, sensors, master processing unit, human-machine interface remote devices, computers, cell phones, and other relevant devices; so that relevant devices can communicate relevant information to each other; said relevant information such as current environmental conditions, desired environmental condition, state of a plurality of adaptive vents
d. utilizing a computer program, embedded in some kind of hardware, that can interpret information from relevant sources, calculate, adapt to user behavior, learn from its operating history and gives said adaptive flow device intelligence
e. harvesting energy from surrounding environment or medium of said adaptive flow device which can be used to energize said adaptive flow device directly and/or stored for future use
f. harvesting energy from external environment and then transferring the energy to the adaptive flow device
g. detecting airflow, which could be flowing in ductwork, into a particular area through an airflow detecting means
h. receiving feedback from various subsystems of said adaptive device
i. providing energy to said adaptive machine from power source
whereby, communications allow the master processor and/or adaptive vent's control units to: obtain knowledge of current environmental conditions in a particular area, obtain knowledge of desired environmental conditions, to work cooperatively with each other, and to cooperate with other relevant devices; energy harvesting makes said adaptive flow device more autonomous; said aroma creating means provides a more appealing environment; said restricting means control influx of air to said particular area; the intelligence provided by said program helps the adaptive flow device satisfy requests made by users; said airflow detecting means serves as a sensory mechanism for the intelligence; said feedback mechanism is a means for the intelligence to be aware of the state of said adaptive flow machine; and said power source energizes the adaptive flow device.

13. The method of claim 12, wherein said regulating airflow step comprises:
a. restricting airflow or reducing airflow into a room/compartment/enclosed area with a gating mechanism
b. controlling said gating mechanism with an intelligent processing unit or circuit
c. energizing said gating mechanism, said intelligent processing unit, and other energy dependent members of the adaptive flow device with energy from a power source
d. providing feedback mechanism through which said intelligent processing unit is aware of the state of various aspects of the adaptive flow device such as gating means, power level, etc.

14. The method of claim 12, wherein said regulating airflow step comprises of the first step below and one or more of the remaining steps:
a. boosting and hindering airflow into an enclosed area/compartment with an air propelling means
b. controlling said air propelling means with an intelligent processing unit or circuit
c. energizing said air propelling means, said intelligent processing unit, and other energy dependent members of said adaptive flow device with energy from a power source
d. providing feedback mechanism through which said processing unit is aware of the state of various aspect of said adaptive flow device such as said air propelling means, power level.

15. The method of claim 12 wherein said aroma creating means step comprises:
a. storing fragrance such as natural oils, scented solutions in a container in said adaptive flow device
b. supplying said stored fragrance to a spraying or an atomizing means
c. spraying scented particles atomized by said atomizing means, which is controlled by an intelligent processing unit or circuit, into airflow
d. providing feedback mechanism through which said intelligent processing unit is aware of the state of various aspect of said adaptive flow device such as liquid fragrance level, power level
e. energizing said aroma creating means, said intelligent processing unit, and other energy dependent members of said adaptive flow device with energy from a power source.

16. The method of claim 12 wherein said aroma creating means step and said regulating means step comprises:
a. storing fragrance such as natural oils, scented solutions in a containers in said adaptive flow device
b. supplying said stored fragrance to a spraying or an atomizing means
c. spraying fragrance solution atomized by said atomizing means which is controlled by an intelligent processing unit or circuit into airflow
d. restricting airflow or reducing airflow into a room/compartment/enclosed area with a gating mechanism
e. controlling said gating mechanism with said intelligent processing unit or circuit
f. boosting and hindering airflow into an enclosed area/compartment with an air propelling means
g. controlling said air propelling means with said intelligent processing unit or circuit
h. energizing said gating mechanism, said air propelling means, said atomizing means, said intelligence, and other energy dependent members of the adaptive flow device with energy from power source
i. providing feedback mechanism through which said intelligent processing unit is aware of the state of various aspects of said adaptive flow device such as liquid fragrance level, power level, gating means, air propelling means.

17. The method of claim 12 wherein said area could be a room in a building, an interior of a residential building, an interior of a commercial building, an interior of a building, interior of a vehicle, interior of a train, interior of an automobile, interior of a flying vehicle, or the interior of an airplane.

18. A system creating a climate and environment control comprising:
a. an environmental control unit
b. an in-duct or duct end mountable adaptive vents or flow devices that are capable of boosting, restricting, reversing, and/or hindering airflow from ductwork to a particular area; also capable of providing a particular area with scented molecules in order to create a pleasing and attractive environment
c. a programmable environmental control unit controller, or a master control unit that is capable of controlling said adaptive flow devices via a communication network
d. sensors that relay relevant information to the master control unit and said adaptive flow devices via communications network
e. optional human-machine interface devices which could be coupled to sensors that allows users to communicate their desires to said master control unit and/or said adaptive flow devices via a communication network; the adaptive flow devices' state and alerts can also be made known to users through said human-machine interface
whereby said master control unit controls the environmental control unit and adaptive flow devices tactfully to meet environment conditions desired by user; it collects necessary information from: users, sensors, adaptive flow devices, said human-interfaces; interprets and analysis them, and then makes intelligent decisions based on calculations; and instructs the adaptive vent on what to do.

19. A system of claim 18 wherein said master control unit controls includes:
a. control over electric metering
b. control over water metering
c. control over gas metering
d. control over any other utility metering
e. control over devices in a residential or commercial building.

20. A machine as claimed in claim 1 wherein said container can be filled by water so that said adaptive machine can function as a humidifier also.
